(19) United States
(12) Patent Application Publication
(10) Pub. No.: US 2025/0224157 A1
(43) Pub. Date: Jul. 10, 2025

(54) HEAT PUMP CYCLE DEVICE

(71) Applicant: DENSO CORPORATION, Kariya-city (JP)

(72) Inventors: Hiroya HASEGAWA, Kariya-city (JP); Hiroshi Mieda, Kariya-city (JP); Kiyoshiro Ota, Kariya-city (JP)

(21) Appl. No.: 19/089,185

(22) Filed: Mar. 25, 2025

Related U.S. Application Data
(63) Continuation of application No. PCT/JP2023/033393, filed on Sep. 13, 2023.

(30) Foreign Application Priority Data
Sep. 27, 2022 (JP) 2022-153559

(51) Int. Cl. F25B 30/02; B60H 1/00; F25B 43/00

(52) U.S. Cl. CPC F25B 30/02; F25B 43/00; B60H 1/00899

(57) ABSTRACT

A heat pump cycle device includes: a compressor; an upstream branch configured to branch refrigerant discharged from a discharge port of the compressor; a heater that heats an object to be heated using one of high-pressure refrigerant divided at the upstream branch as a heat source; a first decompression valve; a hot-gas gas-liquid separator; a second decompression valve; a bypass passage that guides an another one of the high-pressure refrigerant divided at the upstream branch; a bypass-side flow rate valve; and a joint. During a multi-stage hot-gas heating mode for heating the object to be heated using the heater, gas refrigerant separated by the hot-gas gas-liquid separator is guided toward an intermediate-pressure suction port of the compressor, and refrigerant flowing out of the joint is guided toward a low-pressure suction port of the compressor.

### CROSS REFERENCE TO RELATED APPLICATION

The present application is a continuation application of International Patent Application No. PCT/JP2023/033393 filed on Sep. 13, 2023, which designated the U.S. and claims the benefit of priority from Japanese Patent Application No. 2022-153559 filed on Sep. 27, 2022. The entire disclosures of all of the above applications are incorporated herein by reference.

### FIELD OF THE INVENTION

The present disclosure relates to a heat pump cycle device that heats an object to be heated using heat generated by compression work of a compressor.

### BACKGROUND

Conventionally, a heat pump cycle device is applied to a vehicular air conditioner and heats ventilation air to be blown into a vehicle interior. In the heat pump cycle device, operation in a hot-gas air-heating mode may be executed in an operating condition in which heat for heating the ventilation air is difficult to be absorbed from outside air, such as when an outside air temperature is low.

### SUMMARY

A heat pump cycle device according to an aspect of the present disclosure includes: a compressor configured to compress low-pressure refrigerant drawn from a low-pressure suction port, to discharge compression refrigerant from a discharge port, and to merge intermediate-pressure refrigerant drawn from an intermediate-pressure suction port with the low-pressure refrigerant in a process of compression; an upstream branch configured to divide a flow of high-pressure refrigerant discharged from the discharge port of the compressor; a heater configured to heat an object to be heated using one of the high-pressure refrigerant divided at the upstream branch as a heat source; a first decompression valve configured to decompress the refrigerant flowing out of the heater; a hot-gas gas-liquid separator configured to separate the refrigerant, flowing out of the first decompression valve, into gas refrigerant and liquid refrigerant; a second decompression valve configured to depressurize the liquid refrigerant separated by the hot-gas gas-liquid separator; a bypass passage that guides an another one of the high-pressure refrigerant divided at the upstream branch toward the low-pressure suction port of the compressor; a bypass-side flow rate valve configured to regulate a flow rate of the refrigerant flowing through the bypass passage; a joint that merges a flow of the refrigerant flowing out of the bypass-side flow rate valve and a flow of the refrigerant flowing out of the second decompression valve; a third decompression valve configured to decompress the refrigerant flowing out of the heater; a heating gas-liquid separator that separates the refrigerant, decompressed by the third decompression valve, into gas refrigerant and liquid refrigerant; a fourth decompression valve configured to decompress the liquid refrigerant separated by the heating gas-liquid separator; an exterior heat exchanger that exchanges heat between the refrigerant and outside air; and a refrigerant circuit switching portion configured to switch between refrigerant circuits in which the refrigerant circulates.

For example, during an outside air endothermic heating mode in which the object is heated using the heater, the refrigerant circuit switching portion switches a refrigerant circuit in which the refrigerant flowing out of the heater is guided to the third decompression valve, the gas refrigerant separated by the heating gas-liquid separator is guided toward the intermediate-pressure suction port, the refrigerant decompressed by the fourth decompression valve is guided to a refrigerant inlet side of the exterior heat exchanger, and the refrigerant flowing out of the exterior heat exchanger is guided toward the low-pressure suction port of the compressor.

A heat pump cycle device according to an another aspect of the present disclosure includes: a compressor configured to compress low-pressure refrigerant drawn from a low-pressure suction port, to discharge compression refrigerant from a discharge port, and to merge intermediate-pressure refrigerant drawn from an intermediate-pressure suction port with the low-pressure refrigerant in a process of compression; an upstream branch configured to divide a flow of high-pressure refrigerant discharged from the discharge port of the compressor; a heater configured to heat an object to be heated using one of the high-pressure refrigerant divided at the upstream branch as a heat source; a first decompression valve configured to decompress the refrigerant flowing out of the heater; a hot-gas gas-liquid separator configured to separate the refrigerant, flowing out of the first decompression valve, into gas refrigerant and liquid refrigerant; a second decompression valve configured to depressurize the liquid refrigerant separated by the hot-gas gas-liquid separator; a bypass passage that guides an another one of the high-pressure refrigerant divided at the upstream branch toward the low-pressure suction port; a bypass-side flow rate valve configured to regulate a flow rate of the refrigerant flowing through the bypass passage; a joint that merges a flow of the refrigerant flowing out of the bypass-side flow rate valve and a flow of the refrigerant flowing out of the second decompression valve; an exterior heat exchanger that exchanges heat between the refrigerant and outside air; an evaporator that evaporates the refrigerant decompressed by the second decompression valve; and a refrigerant circuit switching portion that switches between refrigerant circuits through which the refrigerant circulates.

In this case, during a cooling mode for cooling an object to be cooled, the refrigerant circuit switching portion switches a refrigerant circuit in which the refrigerant flowing out of the heater is guided to a refrigerant inlet side of the exterior heat exchanger, the refrigerant flowing out of the exterior heat exchanger is guided to an inlet side of the first decompression valve, the gas refrigerant separated by the hot-gas gas-liquid separator is guided toward the intermediate-pressure suction port, the refrigerant decompressed by the second decompression valve is guided to the refrigerant inlet side of the evaporator, and the refrigerant flowing out of the evaporator is guided toward the low-pressure suction port of the compressor.

A heat pump cycle device according to a third aspect of the present disclosure includes: a compressor configured to compress low-pressure refrigerant drawn from a low-pressure suction port, to discharge compression refrigerant from a discharge port, and to merge intermediate-pressure refrigerant drawn from an intermediate-pressure suction port with the low-pressure refrigerant in a process of compression; an upstream branch configured to divide a flow of high-pressure refrigerant discharged from the discharge port of the compressor; a heater configured to heat an object to be heated using one of the high-pressure refrigerant divided at the upstream branch as a heat source; a first decompression valve configured to decompress the refrigerant flowing out of the heater; a hot-gas gas-liquid separator configured to separate the refrigerant, flowing out of the first decompression valve, into gas refrigerant and liquid refrigerant; a second decompression valve configured to depressurize the liquid refrigerant separated by the hot-gas gas-liquid separator; a bypass passage that guides an another one of the high-pressure refrigerant divided at the upstream branch toward the low-pressure suction port; a bypass-side flow rate valve configured to regulate a flow rate of the refrigerant flowing through the bypass passage; a joint that merges a flow of the refrigerant flowing out of the bypass-side flow rate valve and a flow of the refrigerant flowing out of the second decompression valve; an evaporator that evaporates the refrigerant decompressed by the second decompression valve to cool the object to be cooled; and a refrigerant circuit switching portion that switches between refrigerant circuits through which the refrigerant circulates.

In this case, during a multi-stage endothermic hot-gas heating mode for heating the object to be heated using the heater, the refrigerant circuit switching portion switches a refrigerant circuit in which the gas refrigerant separated by the hot-gas gas-liquid separator is guided toward the intermediate-pressure suction port, the liquid refrigerant separated by the hot-gas gas-liquid separator is decompressed by the second decompression valve, and the refrigerant flowing out of the joint is guided toward the low-pressure suction port of the compressor.

A heat pump cycle device according to a fourth aspect of the present disclosure includes: a compressor configured to compress low-pressure refrigerant drawn from a low-pressure suction port, to discharge compression refrigerant from a discharge port, and to merge intermediate-pressure refrigerant drawn from an intermediate-pressure suction port with the low-pressure refrigerant in a process of compression; an upstream branch configured to divide a flow of high-pressure refrigerant discharged from the discharge port; a heater configured to heat an object to be heated using one of the high-pressure refrigerant divided at the upstream branch as a heat source; a downstream branch configured to divide a flow of the refrigerant flowing out of the heater; a first decompression valve configured to decompress one of the refrigerant divided at the downstream branch; an internal heat exchanger that exchanges heat between the refrigerant flowing out of the first decompression valve and an another one of the refrigerant divided at the downstream branch; a second decompression valve configured to decompress the another one of the refrigerant divided at the downstream branch and flowing out of the internal heat exchanger; a bypass passage that guides an another one of the high-pressure refrigerant divided at the upstream branch toward the low-pressure suction port of the compressor; a bypass-side flow rate valve configured to regulate a flow rate of the refrigerant flowing through the bypass passage; a joint that merges a flow of the refrigerant flowing out of the bypass-side flow rate valve and a flow of the refrigerant flowing out of the second decompression valve; an evaporator that evaporates the refrigerant decompressed by the second decompression valve to cool an object to be cooled; and a refrigerant circuit switching portion that switches between refrigerant circuits through which the refrigerant circulates.

In this case, during a multi-stage endothermic hot-gas heating mode for heating the object to be heated using the heater, the refrigerant circuit switching portion switches a refrigerant circuit in which the refrigerant heated by the internal heat exchanger is guided toward the intermediate-pressure suction port, the refrigerant cooled by the internal heat exchanger is decompressed by the second decompression valve, and the refrigerant flowing out of the joint is guided toward the low-pressure suction port of the compressor.

### BRIEF DESCRIPTION OF DRAWINGS

The above object, the other objects, features, and advantages of the present disclosure will become more apparent from the following detailed description with reference to the accompanying drawings. In the drawings:

FIG. 1 is a schematic overall configuration diagram of a vehicular air conditioner according to a first embodiment;

FIG. 2 is a schematic configuration diagram of an interior air conditioning unit according to the first embodiment;

FIG. 3 is a block diagram illustrating an electric control portion of the vehicular air conditioner of the first embodiment;

FIG. 4 is a schematic overall configuration diagram illustrating a flow of refrigerant and the like during an air-cooling mode and a cooling and air-cooling mode of the vehicular air conditioner of the first embodiment;

FIG. 5 is a schematic overall configuration diagram illustrating a flow of refrigerant and the like in an outside air endothermic air-heating mode of the vehicular air conditioner of the first embodiment;

FIG. 6 is a schematic overall configuration diagram illustrating a flow of refrigerant and the like during a single-stage hot-gas air-heating mode of the vehicular air conditioner according to the first embodiment;

FIG. 7 is a Mollier chart illustrating a state change of the refrigerant during the single-stage hot-gas air-heating mode in the heat pump cycle of the first embodiment;

FIG. 8 is a schematic overall configuration diagram illustrating a flow of refrigerant and the like during a multi-stage hot-gas air-heating mode of the vehicular air conditioner of the first embodiment;

FIG. 9 is a Mollier chart illustrating a state change of the refrigerant during the multi-stage hot-gas air-heating mode in the heat pump cycle of the first embodiment;

FIG. 10 is a schematic overall configuration diagram illustrating a flow of refrigerant and the like during a multi-stage inside air endothermic hot-gas air-heating mode of the vehicular air conditioner of the first embodiment;

FIG. 11 is a schematic overall configuration diagram illustrating a flow of refrigerant and the like during a multi-stage device endothermic hot-gas air-heating mode of the vehicular air conditioner of the first embodiment;

FIG. 12 is a schematic overall configuration diagram illustrating a flow of refrigerant and the like during a multi-stage outside air endothermic hot-gas air-heating mode of the vehicular air conditioner of the first embodiment;

FIG. 13 is a schematic overall configuration diagram illustrating a flow of refrigerant and the like during a single-stage outside air endothermic air-heating mode of a vehicular air conditioner of a second embodiment;

FIG. 14 is a schematic overall configuration diagram illustrating a flow of refrigerant and the like during an outside air endothermic air-heating mode of a vehicular air conditioner of a third embodiment;

FIG. 15 is a schematic overall configuration diagram illustrating a flow of refrigerant and the like during a multi-stage outside air endothermic hot-gas air-heating mode of a vehicular air conditioner of the third embodiment;

FIG. 16 is a schematic overall configuration diagram illustrating a flow of refrigerant and the like during an air-cooling mode and a cooling and air-cooling mode of a vehicular air conditioner according to a fourth embodiment;

FIG. 17 is a schematic overall configuration diagram illustrating a flow of refrigerant and the like during an outside air endothermic air-heating mode of the vehicular air conditioner of the fourth embodiment;

FIG. 18 is a schematic overall configuration diagram illustrating a flow of refrigerant and the like during a single-stage hot-gas air-heating mode of a vehicular air conditioner according to the fourth embodiment;

FIG. 19 is a schematic overall configuration diagram illustrating a flow of refrigerant and the like during a multi-stage hot-gas air-heating mode of a vehicular air conditioner according to the fourth embodiment;

FIG. 20 is a Mollier chart illustrating a state change of the refrigerant during the multi-stage hot-gas air-heating mode in the heat pump cycle of the fourth embodiment;

FIG. 21 is a schematic overall configuration diagram illustrating a flow of refrigerant and the like during a multi-stage inside air endothermic hot-gas air-heating mode of the vehicular air conditioner of the fourth embodiment;

FIG. 22 is a schematic overall configuration diagram illustrating a flow of refrigerant and the like during a multi-stage device endothermic hot-gas air-heating mode of the vehicular air conditioner of the fourth embodiment;

FIG. 23 is a schematic overall configuration diagram illustrating a flow of refrigerant and the like during a multi-stage outside air endothermic hot-gas air-heating mode of the vehicular air conditioner of the fourth embodiment; and

FIG. 24 is a schematic overall configuration diagram of a vehicular air conditioner according to a fifth embodiment.

### DESCRIPTION OF EMBODIMENTS

In a comparative heat pump cycle device, during a hot-gas air-heating mode, a refrigerant circuit is switched to allow a portion of high-pressure refrigerant discharged from a compressor to flow into a heating portion. The heating portion heats ventilation air using the high-pressure refrigerant as a heat source. Furthermore, the refrigerant flowing out of the heating portion and the remaining high-pressure refrigerant discharged from the compressor are decompressed by different decompression portions and then mixed, and the mixture is drawn into the compressor.

Accordingly, in the comparative heat pump cycle device, during the hot-gas air-heating mode, the ventilation air as the object to be heated is heated using the heat generated by the compression work of the compressor to heat the vehicle interior, without using heat absorbed from the outside air.

In the comparative heat pump cycle device, improving the heating capacity of the heating portion during the hot-gas air-heating mode requires an increase in the amount of compression work of the compressor. Moreover, to increase the amount of compression work of the compressor, it is effective to increase the drawn refrigerant pressure of the low-pressure refrigerant drawn into the compressor and increase the density of the low-pressure refrigerant.

However, in the comparative heat pump cycle device, low-pressure-side components, such as an interior evaporator and a chiller, are connected to the suction port of the compressor. For this reason, the drawn refrigerant pressure to be drawn to the compressor cannot be increased above the upper-limit pressure that is determined based on the pressure resistance performance or the like of the low-pressure-side components. Therefore, the hot-gas air-heating mode of the heat pump cycle device has limitations in improving the heating capacity of the heating portion.

In view of the above, an object of the present disclosure is to provide a heat pump cycle device that heats an object to be heated using heat generated by compression work of a compressor, and that can exert sufficiently high heating capacity without increasing pressure of low-pressure refrigerant.

A heat pump cycle device of a first exemplar of the present disclosure includes a compressor, an upstream branch, a heating portion, a high-stage-side decompression portion, a hot-gas gas-liquid separation portion, a low-stage-side decompression portion, a bypass passage, a bypass-side flow rate regulation portion, and a joint.

The compressor is configured to compress low-pressure refrigerant drawn from a low-pressure suction port, to discharge compression refrigerant from a discharge port, and to merge intermediate-pressure refrigerant drawn from an intermediate-pressure suction port with the low-pressure refrigerant in a process of compression. The upstream branch is configured to divide a flow of high-pressure refrigerant discharged from the discharge port of the compressor. The heating portion is configured to heat an object to be heated using one of the high-pressure refrigerant divided at the upstream branch as a heat source. The high-stage-side decompression portion is configured to decompress the refrigerant flowing out of the heating portion. the hot-gas gas-liquid separation portion is configured to separate the refrigerant, flowing out of the high-stage-side decompression portion, into gas refrigerant and liquid refrigerant. The low-stage-side decompression portion is configured to depressurize the liquid refrigerant separated by the hot-gas gas-liquid separation portion. The bypass passage is made to guide an another one of the high-pressure refrigerant divided at the upstream branch toward the low-pressure suction port. The bypass-side flow rate regulation portion is configured to regulate a flow rate of the refrigerant flowing through the bypass passage. The joint is made to merge a flow of the refrigerant flowing out of the bypass-side flow rate regulation portion and a flow of the refrigerant flowing out of the low-stage-side decompression portion.

Furthermore, during a multi-stage hot-gas heating mode in which the heating object is heated by the heating portion, gas refrigerant separated by the hot-gas gas-liquid separation portion is led toward the intermediate-pressure suction port of the compressor, and the refrigerant flowing out of the joint is led toward the low-pressure suction port of the compressor.

With this configuration, during the multi-stage hot-gas heating mode, the flow of the refrigerant having relatively high enthalpy flowing out of the bypass-side flow rate regulation portion and the flow of the refrigerant having relatively low enthalpy flowing out of the low-stage-side decompression portion are merged at the joint, and guided to the low-pressure suction port side of the compressor. Therefore, the refrigerant drawn into the low-pressure suction port of the compressor can be maintained in an appropriate state, and the cycle can be operated suitably.

Thus, in the multi-stage hot-gas heating mode, the object to be heated can be stably heated by the heating portion using the heat generated by the compression work of the compressor without using the heat absorbed from the outside air.

Furthermore, in the multi-stage hot-gas heating mode, since the gas refrigerant separated by the hot-gas gas-liquid separation portion is drawn into the intermediate-pressure suction port, the amount of compression work of the compressor can be increased without increasing the pressure of the low-pressure refrigerant. Therefore, sufficiently high heating capacity can be exerted in the heating portion without increasing the pressure of the low-pressure refrigerant.

A heat pump cycle device of a second exemplar of the present disclosure includes a compressor, an upstream branch, a heating portion, a downstream branch, a high-stage-side decompression portion, an internal heat exchanger, a low-stage-side decompression portion, a bypass passage, a bypass-side flow rate regulation portion, and a joint.

The compressor is configured to compress low-pressure refrigerant drawn from a low-pressure suction port, to discharge compression refrigerant from a discharge port, and to merge intermediate-pressure refrigerant drawn from an intermediate-pressure suction port with the low-pressure refrigerant in a process of compression. The upstream branch is configured to divide a flow of high-pressure refrigerant discharged from the discharge port. The heating portion is configured to heat an object to be heated using one of the high-pressure refrigerant divided at the upstream branch as a heat source. The downstream branch is configured to divide a flow of the refrigerant flowing out of the heating portion. The high-stage-side decompression portion is configured to decompress one of the refrigerant divided at the downstream branch. The internal heat exchanger exchanges heat between the refrigerant flowing out of the high-stage-side decompression portion and an another one of the refrigerant divided at the downstream branch. The low-stage-side decompression portion is configured to decompress the another one of the refrigerant divided at the downstream branch and flowing out of the internal heat exchanger. The bypass passage is made to guide an another one of the high-pressure refrigerant divided at the upstream branch toward the low-pressure suction port of the compressor. The bypass-side flow rate regulation portion is configured to regulate a flow rate of the refrigerant flowing through the bypass passage. The joint is made to merge a flow of the refrigerant flowing out of the bypass-side flow rate regulation portion and a flow of the refrigerant flowing out of the low-stage-side decompression portion.

In addition, during a multi-stage hot-gas heating mode in which the object to be heated is heated by the heating portion, the refrigerant heated by the internal heat exchanger is guided toward the intermediate-pressure suction port of the compressor, and the refrigerant flowing out of the joint is guided to the low-pressure suction port of the compressor.

With this configuration, in the multi-stage hot-gas heating mode, the flow of the refrigerant having relatively high enthalpy flowing out of the bypass-side flow rate regulation portion and the flow of the refrigerant having relatively low enthalpy flowing out of the low-stage-side decompression portion are merged and guided to the low-pressure suction port side of the compressor at the joint. Therefore, the refrigerant drawn into the low-pressure suction port of the compressor can be maintained in an appropriate state, and the cycle can be operated suitably.

Thus, in the multi-stage hot-gas heating mode, the object to be heated can be stably heated by the heating portion using the heat generated by the compression work of the compressor without using the heat absorbed from the outside air.

Moreover, in the multi-stage hot-gas heating mode, since the refrigerant heated by the internal heat exchanger is drawn into the intermediate-pressure suction port, the amount of compression work of the compressor can be increased without increasing the pressure of the low-pressure refrigerant. As a result, the heating portion can exert sufficiently high heating capacity without increasing the pressure of the low-pressure refrigerant.

Hereinafter, a plurality of embodiments for carrying out the present disclosure will be described with reference to the drawings. In each embodiment, parts corresponding to an item described in the prior embodiment are denoted by the same reference numerals, and redundant description may be omitted. When only a part of the configuration is described in each embodiment, another embodiment described previously may be applied to the other parts of the configuration. Not only a combination of parts that are specifically indicated as combinable in each embodiment, but also a partial combination of embodiments without being explicitly indicated is possible when no particular obstacle to the combination arises.

### First Embodiment

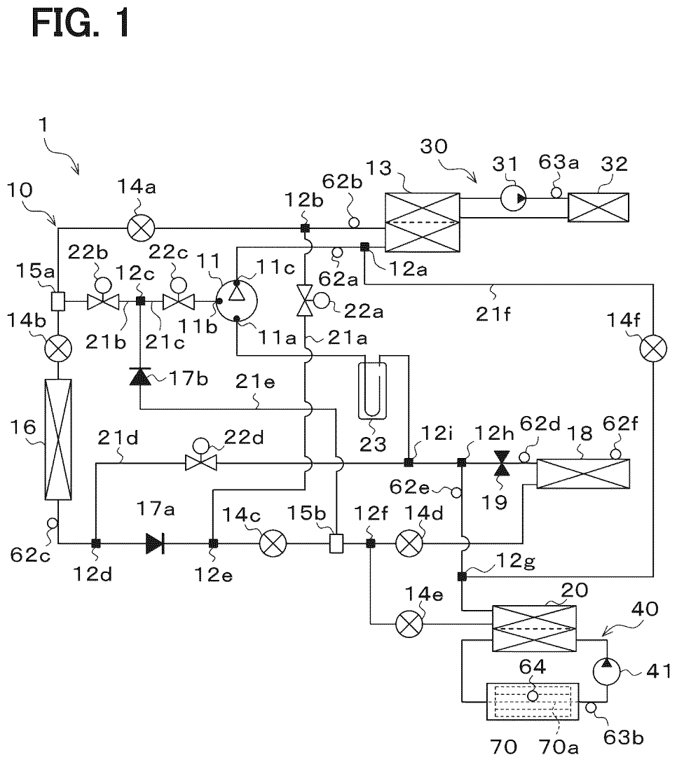

A first embodiment of a heat pump cycle device according to the present disclosure will be described with reference to FIGS. 1 to 12. In the present embodiment, the heat pump cycle device according to the present disclosure is applied to a vehicular air conditioner 1 installed in an electric vehicle. An electric vehicle is a vehicle that obtains driving power for traveling from an electric motor. The vehicular air conditioner 1 performs air conditioning of the vehicle interior, which is a space to be air conditioned, and regulates the temperature of an in-vehicle device. Therefore, the vehicular air conditioner 1 can be referred to as an air conditioner with an in-vehicle device temperature regulation function or an in-vehicle device temperature regulation device with an air conditioning function.

The vehicular air conditioner 1 specifically regulates the temperature of a battery 70 as an in-vehicle device. The battery 70 is a secondary battery that stores electric power supplied to a plurality of in-vehicle devices operated by electricity. The battery 70 is an assembled battery formed by electrically connecting a plurality of stacked battery cells in series or in parallel. The battery cell of the present embodiment is a lithium-ion battery.

The battery 70 is a heat-generating device that generates heat during operation (i.e., during charging and discharging). The battery 70 tends to decrease in output at low temperatures and deteriorates at high temperatures. This necessitates maintaining the temperature of the battery 70 within an appropriate range (the temperature is 15° C. or higher and 55° C. or lower in the present embodiment). Therefore, in the electric vehicle of the present embodiment, the temperature of the battery 70 is regulated using the vehicular air conditioner 1.

The vehicular air conditioner 1 is configured to switch various operation modes to perform air conditioning in the vehicle interior and temperature regulation of the battery 70. As illustrated in FIGS. 1 to 3, the vehicular air conditioner 1 includes a heat pump cycle 10, a high-temperature-side heat medium circuit 30, a low-temperature-side heat medium circuit 40, an interior air conditioning unit 50, a control device 60, and the like.

First, the heat pump cycle 10 will be described. The heat pump cycle 10 forms a vapor compression refrigeration cycle that regulates the temperatures of the ventilation air blown into the vehicle interior, the high-temperature-side heat medium circulating through the high-temperature-side heat medium circuit 30, and the low-temperature-side heat medium circulating through the low-temperature-side heat medium circuit 40. The heat pump cycle 10 is configured to switch a circuit configuration of a refrigerant circuit in accordance with the operation mode of the vehicular air conditioner 1.

In the heat pump cycle 10, a hydrofluoroolefin (HFO) refrigerant (specifically, R1234yf) is employed as the refrigerant. The heat pump cycle 10 constitutes a subcritical refrigeration cycle in which the pressure of the high-pressure-side refrigerant does not exceed the critical pressure of the refrigerant. Refrigerant oil for lubricating a compressor 11 is mixed in the refrigerant. In the present embodiment, polyethylene glycol (PAG) oil having compatibility with liquid refrigerant is employed as the refrigerating machine oil. A part of the refrigerant machine oil circulates through the heat pump cycle 10 together with the refrigerant.

The compressor 11 sucks, compresses, and discharges the refrigerant in the heat pump cycle 10. The compressor 11 is a two-stage boost type electric compressor in which a low-stage-side compression mechanism with fixed discharge volume and a high-stage-side compression mechanism are driven by a common electric motor. The rotation speed (i.e., refrigerant discharge capacity) of the compressor 11 is controlled by a control signal output from the control device 60 to be described later.

The compressor 11 includes a housing that forms a space for accommodating a low-stage-side compression mechanism, a high-stage-side compression mechanism, an electric motor, and the like. The housing is provided with a low-pressure suction port 11a, an intermediate-pressure suction port 11b, and a discharge port 11c.

The low-pressure suction port 11a is an opening hole for sucking low-pressure refrigerant from the outside of the housing to the low-stage-side compression mechanism. The intermediate-pressure suction port 11b is an opening hole for allowing intermediate-pressure refrigerant to flow from the outside to the inside of the housing to merge with the refrigerant in a compression process from low pressure to high pressure. The intermediate-pressure suction port 11b is connected to the discharge port side of the low-stage-side compression mechanism and the suction port side of the high-stage-side compression mechanism inside the housing. The discharge port 11c is an opening hole for discharging the high-pressure refrigerant discharged from the high-stage-side compression mechanism to the outside of the housing.

The compressor 11 is disposed in a drive device compartment formed on the front side of the vehicle interior. The drive device compartment forms a space in which at least some of devices used for generating or adjusting driving power for vehicle traveling (e.g., an electric motor for vehicle traveling and other devices are disposed.

The inflow port side of a first three-way joint 12a is connected to the discharge port 11c of the compressor 11. The first three-way joint 12a includes three inflow/outflow ports communicating with each other. As the first three-way joint 12a, a joint portion formed by joining a plurality of pipes or a joint portion formed by providing a plurality of refrigerant passages in a metal block or a resin block can be employed.

Moreover, as described later, heat pump cycle 10 of the present embodiment includes a second three-way joint 12b to a ninth three-way joint 12i. The basic configurations of the second three-way joint 12b to the ninth three-way joint 12i is similar to that of the first three-way joint 12a. The basic configurations of three-way joints described in embodiments to be described later are also similar to that of the first three-way joint 12a.

Each of these three-way joints serves as a branch that divides the flow of the refrigerant when one of the three inflow/outflow ports is used as an inflow port and the remaining two are used as outflow ports. Furthermore, each of these three-way joints serves as a joint that merges the flows of the refrigerant when two of the three inflow/outflow ports are used as inflow ports and the remaining one is used as an outflow port. The first three-way joint 12a serves as an upstream branch that divides the flow of the high-pressure refrigerant discharged from the discharge port 11c of the compressor 11.

The inlet side of a refrigerant passage of a water-refrigerant heat exchanger 13 is connected to one outflow port of the first three-way joint 12a. One inflow port side of the seventh three-way joint 12g is connected to the other outflow port of the first three-way joint 12a.

The refrigerant passage from the other outflow port of the first three-way joint 12a to the one inflow port of the seventh three-way joint 12g is a bypass passage 21f that guides the other high-pressure refrigerant divided at the first three-way joint 12a toward the low-pressure suction port 11a. A bypass-side flow rate regulation valve 14f is disposed in the bypass passage 21f.

The bypass-side flow rate regulation valve 14f is a bypass passage-side decompression portion that decompresses the refrigerant (i.e., the other of the refrigerant divided at the first three-way joint 12a) flowing out of the other outflow port of the first three-way joint 12a during a multi-stage hot-gas air-heating mode or other mode to be described later. Furthermore, the bypass-side flow rate regulation valve 14f is a bypass-side flow rate regulation portion that regulates the flow rate (mass flow rate) of the refrigerant flowing through the bypass passage 21f.

The bypass-side flow rate regulation valve 14f is an electric variable throttle mechanism including a valve body that changes a throttle opening and an electric actuator that displaces the valve body. As the electric actuator, a stepping motor or a brushless motor can be employed. The operation of the bypass-side flow rate regulation valve 14f is controlled by a control signal output from the control device 60.

The bypass-side flow rate regulation valve 14f has a full-open function that functions as a simple refrigerant passage without exerting a refrigerant decompression action and a flow rate regulation action by fully opening the valve opening. The bypass-side flow rate regulation valve 14f has a full-close function of closing the refrigerant passage by fully closing the valve opening.

As will be described later, the heat pump cycle 10 of the present embodiment includes an exterior-device high-stage-side expansion valve 14a, an exterior-device low-stage-side expansion valve 14b, a high-stage-side expansion valve 14c, an air-cooling expansion valve 14d, and a cooling expansion valve 14e. The basic configurations of the exterior-device high-stage-side expansion valve 14a, the exterior-device low-stage-side expansion valve 14b, the high-stage-side expansion valve 14c, the air-cooling expansion valve 14d, and the cooling expansion valve 14e are similar to that of the bypass-side flow rate regulation valve 14f.

The basic configurations of the expansion valve and the flow rate regulation valve described in the embodiments to be described later are also similar to those of the bypass-side flow rate regulation valve 14f.

The exterior-device high-stage-side expansion valve 14a, the exterior-device low-stage-side expansion valve 14b, the high-stage-side expansion valve 14c, the air-cooling expansion valve 14d, the cooling expansion valve 14e, and the bypass-side flow rate regulation valve 14f can switch the refrigerant circuit through which the refrigerant circulates by exerting the full-close function described above. Therefore, each of the exterior-device high-stage-side expansion valve 14a, the exterior-device low-stage-side expansion valve 14b, the high-stage-side expansion valve 14c, the air-cooling expansion valve 14d, the cooling expansion valve 14e, and the bypass-side flow rate regulation valve 14f also function as a refrigerant circuit switching portion that switches the refrigerant circuit.

Alternatively, the exterior-device high-stage-side expansion valve 14a, the exterior-device low-stage-side expansion valve 14b, the high-stage-side expansion valve 14c, the air-cooling expansion valve 14d, the cooling expansion valve 14e, and the bypass-side flow rate regulation valve 14f may be formed by combining a variable throttle mechanism that does not have a full-close function and an on/off valve that opens and closes the refrigerant passage. In this case, each on/off valve serves as a refrigerant circuit switching portion.

The water-refrigerant heat exchanger 13 is a heat exchange portion that exchanges heat between high-pressure refrigerant (i.e., one of high-pressure refrigerant divided at the first three-way joint 12a) flowing out of one outflow port of the first three-way joint 12a and high-temperature-side heat medium circulating through the high-temperature-side heat medium circuit 30. In water-refrigerant heat exchanger 13, the heat of the high-pressure refrigerant is radiated to the high-temperature-side heat medium to heat the high-temperature-side heat medium.

The inflow port side of the second the second three-way joint 12b is connected to the outlet of the refrigerant passage of the water-refrigerant heat exchanger 13. The inlet side of the exterior-device high-stage-side expansion valve 14a is connected to one outflow port of the second three-way joint 12b. One inflow port side of the fifth three-way joint 12e is connected to the other outflow port of the second three-way joint 12b. The refrigerant passage from the other outflow port of the second three-way joint 12b to the one inflow port of the fifth three-way joint 12e is a high-pressure-side passage 21a.

A high-pressure-side on/off valve 22a is disposed in the high-pressure-side passage 21a. The high-pressure-side on/off valve 22a is an on/off valve that opens and closes the high-pressure-side passage 21a. The high-pressure-side on/off valve 22a is an electromagnetic valve with its opening/closing operation controlled by a control voltage output from the control device 60.

As will be described later, the heat pump cycle 10 of the present embodiment includes an air-heating on/off valve 22b, an intermediate-pressure-side on/off valve 22c, and a low-pressure-side on/off valve 22d. The air-heating on/off valve 22b, the intermediate-pressure-side on/off valve 22c, and the low-pressure-side on/off valve 22d are basically configured similarly to the high-pressure-side on/off valve 22a. The basic configurations of the on/off valves described in the embodiments to be described later are also similar to that of the high-pressure-side on/off valve 22a.

The high-pressure-side on/off valve 22a, the air-heating on/off valve 22b, the intermediate-pressure-side on/off valve 22c, and the low-pressure-side on/off valve 22d can switch the refrigerant circuit by opening and closing the refrigerant passage. Therefore, the high-pressure-side on/off valve 22a, the air-heating on/off valve 22b, the intermediate-pressure-side on/off valve 22c, and the low-pressure-side on/off valve 22d are refrigerant circuit switching portions that switch the refrigerant circuit.

The exterior-device high-stage-side expansion valve 14a is an exterior-device high-stage-side decompression portion that decompresses the refrigerant flowing out of the water-refrigerant heat exchanger 13 during an outside air endothermic air-heating mode to be described later. Furthermore, the exterior-device high-stage-side expansion valve 14a is an exterior-device high-stage-side flow rate regulation portion that regulates the flow rate (mass flow rate) of the refrigerant flowing into an air-heating gas-liquid separator 15a.

The inlet side of the air-heating gas-liquid separator 15a is connected to the outlet of the exterior-device high-stage-side expansion valve 14a. The air-heating gas-liquid separator 15a is a heating gas-liquid separation portion that separates the refrigerant flowing out of the exterior-device high-stage-side expansion valve 14a into gas and liquid.

In the present embodiment, as the air-heating gas-liquid separator 15a, a centrifugation-type (cyclone separator-type) gas-liquid separation portion that separates the refrigerant into gas and liquid by the action of centrifugal force is employed. Furthermore, in the present embodiment, as the air-heating gas-liquid separator 15a, a gas-liquid separation portion having a relatively small internal volume that discharges the separated liquid refrigerant without storing the refrigerant therein is employed.

One inflow port side of the third three-way joint 12c is connected to the gas refrigerant outlet of the air-heating gas-liquid separator 15a. The refrigerant passage from the gas refrigerant outlet of the air-heating gas-liquid separator 15a to the one inflow port of the third three-way joint 12c is an air-heating intermediate-pressure passage 21b. The air-heating on/off valve 22b is disposed in the air-heating intermediate-pressure passage 21b. The air-heating on/off valve 22b opens and closes the air-heating intermediate-pressure passage 21b.

The intermediate-pressure suction port 11b side of the compressor 11 is connected to the outflow port of the third three-way joint 12c. The refrigerant passage from the outflow port of the third three-way joint 12c to the intermediate-pressure suction port 11b of the compressor 11 is an intermediate-pressure passage 21c. The intermediate-pressure-side on/off valve 22c is disposed in the intermediate-pressure passage 21c. The intermediate-pressure-side on/off valve 22c is an intermediate-pressure-side opening/closing portion that opens and closes the intermediate-pressure passage 21c.

The inlet side of the exterior-device low-stage-side expansion valve 14b is connected to the liquid refrigerant outlet of the air-heating gas-liquid separator 15a. The exterior-device low-stage-side expansion valve 14b is an exterior-device low-stage-side decompression portion that decompresses the refrigerant flowing out of the air-heating gas-liquid separator 15a during the outside air endothermic air-heating mode. Furthermore, the exterior-device low-stage-side expansion valve 14b is an exterior-device low-stage-side flow rate regulation portion that regulates the flow rate (mass flow rate) of the refrigerant flowing into the exterior heat exchanger 16.

The refrigerant inlet side of the exterior heat exchanger 16 is connected to the outlet of the exterior-device low-stage-side expansion valve 14b. The exterior heat exchanger 16 is an exterior heat exchanger that exchanges heat between the refrigerant decompressed by the exterior-device low-stage-side expansion valve 14b and outside air blown by an outside air fan (not illustrated). The exterior heat exchanger 16 is disposed on the front side of the drive device compartment. Therefore, when the vehicle is traveling, traveling air flowing into the drive device compartment via a grill can be blown against the exterior heat exchanger 16.

The exterior heat exchanger 16 serves as a refrigerant radiator that radiates the heat of the refrigerant to the outside air during an air-cooling mode or other mode to be described later. The exterior heat exchanger 16 serves as a refrigerant heat absorber that causes the refrigerant to absorb outside-air-side heat of the outside air during the outside air endothermic air-heating mode or other modes.

The inlet side of the fourth three-way joint 12d is connected to the refrigerant outlet of the exterior heat exchanger 16. The other inflow port side of the fifth three-way joint 12e is connected to one outflow port of the fourth three-way joint 12d via a first check valve 17a. The first check valve 17a allows the refrigerant to flow from the fourth three-way joint 12d side to the fifth three-way joint 12e side, and prohibits the refrigerant from flowing from the fifth three-way joint 12e side to the fourth three-way joint 12d side.

One inflow port side of the ninth three-way joint 12i is connected to the other outflow port of the fourth three-way joint 12d. The refrigerant passage from the other outflow port of the fourth three-way joint 12d to the one inflow port of the ninth three-way joint 12i is a low-pressure-side passage 21d. The low-pressure-side on/off valve 22d is disposed in the low-pressure-side passage 21d. The low-pressure-side on/off valve 22d opens and closes the low-pressure-side passage 21d.

The high-stage-side expansion valve 14c is disposed at the outflow port of the fifth three-way joint 12e. The high-stage-side expansion valve 14c is a high-stage-side decompression portion that decompresses the refrigerant flowing out of the water-refrigerant heat exchanger 13 during an air-cooling mode, a multi-stage hot-gas air-heating mode, or other mode to be described later. Furthermore, the high-stage-side expansion valve 14c is a high-stage-side flow rate regulation portion that regulates the flow rate (mass flow rate) of the refrigerant flowing into a hot-gas gas-liquid separator 15b.

The inlet side of the hot-gas gas-liquid separator 15b is connected to the outlet of the high-stage-side expansion valve 14c. The hot-gas gas-liquid separator 15b is a hot-gas gas-liquid separation portion that separates the refrigerant flowing out of the high-stage-side expansion valve 14c into gas and liquid. As the hot-gas gas-liquid separator 15b, a gas-liquid separation portion similar to the air-heating gas-liquid separator 15a can be employed.

The other inflow port side of the third three-way joint 12c is connected to the gas refrigerant outlet of the hot-gas gas-liquid separator 15b. The refrigerant passage from the gas refrigerant outlet of the hot-gas gas-liquid separator 15b to the other inflow port of the third three-way joint 12c is a hot-gas intermediate-pressure passage 21e. A second check valve 17b is disposed in the hot-gas intermediate-pressure passage 21e.

The second check valve 17b allows the refrigerant to flow from the hot-gas gas-liquid separator 15b side to the third three-way joint 12c side, and prohibits the refrigerant from flowing from the third three-way joint 12c side to the hot-gas gas-liquid separator 15b side.

The inflow port side of the sixth three-way joint 12f is connected to the liquid refrigerant outlet of the hot-gas gas-liquid separator 15b. The refrigerant inlet side of an interior evaporator 18 is connected to one outflow port of the sixth three-way joint 12f. The refrigerant inlet side of a chiller 20 is connected to the other outflow port of the sixth three-way joint 12f.

The air-cooling expansion valve 14d is disposed in the refrigerant passage from one outflow port of the sixth three-way joint 12f to the refrigerant inlet of the interior evaporator 18. The air-cooling expansion valve 14d is an interior-side decompression portion that decompresses the refrigerant flowing out of one outflow port of the sixth three-way joint 12f during an air-cooling mode to be described later. Furthermore, the air-cooling expansion valve 14d is an interior-side flow rate regulation portion that regulates the flow rate (mass flow rate) of the refrigerant flowing into the interior evaporator 18.

The air-cooling expansion valve 14d is included in a low-stage-side decompression portion that decompresses the liquid refrigerant separated by the hot-gas gas-liquid separator 15b.

The interior evaporator 18 is disposed in an air conditioning case 51 of an interior air conditioning unit 50 to be described later. The interior evaporator 18 is an air cooling heat exchange portion that exchanges heat between the low-pressure refrigerant decompressed by the air-cooling expansion valve 14d and the ventilation air blown from an interior blower 52 toward the vehicle interior. The interior evaporator 18 is an air conditioning evaporator that cools ventilation air by evaporating the low-pressure refrigerant to exert an endothermic action.

Therefore, the interior evaporator 18 is a ventilation air cooling portion that evaporates the refrigerant decompressed by the cooling expansion valve 14e to cool the ventilation air as an object to be cooled by the vehicular air conditioner 1.

One inflow port side of the eighth three-way joint 12h is connected to the refrigerant outlet of the interior evaporator 18. An evaporating pressure regulation valve 19 is disposed in the refrigerant passage from the refrigerant outlet of the interior evaporator 18 to one inflow port of the eighth three-way joint 12h.

The evaporating pressure regulation valve 19 is a variable throttle mechanism that maintains the refrigerant evaporating temperature at the interior evaporator 18 at a level equal to or higher than a temperature (1° C. in the present embodiment) that can suppress frosting at the interior evaporator 18. The evaporating pressure regulation valve 19 includes a mechanical mechanism that increases the valve opening as the pressure of the refrigerant on the refrigerant outlet side of the interior evaporator 18 increases.

The cooling expansion valve 14e is disposed in the refrigerant passage from the other outflow port of the sixth three-way joint 12f to the refrigerant inlet of the chiller 20. The cooling expansion valve 14e is a cooling-side decompression portion that decompresses the refrigerant flowing out of the other outflow port of the sixth three-way joint 12f during the operation mode for cooling the battery 70. Furthermore, the cooling expansion valve 14e is a cooling-side flow rate regulation portion that regulates the flow rate (mass flow rate) of the refrigerant flowing into the chiller 20.

The cooling expansion valve 14e is included in a low-stage-side decompression portion that decompresses the liquid refrigerant separated by the hot-gas gas-liquid separator 15b.

The chiller 20 is a low-temperature-side heat exchange portion that exchanges heat between the low-pressure refrigerant decompressed by the cooling expansion valve 14e and the low-temperature-side heat medium circulating through the low-temperature-side heat medium circuit 40. The chiller 20 is an evaporator that cools the low-temperature-side heat medium by evaporating the low-pressure refrigerant to exert an endothermic action.

The other inflow port side of the seventh three-way joint 12g is connected to the refrigerant outlet of the chiller 20. The other inflow port side of the eighth three-way joint 12h is connected to the outflow port of the seventh three-way joint 12g. The other inflow port side of the ninth three-way joint 12i is connected to the outflow port of the eighth three-way joint 12h.

The inlet side of an accumulator 23 is connected to the outflow port of the ninth three-way joint 12i. The accumulator 23 is a low-pressure-side liquid storage that separates the refrigerant flowing into the accumulator into gas and liquid, and stores the separated liquid refrigerant as a surplus refrigerant of the cycle. The gas refrigerant outlet of the accumulator 23 is connected to the suction port side of the compressor 11.

The seventh three-way joint 12g merges the flow of the refrigerant flowing out of the cooling expansion valve 14e and the flow of the refrigerant flowing out of the bypass-side flow rate regulation valve 14f during a single-stage hot-gas air-heating mode and a multi-stage hot-gas air-heating mode to be described later. Accordingly, the seventh three-way joint 12g serves as a joint that allows the merged refrigerant to flow toward the suction port side of the compressor 11.

Furthermore, the eighth three-way joint 12h merges the flow of the refrigerant flowing out of the air-cooling expansion valve 14d and the flow of the refrigerant flowing out of the bypass-side flow rate regulation valve 14f during a multi-stage inside air endothermic hot-gas air-heating mode to be described later. Therefore, the eighth three-way joint 12h serves as a joint that allows the merged refrigerant to flow into the suction port side of the compressor 11.

Next, the high-temperature-side heat medium circuit 30 will be described. The high-temperature-side heat medium circuit 30 is a heat medium circulation circuit that circulates the high-temperature-side heat medium. In the present embodiment, an ethylene glycol aqueous solution is employed as the high-temperature-side heat medium. In the high-temperature-side heat medium circuit 30, the heat medium passage of the water-refrigerant heat exchanger 13, a high-temperature-side pump 31, a heater core 32, and the like are disposed.

The high-temperature-side pump 31 is a high-temperature-side heat medium pressure transfer portion that pressure-feeds the high-temperature-side heat medium flowing out of the heat medium passage of the water-refrigerant heat exchanger 13 to the heat medium inlet side of the heater core 32. The high-temperature-side pump 31 is an electric pump having a rotation speed (i.e., pressure feeding capacity) controlled by a control voltage output from the control device 60.

The heater core 32 is a heating heat exchanger that exchanges heat between the high-temperature-side heat medium heated by the water-refrigerant heat exchanger 13 and the ventilation air passing through the interior evaporator 18 to heat the ventilation air. The heater core 32 is disposed in the air conditioning case 51 of the interior air conditioning unit 50. The inlet side of a heat medium passage of the water-refrigerant heat exchanger 13 is connected to the heat medium outlet of the heater core 32.

Therefore, each of the components, the water-refrigerant heat exchanger 13 and the high-temperature-side heat medium circuit 30 in the present embodiment, is a heating portion that heats ventilation air as an object to be heated using one high-pressure refrigerant divided at the first three-way joint 12a as a heat source.

Next, the low-temperature-side heat medium circuit 40 will be described. The low-temperature-side heat medium circuit 40 is a heat medium circuit that circulates the low-temperature-side heat medium. In the present embodiment, the same type of fluid as the high-temperature-side heat medium is employed as the low-temperature-side heat medium. A low-temperature-side pump 41, a cooling water passage 70a of the battery 70, the heat medium passage of the chiller 20, and the like are connected to the low-temperature-side heat medium circuit 40.

The low-temperature-side pump 41 is a low-temperature-side heat medium pressure transfer portion that pressure-feeds the low-temperature-side heat medium flowing out of the cooling water passage 70a of the battery 70 to the inlet side of the heat medium passage of the chiller 20. The basic configuration of the low-temperature-side pump 41 is similar to that of the high-temperature-side pump 31. The inlet side of the cooling water passage 70a of the battery 70 is connected to the outlet side of the heat medium passage of the chiller 20.

The cooling water passage 70a of the battery 70 is a cooling water passage formed to cool the battery 70 by flowing through the low-temperature-side heat medium cooled by the chiller 20. The cooling water passage 70a is formed inside a battery-dedicated case that accommodates a plurality of stacked battery cells.

The passage configuration of the cooling water passage 70a is a passage configuration in which a plurality of passages are connected in parallel inside the battery-dedicated case. As a result, all the battery cells can be uniformly cooled in the cooling water passage 70a. The suction port side of the low-temperature-side pump 41 is connected to the outlet of the cooling water passage 70a.

Therefore, each of the components, the chiller 20 and the low-temperature-side heat medium circuit 40, is a device cooling portion that evaporates the refrigerant decompressed by the cooling expansion valve 14e to cool the battery 70, which is an object to be cooled by the vehicular air conditioner 1.

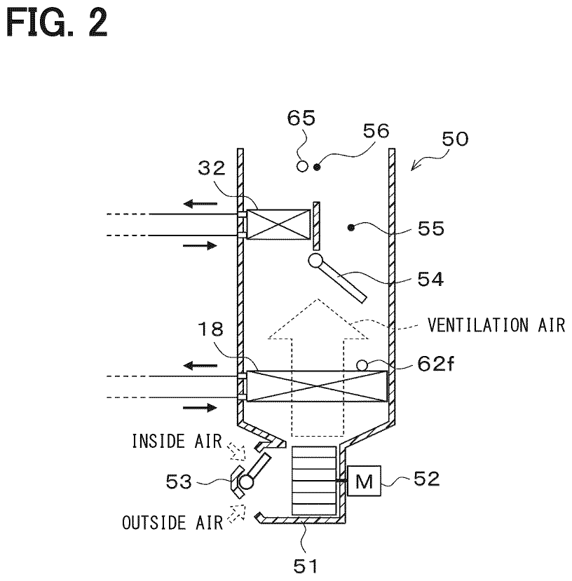

Next, the interior air conditioning unit 50 will be described with reference to FIG. 2. The interior air conditioning unit 50 is a unit in which a plurality of components are integrated to blow ventilation air regulated to an appropriate temperature for air conditioning in the vehicle interior to an appropriate location in the vehicle interior. The interior air conditioning unit 50 is disposed inside an instrument panel at the foremost portion of the vehicle interior.

The interior air conditioning unit 50 is formed by accommodating the interior blower 52, the interior evaporator 18, the heater core 32, and the like in the air conditioning case 51 forming an air passage for ventilation air. The air conditioning case 51 is made of resin (e.g., polypropylene) having a certain degree of elasticity and excellent strength.

An inside/outside air switching device 53 is disposed on the most upstream side in the ventilation air flow of the air conditioning case 51. The inside/outside air switching device 53 performs switching to introduce inside air (i.e., air inside the vehicle interior) and outside air (i.e., air outside the vehicle interior) into the air conditioning case 51. The operation of the inside/outside air switching device 53 is controlled by a control signal output from the control device 60.

The interior blower 52 is disposed on the ventilation-air-flow downstream side of the inside/outside air switching device 53. The interior blower 52 is a blowing portion that blows air drawn via the inside/outside air switching device 53 toward the vehicle interior. The rotation speed (i.e., air blowing capacity) of the interior blower 52 is controlled by a control voltage output from the control device 60.

The interior evaporator 18 and the heater core 32 are disposed on the ventilation-air-flow downstream side of the interior blower 52. The interior evaporator 18 is disposed on the ventilation-air-flow upstream side of the heater core 32. In the air conditioning case 51, a cold air bypass passage 55 is formed to allow the ventilation air, after passing through the interior evaporator 18, to flow while bypassing the heater core 32.

An air mix door 54 is disposed on the ventilation-air-flow downstream side of the interior evaporator 18 in the air conditioning case 51 and on the ventilation-air-flow upstream side of the heater core 32 and the cold air bypass passage 55.

The air mix door 54 adjusts the air volume ratio of the ventilation air after passing through the interior evaporator 18, between the air volume of the ventilation air passing through the heater core 32 and the air volume of the ventilation air passing through the cold air bypass passage 55. The operation of the actuator for driving the air mix door 54 is controlled by a control signal output from the control device 60.

A mixing space 56 is disposed on the ventilation-air-flow downstream side of the heater core 32 and the cold air bypass passage 55. The mixing space 56 is a space for mixing the ventilation air heated by the heater core 32 and the ventilation air passing through the cold air bypass passage 55 and not heated.

Therefore, in the interior air conditioning unit 50, the temperature of the ventilation air (i.e., conditioned air) mixed in the mixing space 56 and blown into the vehicle interior can be regulated by adjusting the opening of the air mix door 54.

A plurality of opening holes (not illustrated) for blowing conditioned air toward various places in the vehicle interior is formed in the ventilation air flow most downstream portion of the air conditioning case 51. In each of the plurality of opening holes, a blowout mode door (not illustrated), which opens and closes the opening hole, is disposed. The operation of the actuator for driving the blowout mode door is controlled by a control signal output from the control device 60.

Therefore, in the interior air conditioning unit 50, the conditioned air regulated to an appropriate temperature can be blown to an appropriate location in the vehicle interior by switching the opening hole where the blowout mode door opens and closes.

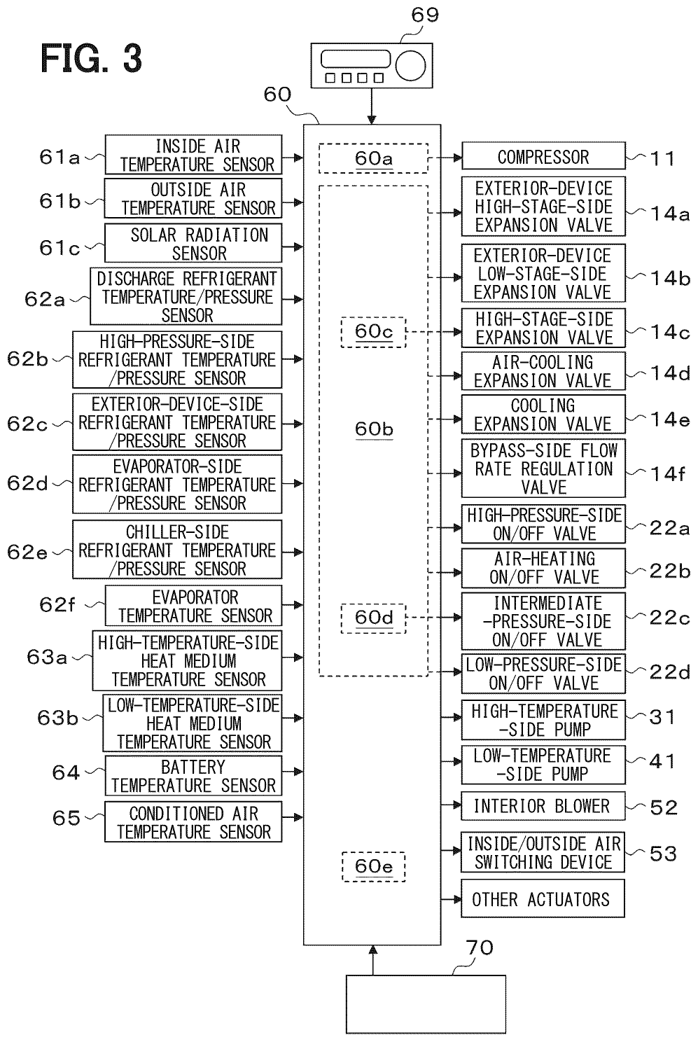

Next, the electric control portion of the present embodiment will be described with reference to a block diagram of FIG. 3. The control device 60 includes a known microcomputer including a central processing unit (CPU), a read-only memory (ROM), a read-only memory (RAM), and the like and peripheral circuits thereof. The control device 60 performs various operations and processing based on a control program stored in the ROM. Then, the control device 60 controls the operations of various devices to be controlled, which are connected to the output side, based on the calculation and processing results.

A group of sensors for control is connected to the input side of the control device 60, the sensors including: an inside air temperature sensor 61a, an outside air temperature sensor 61b, a insolation amount sensor 61c, a discharge refrigerant temperature/pressure sensor 62a, a high-pressure-side refrigerant temperature/pressure sensor 62b, an exterior-device-side refrigerant temperature/pressure sensor 62c, an evaporator-side refrigerant temperature/pressure sensor 62d, a chiller-side refrigerant temperature/pressure sensor 62e, an evaporator temperature sensor 62f, a high-temperature-side heat medium temperature sensor 63a, a low-temperature-side heat medium temperature sensor 63b, a battery temperature sensor 64, and an conditioned air temperature sensor 65.

The inside air temperature sensor 61a is an inside air temperature detection portion that detects a vehicle interior temperature (inside air temperature) Tr. The outside air temperature sensor 61b is an outside air temperature detection portion that detects a vehicle exterior temperature (outside air temperature) Tam. The insolation amount sensor 61c is an insolation amount detection portion for detecting an insolation amount As with which the vehicle interior is irradiated.

The discharge refrigerant temperature/pressure sensor 62a is a discharge refrigerant temperature/pressure detection portion that detects a discharge refrigerant temperature Td and a discharge refrigerant pressure Pd of the discharge refrigerant discharged from the compressor 11.

The high-pressure-side refrigerant temperature/pressure sensor 62b is a high-pressure-side refrigerant temperature/pressure detection portion that detects a high-pressure-side refrigerant temperature T1 and a high-pressure-side refrigerant pressure P1 of the refrigerant flowing out of the water-refrigerant heat exchanger 13.

The exterior-device-side refrigerant temperature/pressure sensor 62c is an exterior-device-side refrigerant temperature/pressure detection portion that detects an exterior-device-side refrigerant temperature T2 and an exterior-device-side refrigerant pressure P2 of the refrigerant flowing out of the exterior heat exchanger 16.

The evaporator-side refrigerant temperature/pressure sensor 62d is an evaporator-side refrigerant temperature/pressure detection portion that detects an evaporator-side refrigerant temperature Te and an evaporator-side refrigerant pressure Pe of the refrigerant flowing out of the interior evaporator 18.

The chiller-side refrigerant temperature/pressure sensor 62e is a chiller-side refrigerant temperature/pressure detection portion that detects a chiller-side refrigerant temperature Tc and a chiller-side refrigerant pressure Pc of the refrigerant flowing out of the refrigerant passage of the chiller 20. Specifically, the chiller-side refrigerant temperature/pressure sensor 62e of the present embodiment detects the temperature and pressure of the refrigerant before flowing out of the seventh three-way joint 12g and flowing into the other inflow port of the eighth three-way joint 12h.

In the present embodiment, a detection portion integrating both a pressure detection portion and a temperature detection portion is employed as the refrigerant temperature/pressure sensor. However, a pressure detection portion and a temperature detection portion configured separately may also be employed.

The evaporator temperature sensor 62f is an evaporator temperature detection portion that detects a refrigerant evaporating temperature (evaporator temperature) Tefin at the interior evaporator 18. Specifically, the evaporator temperature sensor 62f of the present embodiment detects the heat exchange fin temperature of the interior evaporator 18.

The high-temperature-side heat medium temperature sensor 63a is a high-temperature-side heat medium temperature detection portion that detects a high-temperature-side heat medium temperature TWH, which is the temperature of the high-temperature-side heat medium flowing into the heater core 32. The low-temperature-side heat medium temperature sensor 63b is a low-temperature-side heat medium temperature detection portion that detects a low-temperature-side heat medium temperature TWL, which is the temperature of the low-temperature-side heat medium flowing out of the cooling water passage 70a of the battery 70.

The battery temperature sensor 64 is a battery temperature detection portion that detects a battery temperature TB, which is the temperature of the battery 70. The battery temperature sensor 64 includes a plurality of temperature sensors and detects temperatures at a plurality of locations of the battery 70. Therefore, the control device 60 can detect a temperature difference and a temperature distribution of each battery cell forming the battery 70. Furthermore, as the battery temperature TB, an average value of detection values of the plurality of temperature sensors is employed.

The conditioned air temperature sensor 65 detects a ventilation air temperature TAV, which is the temperature of the ventilation air blown into the vehicle interior from the mixing space 56. Accordingly, the air-conditioned air temperature sensor 65 is an heating-object temperature detection portion that detects an object temperature of ventilation air as an object to be heated.

As illustrated in FIG. 3, an operation panel 69 disposed in the vicinity of the instrument panel in the front of the vehicle interior is connected to the input side of the control device 60. Operation signals from various operation switches provided on the operation panel 69 are input to the control device 60.

Specific examples of the various operation switches provided on the operation panel 69 include an automatic switch, an air conditioner switch, an air volume setting switch, and a temperature setting switch.

The automatic switch is an automatic control setting portion that sets or cancels the automatic control operation of the vehicular air conditioner 1. The air conditioner switch is a cooling request portion that requests the interior evaporator 18 to cool the ventilation air. The air volume setting switch is an air volume setting portion that manually sets the amount of air blown by the interior blower 52. The temperature setting switch is a temperature setting portion that sets a set temperature Tset in the vehicle interior.

The control device 60 of the present embodiment is integrally configured with a control portion that controls various devices to be controlled that are connected to the output side thereof. Therefore, a configuration for controlling the operation of each device to be controlled (i.e., hardware and software) forms a controller that controls the operation of each device to be controlled.

For example, in the control device 60, the configuration for controlling the refrigerant discharge capacity of the compressor 11 is a discharge capacity control portion 60a. The configuration for controlling the operation of the refrigerant circuit switching portion is a refrigerant circuit control portion 60b. The refrigerant circuit control portion 60b includes an intermediate-pressure opening/closing control portion 22c that controls the operation of the intermediate-pressure-side on/off valve 60c. The refrigerant circuit control portion 60b includes a high-stage-side decompression control portion 60d that controls the operation of the high-stage-side expansion valve 14c.

Moreover, in the control device 60, the configuration for determining a target blowout temperature TAO, which is a target temperature of the ventilation air blown into the vehicle interior, is a target temperature determination portion 60e.

Next, the operation of the vehicular air conditioner 1 of the present embodiment having the above configuration will be described. The vehicular air conditioner 1 switches various operation modes to perform air conditioning of the vehicle interior and temperature regulation of the battery 70. The operation mode is switched by executing a control program stored in advance in the control device 60.

The control program is executed not only when the start switch (so-called ignition switch) of the vehicle system is turned on and the vehicle system is starting, but also when the battery 70 is being charged from an external power supply. In the control program, the vehicle interior is air-conditioned when the automatic switch is turned on.

The control program reads the detection signal of the control sensor group and the operation signal of the operation panel 69 described above. The target temperature determination portion 60e determines the target blowout temperature TAO based on the read detection and operation signals.

The target temperature determination portion 60e calculates the target blowout temperature TAO using the following Formula F1.

TAO=Kset×Tset−Kr×Tr−Kam×Tam−Ks×As+C (F1)

Tset is a set temperature in the vehicle interior set by the temperature setting switch. Tr is an inside air temperature detected by the inside air temperature sensor 61a. Tam is an outside air temperature detected by the outside air temperature sensor 61b. As is an insolation amount detected by the insolation amount sensor 61c. Kset, Kr, Kam, and Ks are control gains, and C is a correction constant.

Moreover, in the control program, the operation mode is selected based on the detection signal, the operation signal, the target blowout temperature TAO, and the like, and the operations of the various devices to be controlled are controlled in accordance with the selected operation modes.

Thereafter, the control routine described above, such as reading detection and operation signals, determining the target blowout temperature TAO, selecting the operation mode, and controlling various devices according to the selected operation mode, is repeated every predetermined control cycle until the termination condition of the control program is satisfied. The detailed operation of each operation mode will be described below.

### (a) Air-Cooling Mode

The air-cooling mode is an operation mode for cooling the vehicle interior by blowing the cooled ventilation air into the vehicle interior. The air-cooling mode is easily selected when the outside air temperature Tam is relatively high or when the target blowout temperature TAO is relatively low in a state where the automatic switch and the air conditioner switch are turned on.

The air-cooling mode includes a single air-cooling mode for cooling the vehicle interior without cooling the battery 70, and a cooling and air-cooling mode for cooling the vehicle interior while cooling the battery 70. The single air-cooling mode is included in a cooling mode for cooling ventilation air as an object to be cooled. The cooling and air-cooling mode is included in a cooling mode for cooling the ventilation air and the low-temperature-side heat medium as the object to be cooled.

In the control program of the present embodiment, an operation mode for cooling the battery 70 is executed when the battery temperature TB detected by the battery temperature sensor 64 becomes equal to or higher than a predetermined reference upper limit temperature KTBH.

(a-1) Single Air-Cooling Mode

In the heat pump cycle 10 in the single air-cooling mode, the control device 60 brings the exterior-device high-stage-side expansion valve 14a into a fully open state, brings the exterior-device low-stage-side expansion valve 14b into the fully open state, brings the high-stage-side expansion valve 14c into a throttled state that exerts a decompression action, brings the air-cooling expansion valve 14d into the throttled state, brings the cooling expansion valve 14e into a fully closed state, and brings the bypass-side flow rate regulation valve 14f into the fully closed state.

The control device 60 closes the high-pressure-side on/off valve 22a, closes the air-heating on/off valve 22b, opens the intermediate-pressure-side on/off valve 22c, and closes the low-pressure-side on/off valve 22d.

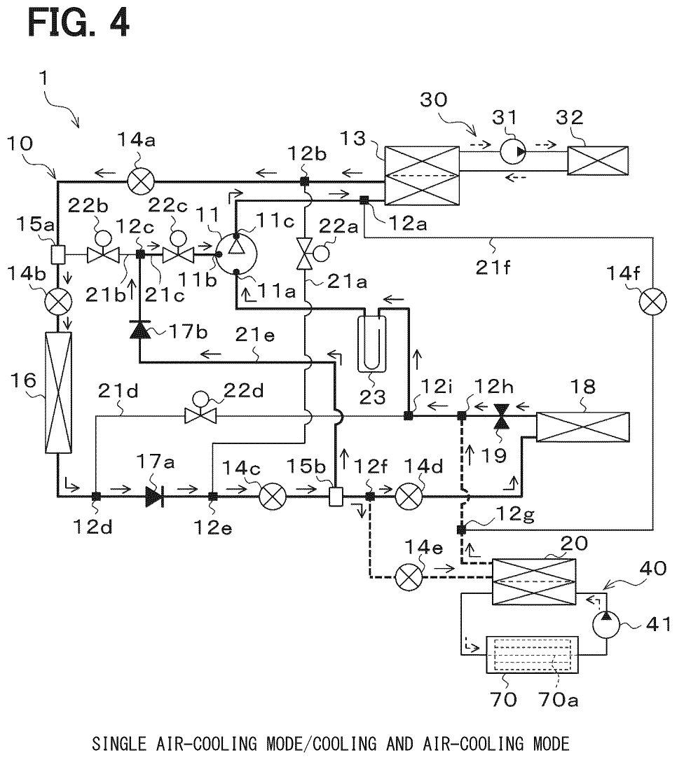

Therefore, in the heat pump cycle 10 in the single air-cooling mode, as indicated by the thick solid lines and arrows in FIG. 4, the refrigerant discharged from the discharge port 11c of the compressor 11 flows through the water-refrigerant heat exchanger 13, the exterior-device high-stage-side expansion valve 14a in the fully open state, the air-heating gas-liquid separator 15a, the exterior-device low-stage-side expansion valve 14b in the fully open state, the exterior heat exchanger 16, the high-stage-side expansion valve 14c, and the hot-gas gas-liquid separator 15b in this order. The gas refrigerant separated by the hot-gas gas-liquid separator 15b flows through the hot-gas intermediate-pressure passage 21e, the intermediate-pressure passage 21c, and the intermediate-pressure suction port 11b of the compressor 11 in this order. At the same time, the liquid refrigerant separated by the hot-gas gas-liquid separator 15b is switched to the refrigerant circuit in which the liquid refrigerant flows through the air-cooling expansion valve 14d, the interior evaporator 18, the evaporating pressure regulation valve 19, the accumulator 23, and the low-pressure suction port 11a of the compressor 11 in this order.

Moreover, the control device 60 controls the refrigerant discharge capacity of the compressor 11 such that the evaporator temperature Tefin detected by the evaporator temperature sensor 62f approaches a target evaporator temperature TEO.

The target evaporator temperature TEO is determined based on the target blowout temperature TAO with reference to a control map for the air-cooling mode stored in advance in the control device 60. In the control map, the target evaporator temperature TEO is determined to increase as the target blowout temperature TAO increases. The target evaporator temperature TEO is determined to be a value (at least 1° C. or higher in the present embodiment) at which frosting on the interior evaporator 18 can be prevented.

The control device 60 also controls the throttle opening of the high-stage-side expansion valve 14c such that a degree of subcooling SC2 of the refrigerant flowing out of the exterior heat exchanger 16 approaches a predetermined reference degree of subcooling KSC2. The degree of subcooling SC2 of the refrigerant flowing out of the exterior heat exchanger 16 can be determined from the exterior-device-side refrigerant temperature T2 and the exterior-device-side refrigerant pressure P2 detected by the exterior-device-side refrigerant temperature/pressure sensor 62c.

The control device 60 controls the throttle opening of the air-cooling expansion valve 14d to be a predetermined reference opening for the air-cooling mode.

In the high-temperature-side heat medium circuit 30 in the single air-cooling mode, the control device 60 controls the operation of the high-temperature-side pump 31 to exert predetermined reference pressure-feeding capacity. Therefore, in the high-temperature-side heat medium circuit 30 in the single air-cooling mode, as indicated by the broken-line arrows in FIG. 4, the high-temperature-side heat medium pressure-fed from the high-temperature-side pump 31 circulates through the heater core 32, the heat medium passage of the water-refrigerant heat exchanger 13, and the suction port of the high-temperature-side pump 31 in this order.

In the interior air conditioning unit 50 in the single air-cooling mode, the control device 60 controls the blowing capacity of the interior blower 52 with reference to a control map stored in advance in the control device 60 based on the target blowout temperature TAO. In the control map, the amount of air blown by the interior blower 52 is determined to be maximized in an extremely low temperature range (maximum air-cooling range) and an extremely high temperature range (maximum air-heating range) of the target blowout temperature TAO, and the amount of blown air is determined to be decreased as the temperature approaches the intermediate temperature range.

The control device 60 adjusts the opening of the air mix door 54 such that the ventilation air temperature TAV detected by the conditioned air temperature sensor 65 approaches the target blowout temperature TAO. Furthermore, the control device 60 appropriately controls the operation of other devices to be controlled.

Therefore, in the heat pump cycle 10 in the single air-cooling mode, a two-stage boost type vapor compression refrigeration cycle is configured in which the water-refrigerant heat exchanger 13 and the exterior heat exchanger 16 function as condensers that radiate heat of the refrigerant and condense the refrigerant, and the interior evaporator 18 functions as an evaporator that evaporates the refrigerant. More specifically, in the heat pump cycle 10 in the single air-cooling mode, a so-called gas-liquid separation-type gas injection cycle is configured.

In water-refrigerant heat exchanger 13, the refrigerant radiates heat to the high-temperature-side heat medium to heat the high-temperature-side heat medium. In the exterior heat exchanger 16, the refrigerant radiates heat to the outside air. In the interior evaporator 18, the refrigerant absorbs heat from the ventilation air to cool the ventilation air.

In the high-temperature-side heat medium circuit 30 in the single air-cooling mode, the high-temperature-side heat medium heated by the water-refrigerant heat exchanger 13 flows into the heater core 32.

In the interior air conditioning unit 50 in the single air-cooling mode, the ventilation air from the interior blower 52 is cooled by the interior evaporator 18. The ventilation air cooled by the interior evaporator 18 is heated by the heater core 32 in accordance with the opening of the air mix door 54. The conditioned air having a temperature regulated to approach the target blowout temperature TAO is blown into the vehicle interior. This achieves cooling of the vehicle interior.

(a-2) Cooling and Air-Cooling Mode

In the heat pump cycle 10 in the cooling and air-cooling mode, the control device 60 brings the cooling expansion valve 14e into the throttled state compared to the single air-cooling mode.

Therefore, in the heat pump cycle 10 in the cooling and air-cooling mode, as indicated by the thick solid lines and arrows in FIG. 4, the refrigerant discharged from the discharge port 11c of the compressor 11 flows as in the single air-cooling mode. At the same time, as indicated by the thick broken lines and arrows in FIG. 4, the liquid refrigerant separated by the hot-gas gas-liquid separator 15b is switched to the refrigerant circuit in which the liquid refrigerant flows through the cooling expansion valve 14e, the chiller 20, the accumulator 23, and the low-pressure suction port 11a of the compressor 11 in this order.

That is, in the heat pump cycle 10 in the cooling and air-cooling mode, the interior evaporator 18 and the chiller 20 are switched to the refrigerant circuit connected in parallel to the flow of the refrigerant flowing out of the hot-gas gas-liquid separator 15b.

Moreover, the control device 60 controls the throttle opening of the cooling expansion valve 14e to be a predetermined throttle opening for the cooling and air-cooling mode.

In the high-temperature-side heat medium circuit 30 in the cooling and air-cooling mode, the control device 60 operates the high-temperature-side pump 31 as in the single air-cooling mode.

In the low-temperature-side heat medium circuit 40 in the cooling and air-cooling mode, the control device 60 controls the operation of the low-temperature-side pump 41 to exert predetermined reference pressure-feeding capacity. Therefore, in the low-temperature-side heat medium circuit 40 in the cooling and air-cooling mode, as indicated by the broken-line arrows in FIG. 4, the high-temperature-side heat medium pressure-fed from the low-temperature-side pump 41 circulates through the heat medium passage of the chiller 20, the cooling water passage 70a of the battery 70, and the suction port of the low-temperature-side pump 41 in this order.

In the interior air conditioning unit 50 in the cooling and air-cooling mode, the control device 60 controls the blowing capacity of the interior blower 52 and the opening of the air mix door 54 as in the single air-cooling mode. Furthermore, the control device 60 appropriately controls the operation of other devices to be controlled.

Accordingly, in the heat pump cycle 10 in the cooling and air-cooling mode, a gas-liquid separation-type gas injection cycle is configured in which the water-refrigerant heat exchanger 13 and the exterior heat exchanger 16 function as condensers, and the interior evaporator 18 and the chiller 20 function as evaporators.

In the water-refrigerant heat exchanger 13, the high-temperature-side heat medium is heated as in the single air-cooling mode. In the exterior heat exchanger 16, the refrigerant radiates heat to the outside air. In the interior evaporator 18, the ventilation air is cooled as in the single air-cooling mode. In the chiller 20, the refrigerant absorbs heat from the low-temperature-side heat medium to cool the low-temperature-side heat medium.

In the high-temperature-side heat medium circuit 30 in the cooling and air-cooling mode, the high-temperature-side heat medium heated by the water-refrigerant heat exchanger 13 flows into the heater core 32 as in the single air-cooling mode.

In the low-temperature-side heat medium circuit 40 in the cooling and air-cooling mode, the low-temperature-side heat medium pressure-fed from the low-temperature-side pump 41 flows into the chiller 20. The low-temperature-side heat medium flowing into the chiller 20 exchanges heat with the low-pressure refrigerant and is cooled. The low-temperature-side heat medium cooled by the chiller 20 flows through the cooling water passage 70a of the battery 70. As a result, the battery 70 is cooled.

As in the single air-cooling mode, the interior air conditioning unit 50 in the cooling and air-cooling mode blows temperature-regulated ventilation air into the vehicle interior to achieve cooling of the vehicle interior.

### (b) Air-Heating Mode

The air-heating mode is an operation mode for heating the vehicle interior by blowing heated ventilation air into the vehicle interior. The air-heating mode is easily selected when the outside air temperature Tam is relatively low or when the target blowout temperature TAO is relatively high in a state where the automatic switch is turned on.

The air-heating mode includes an outside air endothermic air-heating mode, a single-stage hot-gas air-heating mode, and a multi-stage hot-gas air-heating mode. In the air-heating mode, ventilation air as an object to be heated is heated. Therefore, the outside air endothermic air-heating mode, the single-stage hot-gas air-heating mode, and the multi-stage hot-gas air-heating mode are an outside air endothermic heating mode, a single-stage hot-gas heating mode, and a multi-stage hot-gas heating mode, respectively.

(b-1) Outside Air Endothermic Air-Heating Mode

The outside air endothermic air-heating mode is preferentially selected from the single-stage hot-gas heating mode and the multi-stage hot-gas heating mode when heat absorbed from the outside air can be used as an air-heating heat source.

In the heat pump cycle 10 of the outside air endothermic air-heating mode, the control device 60 brings the exterior-device high-stage-side expansion valve 14a into the throttled state, brings the exterior-device low-stage-side expansion valve 14b into the throttled state, brings the high-stage-side expansion valve 14c into the fully closed state, brings the air-cooling expansion valve 14d into the fully closed state, brings the cooling expansion valve 14e into the fully closed state, and brings the bypass-side flow rate regulation valve 14f into the fully closed state.

The control device 60 closes the high-pressure-side on/off valve 22a, opens the air-heating on/off valve 22b, opens the intermediate-pressure-side on/off valve 22c, and opens the low-pressure-side on/off valve 22d.

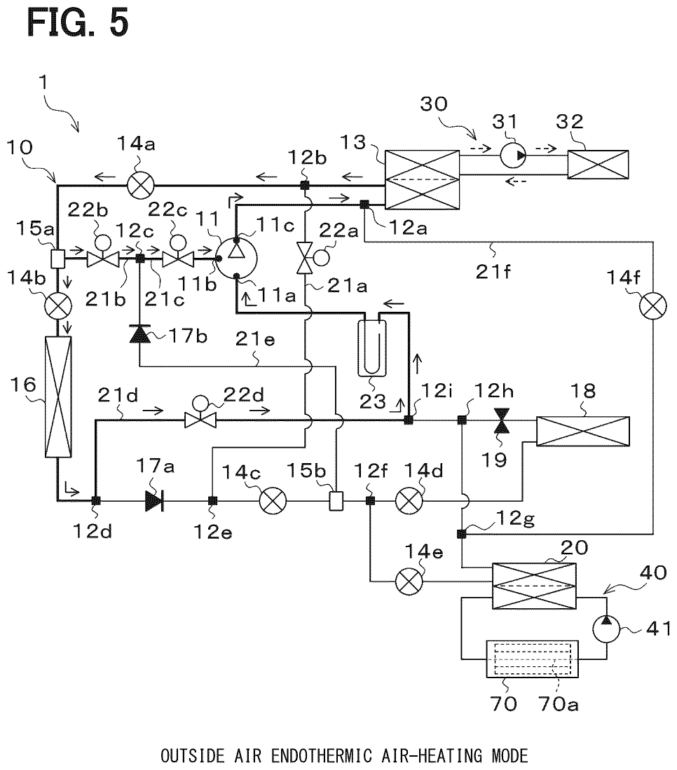

Therefore, in the heat pump cycle 10 in the outside air endothermic air-heating mode, as indicated by the thick solid lines and arrows in FIG. 5, the refrigerant discharged from the discharge port 11c of the compressor 11 flows through the water-refrigerant heat exchanger 13, the exterior-device high-stage-side expansion valve 14a, and the air-heating gas-liquid separator 15a in this order. The gas refrigerant separated by the air-heating gas-liquid separator 15a flows through the air-heating intermediate-pressure passage 21b, the intermediate-pressure passage 21c, and the intermediate-pressure suction port 11b of the compressor 11 in this order. At the same time, the liquid refrigerant separated by the air-heating gas-liquid separator 15a is switched to the refrigerant circuit in which the liquid refrigerant flows through the exterior-device low-stage-side expansion valve 14b, the exterior heat exchanger 16, the low-pressure-side passage 21d, the accumulator 23, and the low-pressure suction port 11a of the compressor 11 in this order.

Furthermore, the control device 60 controls the refrigerant discharge capacity of the compressor 11 such that discharge refrigerant pressure Pd detected by the discharge refrigerant temperature/pressure sensor 62a approaches a target high pressure PDO. The target high pressure PDO is determined based on the target blowout temperature TAO with reference to a control map stored in advance in the control device 60. In the control map, it is determined to increase the target high pressure PDO as the target blowout temperature TAO increases.

The control device 60 also controls the throttle opening of the exterior-device high-stage-side expansion valve 14a such that a degree of subcooling SC1 of the refrigerant flowing out of the water-refrigerant heat exchanger 13 approaches a predetermined reference degree of subcooling KSC1. The degree of subcooling SC1 of the refrigerant flowing out of the water-refrigerant heat exchanger 13 can be determined from the high-pressure-side refrigerant temperature T1 and the high-pressure-side refrigerant pressure P1 detected by the high-pressure-side refrigerant temperature/pressure sensor 62b.

The control device 60 also controls the throttle opening of the exterior-device low-stage-side expansion valve 14b to be a predetermined reference opening for the air-heating mode.

In the high-temperature-side heat medium circuit 30 in the outside air endothermic air-heating mode, the control device 60 operates the high-temperature-side pump 31 as in the single air-cooling mode.

In the interior air conditioning unit 50 in the outside air endothermic air-heating mode, the control device 60 controls the blowing capacity of the interior blower 52 and the opening of the air mix door 54 as in the single air-cooling mode. Furthermore, the control device 60 appropriately controls the operation of other devices to be controlled.

Therefore, in the heat pump cycle 10 in the outside air endothermic air-heating mode, a gas-liquid separation-type gas injection cycle is configured in which the water-refrigerant heat exchanger 13 functions as a condenser and the exterior heat exchanger 16 functions as an evaporator. In the water-refrigerant heat exchanger 13, the high-temperature-side heat medium is heated as in the single air-cooling mode. In the exterior heat exchanger 16, the refrigerant absorbs heat from outside air.

In the high-temperature-side heat medium circuit 30 in the outside air endothermic air-heating mode, the high-temperature-side heat medium heated by the water-refrigerant heat exchanger 13 flows into the heater core 32 as in the single air-cooling mode.

In the interior air conditioning unit 50 in the outside air endothermic air-heating mode, the ventilation air blown from the interior blower 52 passes through the interior evaporator 18. The ventilation air passing through the interior evaporator 18 is heated by the heater core 32 in accordance with the opening of the air mix door 54. The conditioned air having a temperature regulated to approach the target blowout temperature TAO is blown into the vehicle interior. This achieves heating of the vehicle interior.

(b-2) Single-Stage Hot-Gas Air-Heating Mode

The single-stage hot-gas air-heating mode is selected when it is difficult to absorb heat to be an air-heating heat source from outside air as in the case of extremely low outside air temperature, or when the heating capacity of the ventilation air in the heater core 32 is determined as insufficient with respect to the target heating capacity during the execution of the outside air endothermic air-heating mode.

In the present embodiment, the heating capacity is determined as insufficient with respect to the target heating capacity when the rotation speed of the compressor 11 is the maximum rotation speed and the ventilation air temperature TAV is lower than the target blowout temperature TAO during the execution of the outside air endothermic air-heating mode. As the maximum rotation speed of the compressor 11, the maximum rotation speed determined from the durability performance of the compressor 11 can be employed.

In the heat pump cycle 10 in the single-stage hot-gas air-heating mode, the control device 60 brings the exterior-device high-stage-side expansion valve 14a into the fully closed state, brings the exterior-device low-stage-side expansion valve 14b into the fully closed state, brings the high-stage-side expansion valve 14c into the fully open state, brings the air-cooling expansion valve 14d into the fully closed state, brings the cooling expansion valve 14e into the throttled state, and brings the bypass-side flow rate regulation valve 14f into the throttled state.

The control device 60 opens the high-pressure-side on/off valve 22a, closes the air-heating on/off valve 22b, closes the intermediate-pressure-side on/off valve 22c, and closes the low-pressure-side on/off valve 22d.

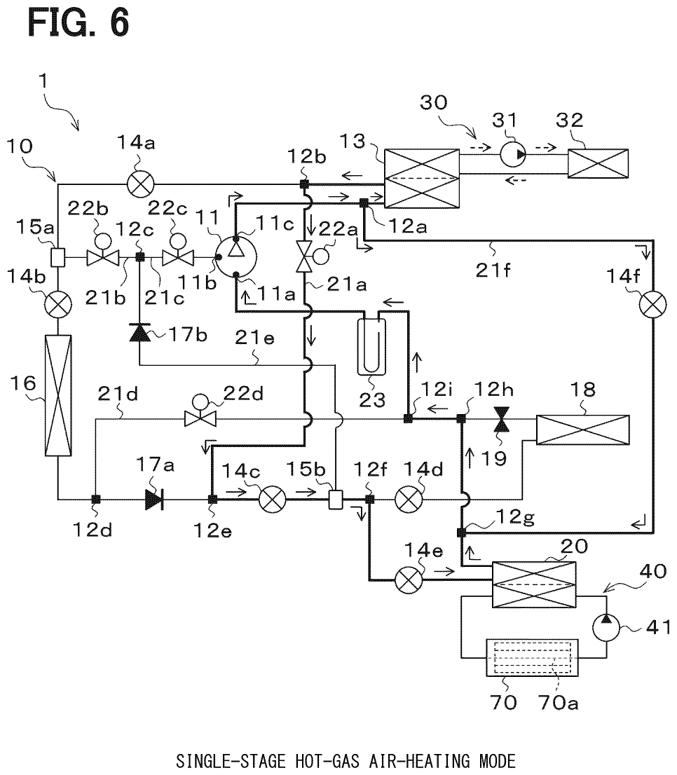

Therefore, in the heat pump cycle 10 in the single-stage hot-gas air-heating mode, as indicated by the thick solid lines and arrows in FIG. 6, the refrigerant discharged from the discharge port 11c of the compressor 11 circulates through the water-refrigerant heat exchanger 13, the high-pressure-side passage 21a, the high-stage-side expansion valve 14c in the fully open state, the hot-gas gas-liquid separator 15b, the cooling expansion valve 14e, the chiller 20, the seventh three-way joint 12g, the accumulator 23, and the low-pressure suction port 11a of the compressor 11 in this order. At the same time, the refrigerant discharged from the compressor 11 is switched to the refrigerant circuit through which the refrigerant circulates in the order of the bypass-side flow rate regulation valve 14f, the seventh three-way joint 12g, and the low-pressure suction port 11a of the compressor 11 arranged in the bypass passage 21f.

Moreover, the control device 60 controls the refrigerant discharge capacity of the compressor 11 such that the chiller-side refrigerant pressure Pc detected by the chiller-side refrigerant temperature/pressure sensor 62e approaches a predetermined target low pressure PSO. The target low pressure PSO is set to a value higher than the refrigerant evaporating pressure in the exterior heat exchanger 16 during the outside air endothermic air-heating mode.

The chiller-side refrigerant pressure Pc during the single-stage hot-gas air-heating mode corresponds to a drawn refrigerant pressure Ps that is the pressure of the low-pressure refrigerant drawn into the compressor 11 from the low-pressure suction port 11a. Controlling the drawn refrigerant pressure Ps to approach a constant value is effective for stabilizing the discharge flow rate (mass flow rate) of the compressor 11.

More specifically, by setting the drawn refrigerant pressure Ps to saturated gas refrigerant of constant pressure, the density of the low-pressure refrigerant drawn into the compressor 11 can be made constant. Therefore, when the drawn refrigerant pressure Ps is controlled to approach the constant pressure, a discharge flow rate Gr of the compressor 11 at the same rotation speed is easily stabilized.

The control device 60 controls the throttle opening of the bypass-side flow rate regulation valve 14f such that a high/low pressure difference ΔP obtained by subtracting the drawn refrigerant pressure Ps from the discharge refrigerant pressure Pd approaches a target high/low pressure difference ΔPO. The target high/low pressure difference ΔPO is a value obtained by subtracting the target low pressure PSO from the target high pressure PDO determined as in the outside air endothermic air-heating mode.

The control device 60 also controls the throttle opening of the cooling expansion valve 14e such that the degree of subcooling SC1 of the refrigerant flowing out of the water-refrigerant heat exchanger 13 approaches a predetermined reference degree of subcooling KSC1. Therefore, the liquid refrigerant flows in the hot-gas gas-liquid separator 15b in the single-stage hot-gas air-heating mode.

In the high-temperature-side heat medium circuit 30 in the single-stage hot-gas air-heating mode, the control device 60 operates the high-temperature-side pump 31 as in the single air-cooling mode.

In the low-temperature-side heat medium circuit 40 in the single-stage hot-gas air-heating mode, the control device 60 stops the low-temperature-side pump 41.

In the interior air conditioning unit 50 in the single-stage hot-gas air-heating mode, the control device 60 controls the blowing capacity of the interior blower 52 and the opening of the air mix door 54 as in the single air-cooling mode. Furthermore, the control device 60 appropriately controls the operation of other devices to be controlled.

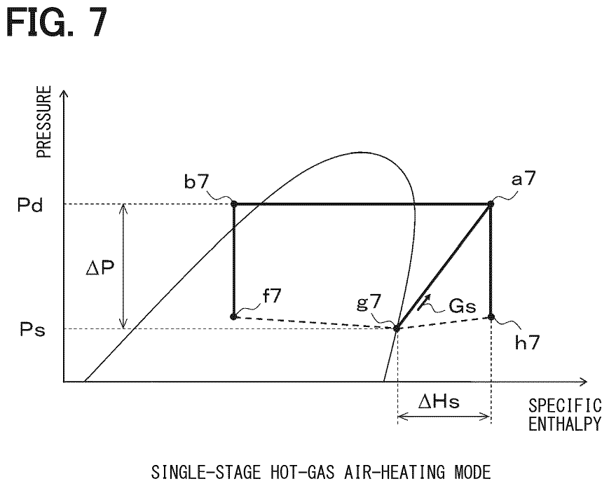

Therefore, in the heat pump cycle 10 in the single-stage hot-gas air-heating mode, the state of the refrigerant changes as illustrated in the Mollier diagram of FIG. 7.

That is, the flow of the high-pressure refrigerant (point a7 in FIG. 7) discharged from the discharge port 11c of the compressor 11 is divided at the first three-way joint 12a. One of the refrigerant divided at first three-way joint 12a flows into the water-refrigerant heat exchanger 13 and radiates heat to the high-temperature-side heat medium (from point a7 to point b7 in FIG. 7). Thereby, the high-temperature-side heat medium is heated.

The refrigerant flowing out of the water-refrigerant heat exchanger 13 flows into the high-pressure-side passage 21a. With the high-stage-side expansion valve 14c being in the fully opened state, the refrigerant that has flowed into the high-pressure-side passage 21a flows into the cooling expansion valve 14e via the hot-gas gas-liquid separator 15b and is decompressed (from point b7 to point f7 in FIG. 7). The low-pressure refrigerant having a relatively low enthalpy and flowing out of the cooling expansion valve 14e flows into the other inflow port of the seventh three-way joint 12g via the chiller 20.

In the single-stage hot-gas air-heating mode, since the air-heating on/off valve 22b and the intermediate-pressure-side on/off valve 22c are closed, the refrigerant does not flow out of the gas refrigerant outlet of the hot-gas gas-liquid separator 15b toward the hot-gas intermediate-pressure passage 21e. In the single-stage hot-gas air-heating mode, since the low-temperature-side pump 41 is stopped, the refrigerant flowing into the chiller 20 does not exchange heat with the low-temperature-side heat medium.

The other of the refrigerant divided at the first three-way joint 12a flows into the bypass passage 21f. The refrigerant flowing into the bypass passage 21f is regulated in flow rate and decompressed by the bypass-side flow rate regulation valve 14f (from point a7 to point h7 in FIG. 7). The low-pressure refrigerant decompressed by the bypass-side flow rate regulation valve 14f and having a relatively high enthalpy flows into one inflow port of the seventh three-way joint 12g.

At the seventh three-way joint 12g, the flow of the low-pressure refrigerant having relatively high enthalpy flowing in from one inflow port of the seventh three-way joint 12g and the flow of the low-pressure refrigerant having relatively low enthalpy flowing in from the other inflow port of the seventh three-way joint 12g merge. The refrigerant merged at the seventh three-way joint 12g flows into the accumulator 23 and is separated into gas and liquid. The gas refrigerant (point g7 in FIG. 7) separated by the accumulator 23 is drawn into the compressor 11 from the low-pressure suction port 11a and compressed. In the single-stage hot-gas air-heating mode, since the intermediate-pressure-side on/off valve 22c is closed, the compressor 11 compresses the refrigerant similarly to the single-stage boost type compressor.

In the high-temperature-side heat medium circuit 30 in the single-stage hot-gas air-heating mode, the high-temperature-side heat medium heated by the water-refrigerant heat exchanger 13 flows into the heater core 32 as in the single air-cooling mode.

As in the outside air endothermic air-heating mode, the interior air conditioning unit 50 in the single-stage hot-gas air-heating mode blows temperature-regulated ventilation air into the vehicle interior to achieve heating of the vehicle interior.

(b-3) Multi-Stage Hot-Gas Air-Heating Mode

The multi-stage hot-gas air-heating mode is selected when the heating capacity of the ventilation air in the heater core 32 is determined as insufficient with respect to the target heating capacity during the execution of the single-stage hot-gas air-heating mode.

In the present embodiment, the heating capacity is determined as insufficient with respect to the target heating capacity when the rotation speed of the compressor 11 is the maximum rotation speed and the ventilation air temperature TAV is lower than the target blowout temperature TAO during the execution of the single-stage hot-gas air-heating mode.

In the heat pump cycle 10 in the multi-stage hot-gas air-heating mode, the control device 60 brings the exterior-device high-stage-side expansion valve 14a into the fully closed state, brings the exterior-device low-stage-side expansion valve 14b into the fully closed state, brings the exterior-device high-stage-side expansion valve 14c into the throttled state, brings the air-cooling expansion valve 14d into the fully closed state, brings the cooling expansion valve 14e into the throttled state, and brings the bypass-side flow rate regulation valve 14f into the throttled state.

The control device 60 opens the high-pressure-side on/off valve 22a, closes the air-heating on/off valve 22b, opens the intermediate-pressure-side on/off valve 22c, and closes the low-pressure-side on/off valve 22d.

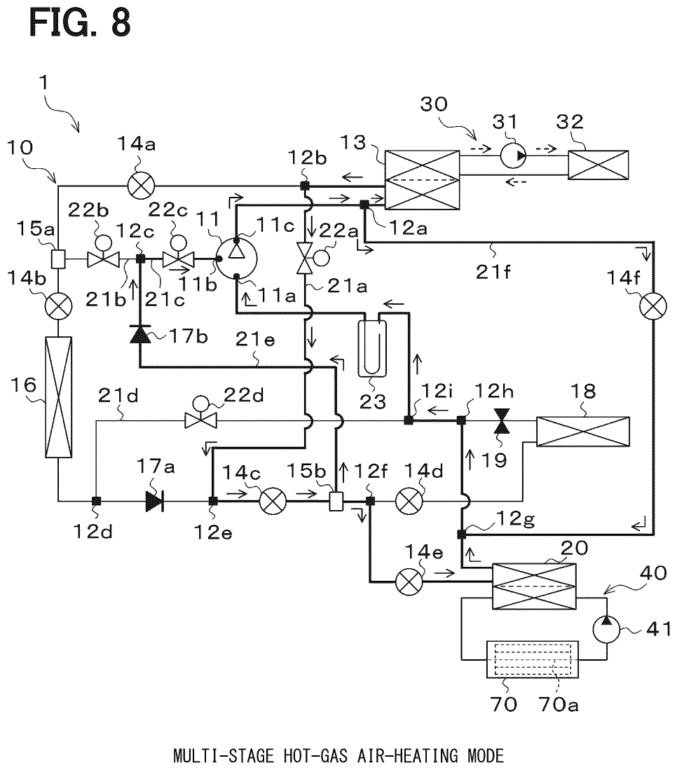

Therefore, in the heat pump cycle 10 in the multi-stage hot-gas air-heating mode, as indicated by the thick solid lines and arrows in FIG. 8, the refrigerant discharged from the discharge port 11c of the compressor 11 flows through the water-refrigerant heat exchanger 13, the high-pressure-side passage 21a, the high-stage-side expansion valve 14c, and the hot-gas gas-liquid separator 15b in this order. The gas refrigerant separated by the hot-gas gas-liquid separator 15b flows through the hot-gas intermediate-pressure passage 21e, the intermediate-pressure passage 21c, and the intermediate-pressure suction port 11b of the compressor 11 in this order. Moreover, the liquid refrigerant separated by the hot-gas gas-liquid separator 15b flows through the cooling expansion valve 14e, the chiller 20, the seventh three-way joint 12g, the accumulator 23, and the low-pressure suction port 11a of the compressor 11 in this order. At the same time, the refrigerant discharged from the compressor 11 is switched to the refrigerant circuit through which the refrigerant circulates in the order of the bypass-side flow rate regulation valve 14f, the seventh three-way joint 12g, and the low-pressure suction port 11a of the compressor 11 arranged in the bypass passage 21f.

Furthermore, the control device 60 controls the throttle opening of the high-stage-side expansion valve 14c. Specifically, when the ventilation air temperature TAV can be made equal to the target blowout temperature TAO by adjusting the opening of the air mix door 54, the throttle opening of the high-stage-side expansion valve 14c is controlled such that the degree of subcooling SC1 of the refrigerant flowing out of the water-refrigerant heat exchanger 13 approaches a predetermined reference degree of subcooling KSC1.

On the other hand, even if the air mix door 54 is displaced to a position where the air passage on the heater core 32 side is fully opened and the cold air bypass passage 55 is fully closed, when the ventilation air temperature TAV is lower than the target blowout temperature TAO, the throttle opening of the high-stage-side expansion valve 14c is increased from the current value.

The control device 60 also controls the throttle opening of the cooling expansion valve 14e to be a predetermined reference opening for the multi-stage hot-gas air-heating mode.

As in the single-stage hot-gas air-heating mode, the control device 60 controls the refrigerant discharge capacity of the compressor 11 and the throttle opening of the bypass-side flow rate regulation valve 14f.

In the high-temperature-side heat medium circuit 30 in the multi-stage hot-gas air-heating mode, the control device 60 operates the high-temperature-side pump 31 as in the single air-cooling mode.

In the low-temperature-side heat medium circuit 40 in the multi-stage hot-gas air-heating mode, the control device 60 stops the low-temperature-side pump 41.

In the interior air conditioning unit 50 in the multi-stage hot-gas air-heating mode, the control device 60 controls the blowing capacity of the interior blower 52, the opening of the air mix door 54, and the like as in the single air-cooling mode. Furthermore, the control device 60 appropriately controls the operation of other devices to be controlled.

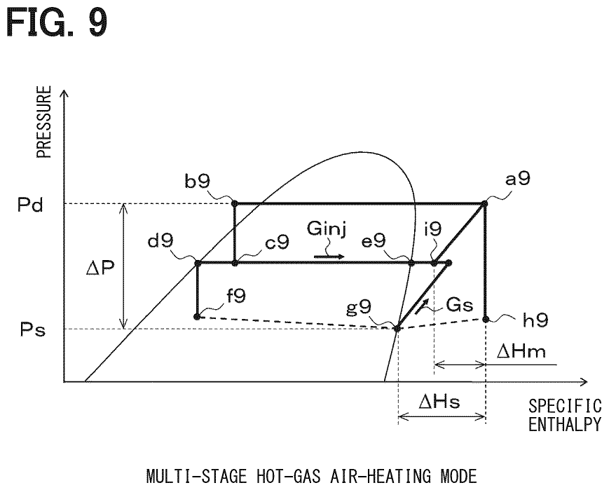

Therefore, in the heat pump cycle 10 in the multi-stage hot-gas air-heating mode, the state of the refrigerant changes as illustrated in the Mollier diagram of FIG. 9. In FIG. 9, the state of the refrigerant at the equivalent points in the cycle configuration to the Moriel diagram in FIG. 7, which describes the single-stage hot-gas air-heating mode, is illustrated with the same signs (alphabets) as in FIG. 7, and only the subscripts (numbers) are changed to match the figure number. This also applies to the Mollier diagram in the following embodiment.

That is, the flow of the high-pressure refrigerant (point a9 in FIG. 9) discharged from the discharge port 11c of the compressor 11 is divided at the first three-way joint 12a. One of the refrigerant divided at first three-way joint 12a flows into the water-refrigerant heat exchanger 13 and radiates heat to the high-temperature-side heat medium (from point a9 to point b9 in FIG. 9). Thereby, the high-temperature-side heat medium is heated.

The refrigerant flowing out of the water-refrigerant heat exchanger 13 flows into the high-pressure-side passage 21a. The refrigerant flowing into the high-pressure-side passage 21a flows into the high-stage-side expansion valve 14c and is decompressed (from point b9 to point c9 in FIG. 9). The intermediate-pressure refrigerant flowing out of the high-stage-side expansion valve 14c flows into the hot-gas gas-liquid separator 15b and is separated into gas and liquid (from point c9 to point e9 and from point c9 to point d9 in FIG. 9).

The gas refrigerant flowing out of the gas refrigerant outlet of the hot-gas gas-liquid separator 15b (point e9 in FIG. 9) is drawn into the compressor 11 from the intermediate-pressure suction port 11b via the hot-gas intermediate-pressure passage 21e and the intermediate-pressure passage 21c. The intermediate-pressure refrigerant drawn from the intermediate-pressure suction port 11b merges with the refrigerant in the process of compression from low pressure to high pressure in the compressor 11 (point i9 in FIG. 9).

The liquid refrigerant flowing out of the liquid refrigerant outlet of the hot-gas gas-liquid separator 15b (point d9 in FIG. 9) flows into the cooling expansion valve 14e and is decompressed (from point d9 to point f9 in FIG. 9). The low-pressure refrigerant having a relatively low enthalpy and flowing out of the cooling expansion valve 14e flows into the other inflow port of the seventh three-way joint 12g via the chiller 20.

In the multi-stage hot-gas air-heating mode, since the low-temperature-side pump 41 is stopped, the refrigerant flowing into the chiller 20 does not exchange heat with the low-temperature-side heat medium.

As in the single-stage hot-gas air-heating mode, the other of the refrigerant divided at the first three-way joint 12a flows into the bypass passage 21f, and the other of the refrigerant is regulated in flow rate and decompressed by the bypass-side flow rate regulation valve 14f (from point a9 to point h9 in FIG. 9). The low-pressure refrigerant decompressed by the bypass-side flow rate regulation valve 14f and having a relatively high enthalpy flows into one inflow port of the seventh three-way joint 12g.

The refrigerant merged at the seventh three-way joint 12g flows into the accumulator 23 and is separated into gas and liquid. The gas refrigerant (point g9 in FIG. 9) separated by the accumulator 23 is drawn into the compressor 11 from the low-pressure suction port 11a and compressed.

In the high-temperature-side heat medium circuit 30 in the multi-stage hot-gas air-heating mode, the high-temperature-side heat medium heated by the water-refrigerant heat exchanger 13 flows into the heater core 32 as in the single air-cooling mode.

As in the outside air endothermic air-heating mode, the interior air conditioning unit 50 in the multi-stage hot-gas air-heating mode blows the temperature-regulated ventilation air into the vehicle interior to achieve heating of the vehicle interior.

Furthermore, in the vehicular air conditioner 1 of the present embodiment, the multi-stage endothermic hot-gas air-heating mode can be executed as the operation mode to improve the heating capacity of the ventilation air compared to the multi-stage hot-gas air-heating mode. The multi-stage endothermic hot-gas air-heating mode is a multi-stage endothermic hot-gas heating mode for heating ventilation air as an object to be heated.

The multi-stage endothermic hot-gas air-heating mode includes: (b-3-1) a multi-stage inside air endothermic hot-gas air-heating mode, and (b-3-2) a multi-stage device endothermic hot-gas air-heating mode.

(b-3-1) Multi-Stage Inside Air Endothermic Hot-Gas Air-Heating Mode

The multi-stage inside air endothermic hot-gas air-heating mode is selected when the multi-stage hot-gas air-heating mode is selected and when the inside air temperature Tr is equal to or higher than a predetermined reference hot-gas inside air temperature KHTr. The reference hot-gas inside air temperature KHTr is set to a temperature at which the refrigerant flowing through the interior evaporator 18 can absorb heat from the inside air flowing out of the vehicle interior even at an extremely low outside air temperature.

In the heat pump cycle 10 in the multi-stage inside air endothermic hot-gas air-heating mode, the control device 60 brings the exterior-device high-stage-side expansion valve 14a into the fully closed state, brings the exterior-device low-stage-side expansion valve 14b into the fully closed state, brings the exterior-device high-stage-side expansion valve 14c into the throttled state, brings the air-cooling expansion valve 14d into the throttled state, brings the cooling expansion valve 14e into the fully closed state, and brings the bypass-side flow rate regulation valve 14f into the throttled state.

The control device 60 opens the high-pressure-side on/off valve 22a, closes the air-heating on/off valve 22b, opens the intermediate-pressure-side on/off valve 22c, and closes the low-pressure-side on/off valve 22d.

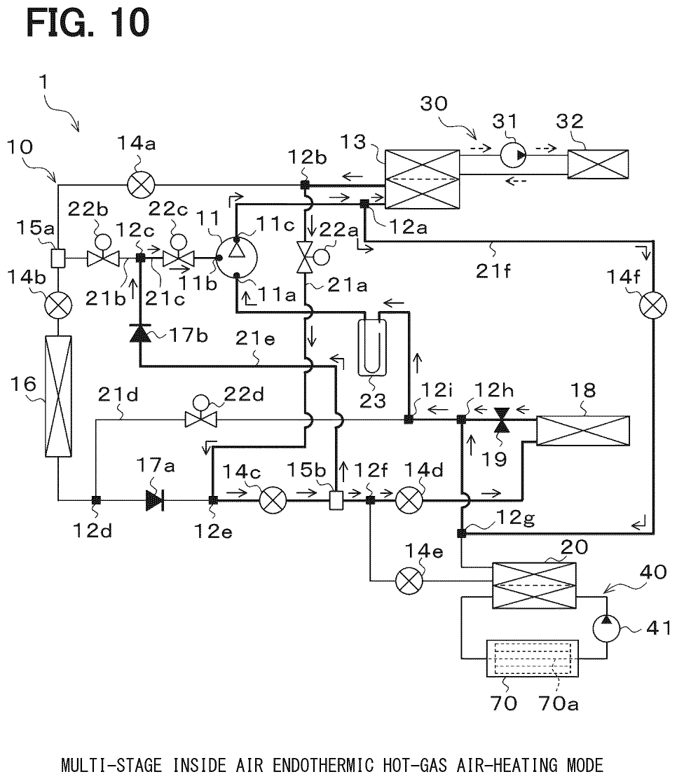

Therefore, in the heat pump cycle 10 in the multi-stage inside air endothermic hot-gas air-heating mode, as indicated by the thick solid lines and arrows in FIG. 10, the refrigerant discharged from the discharge port 11c of the compressor 11 flows through the water-refrigerant heat exchanger 13, the high-pressure-side passage 21a, the high-stage-side expansion valve 14c, and the hot-gas gas-liquid separator 15b in this order. The gas refrigerant separated by the hot-gas gas-liquid separator 15b flows through the hot-gas intermediate-pressure passage 21e, the intermediate-pressure passage 21c, and the intermediate-pressure suction port 11b of the compressor 11 in this order. Moreover, the liquid refrigerant separated by the hot-gas gas-liquid separator 15b flows through the air-cooling expansion valve 14d, the interior evaporator 18, the evaporating pressure regulation valve 19, the accumulator 23, and the low-pressure suction port 11a of the compressor 11 in this order. At the same time, the refrigerant discharged from the compressor 11 is switched to the refrigerant circuit through which the refrigerant circulates in the order of the bypass-side flow rate regulation valve 14f, the seventh three-way joint 12g, and the low-pressure suction port 11a of the compressor 11 arranged in the bypass passage 21f.

As in the multi-stage hot-gas air-heating mode, the control device 60 controls the operations of various components of the heat pump cycle 10.

In the high-temperature-side heat medium circuit 30 in the multi-stage inside air endothermic hot-gas air-heating mode, as in the multi-stage hot-gas air-heating mode, the control device 60 controls the operations of various components of the high-temperature-side heat medium circuit 30.

In the low-temperature-side heat medium circuit 40 in the multi-stage inside air endothermic hot-gas air-heating mode, as in the multi-stage hot-gas air-heating mode, the control device 60 stops the low-temperature-side pump 41.

In the interior air conditioning unit 50 in the multi-stage inside air endothermic hot-gas air-heating mode, the control device 60 controls the operation of the inside/outside air switching device 53 so that inside air is introduced as ventilation air. As in the multi-stage hot-gas air-heating mode, the control device 60 controls the operations of various other components of the interior air conditioning unit 50. Furthermore, the control device 60 appropriately controls the operation of other devices to be controlled.

Therefore, in the heat pump cycle 10 in the multi-stage inside air endothermic hot-gas air-heating mode, the refrigerant radiates heat to the high-temperature-side heat medium in the water-refrigerant heat exchanger 13 as in the multi-stage hot-gas air-heating mode. Thereby, the high-temperature-side heat medium is heated. As in the single air-cooling mode, the refrigerant absorbs heat from the inside air in the interior evaporator 18.

In the high-temperature-side heat medium circuit 30 in the multi-stage inside air endothermic hot-gas air-heating mode, the high-temperature-side heat medium heated by the water-refrigerant heat exchanger 13 flows into the heater core 32 as in the single air-cooling mode.

As in the multi-stage hot-gas air-heating mode, the interior air conditioning unit 50 in the multi-stage inside air endothermic hot-gas air-heating mode blows temperature-regulated ventilation air into the vehicle interior to achieve heating of the vehicle interior.

Moreover, in the multi-stage inside air endothermic hot-gas air-heating mode, the heat of the inside air flowing out of the vehicle interior can be absorbed by the refrigerant in the interior evaporator 18 and used as a heat source for heating the ventilation air in the heater core 32. Therefore, in the multi-stage inside air endothermic hot-gas air-heating mode, the heating capacity of the ventilation air can be improved compared to the multi-stage hot-gas air-heating mode.

(b-3-2) Multi-Stage Device Endothermic Hot-Gas Air-Heating Mode

The multi-stage device endothermic hot-gas air-heating mode is selected when the multi-stage hot-gas air-heating mode is selected and when the low-temperature-side heat medium temperature TWL detected by the low-temperature-side heat medium temperature sensor 63b is equal to or higher than a predetermined reference hot-gas heat medium temperature KHTWL. The reference hot-gas heat medium temperature KHTWL is set to a temperature at which the refrigerant flowing through the chiller 20 can absorb heat from the low-temperature-side heat medium even at an extremely low outside air temperature.

In the heat pump cycle 10 in the multi-stage device endothermic hot-gas air-heating mode, the control device 60 brings the exterior-device high-stage-side expansion valve 14a into the fully closed state, brings the exterior-device low-stage-side expansion valve 14b into the fully closed state, brings the high-stage-side expansion valve 14c into the throttled state, brings the air-cooling expansion valve 14d into the fully closed state, brings the cooling expansion valve 14e into the throttled state, and brings the bypass-side flow rate regulation valve 14f into the throttled state.

The control device 60 opens the high-pressure-side on/off valve 22a, closes the air-heating on/off valve 22b, opens the intermediate-pressure-side on/off valve 22c, and closes the low-pressure-side on/off valve 22d.

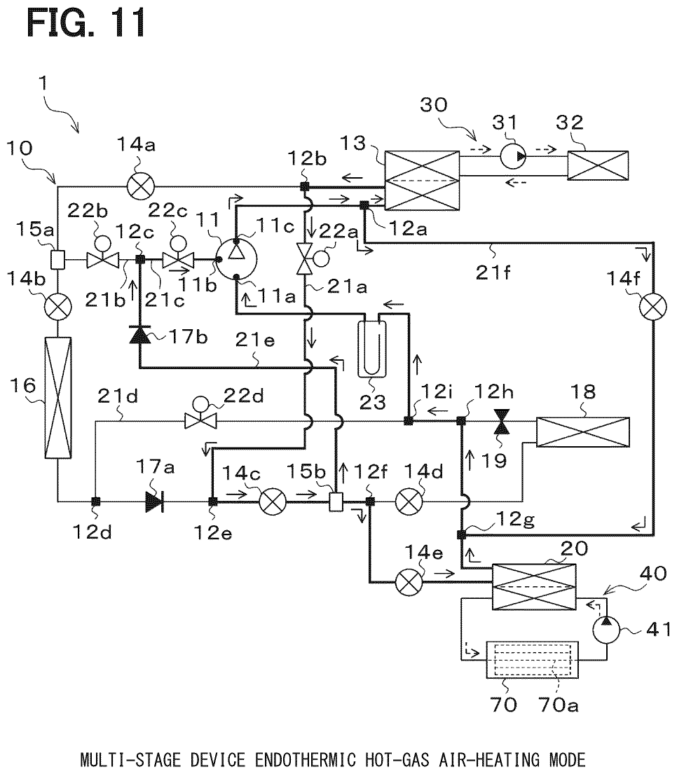

Therefore, in the heat pump cycle 10 in the multi-stage device endothermic hot-gas air-heating mode, as indicated by the thick solid lines and arrows in FIG. 11, the refrigerant circuit is switched to the refrigerant circuit through which the refrigerant flows in the same order as in the multi-stage hot-gas air-heating mode.

As in the multi-stage hot-gas air-heating mode, the control device 60 controls the operations of various components of the heat pump cycle 10.

In the high-temperature-side heat medium circuit 30 in the multi-stage device endothermic hot-gas air-heating mode, as in the multi-stage hot-gas air-heating mode, the control device 60 controls the operations of various components of the high-temperature-side heat medium circuit 30.

In the low-temperature-side heat medium circuit 40 in the multi-stage device endothermic hot-gas air-heating mode, as in the cooling and air-cooling mode, the control device 60 operates the low-temperature-side pump 41.

In the interior air conditioning unit 50 in the multi-stage device endothermic hot-gas air-heating mode, the control device 60 controls the operations of various components of the interior air conditioning unit 50 as in the multi-stage hot-gas air-heating mode. Furthermore, the control device 60 appropriately controls the operation of other devices to be controlled.

Accordingly, in the heat pump cycle 10 in the multi-stage device endothermic hot-gas air-heating mode, the refrigerant radiates heat to the high-temperature-side heat medium in the water-refrigerant heat exchanger 13 as in the multi-stage hot-gas air-heating mode. Thereby, the high-temperature-side heat medium is heated. As in the cooling and air-cooling mode, in the chiller 20, the refrigerant absorbs heat from the low-temperature-side heat medium.

In the high-temperature-side heat medium circuit 30 in the multi-stage device endothermic hot-gas air-heating mode, the high-temperature-side heat medium heated by the water-refrigerant heat exchanger 13 flows into the heater core 32 as in the single air-cooling mode.

In the low-temperature-side heat medium circuit 40 in the multi-stage device endothermic hot-gas air-heating mode, as in the cooling and air-cooling mode, the low-temperature-side heat medium cooled by the chiller 20 flows through the cooling water passage 70a of the battery 70.

As in the multi-stage hot-gas air-heating mode, the interior air conditioning unit 50 in the multi-stage device endothermic hot-gas air-heating mode blows the temperature-regulated ventilation air into the vehicle interior to achieve heating of the vehicle interior.

Moreover, in the multi-stage device endothermic hot-gas air-heating mode, the waste heat of the battery 70 can be absorbed by the refrigerant through the low-temperature-side heat medium in the chiller 20 and used as a heat source for heating the ventilation air in the heater core 32. Therefore, in the multi-stage device endothermic hot-gas air-heating mode, the heating capacity of the ventilation air can be improved compared to the multi-stage hot-gas air-heating mode.

(b-3-3) Multi-Stage Outside Air Endothermic Hot-Gas Air-Heating Mode

The multi-stage outside air endothermic hot-gas air-heating mode is selected when the multi-stage hot-gas air-heating mode is selected and when the outside air temperature Tam is equal to or higher than a predetermined reference hot-gas outside air temperature KHTam. The reference hot-gas outside air temperature KHTam is set to a temperature at which the refrigerant flowing through the exterior heat exchanger 16 can absorb heat from the outside air even at an extremely low outside air temperature.

In the heat pump cycle 10 in the multi-stage outside air endothermic hot-gas air-heating mode, the control device 60 brings the exterior-device high-stage-side expansion valve 14a into the fully open state, brings the exterior-device low-stage-side expansion valve 14b into the throttled state, brings the high-stage-side expansion valve 14c into the throttled state, brings the air-cooling expansion valve 14d into the fully closed state, brings the cooling expansion valve 14e into the throttled state, and brings the bypass-side flow rate regulation valve 14f into the throttled state.

The control device 60 opens the high-pressure-side on/off valve 22a, closes the air-heating on/off valve 22b, opens the intermediate-pressure-side on/off valve 22c, and closes the low-pressure-side on/off valve 22d.

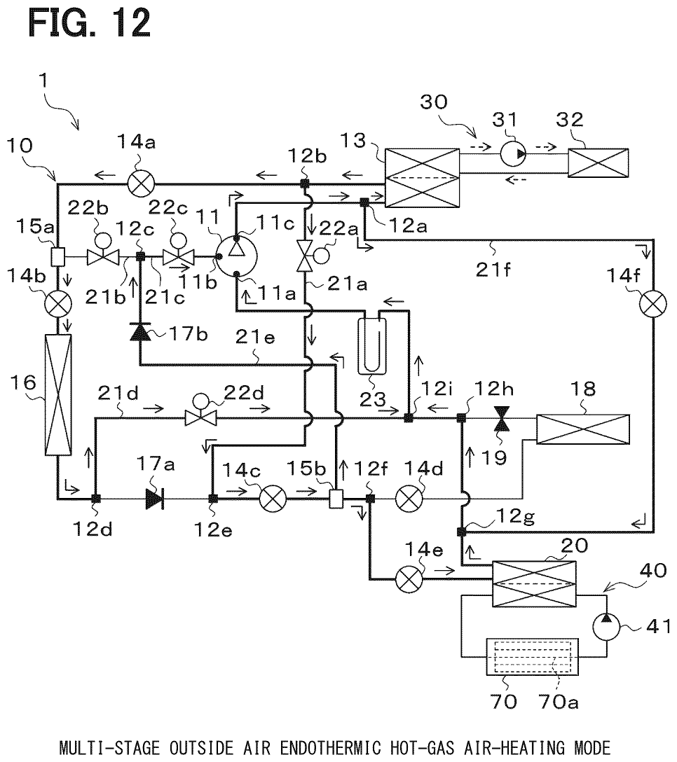

Therefore, in the heat pump cycle 10 in the multi-stage outside air endothermic hot-gas air-heating mode, as indicated by the thick solid lines and arrows in FIG. 12, the refrigerant discharged from the discharge port 11c of the compressor 11 flows as in the multi-stage hot-gas air-heating mode. At the same time, the refrigerant flowing out of the one outflow port of the second three-way joint 12b is switched to the refrigerant circuit in which the refrigerant flows through the exterior-device high-stage-side expansion valve 14a, which is fully opened, the air-heating gas-liquid separator 15a, the exterior-device low-stage-side expansion valve 14b, the exterior heat exchanger 16, the low-pressure-side passage 21d, the accumulator 23, and the low-pressure suction port 11a of the compressor 11 in this order.

The control device 60 also controls the throttle opening of the exterior-device low-stage-side expansion valve 14b so that the exterior-device-side refrigerant temperature T2 becomes lower than the outside air temperature Tam. As in the multi-stage hot-gas air-heating mode, the control device 60 controls the operations of various components of the other heat pump cycle 10.

In the high-temperature-side heat medium circuit 30 in the multi-stage outside air endothermic hot-gas air-heating mode, as in the multi-stage hot-gas air-heating mode, the control device 60 controls the operations of various components of the high-temperature-side heat medium circuit 30.

In the low-temperature-side heat medium circuit 40 in the multi-stage outside air endothermic hot-gas air-heating mode, the control device 60 stops the low-temperature-side pump 41 as in the multi-stage hot-gas air-heating mode.

In the interior air conditioning unit 50 in the multi-stage outside air endothermic hot-gas air-heating mode, the control device 60 controls the operations of various components of the interior air conditioning unit 50 as in the multi-stage hot-gas air-heating mode. Furthermore, the control device 60 appropriately controls the operation of other devices to be controlled.

Accordingly, in the heat pump cycle 10 in the multi-stage outside air endothermic hot-gas air-heating mode, the refrigerant radiates heat to the high-temperature-side heat medium in the water-refrigerant heat exchanger 13 as in the multi-stage hot-gas air-heating mode. Thereby, the high-temperature-side heat medium is heated. As in the outside air endothermic air-heating mode, the refrigerant absorbs heat from the outside air at the interior evaporator 18.

In the high-temperature-side heat medium circuit 30 in the multi-stage outside air endothermic hot-gas air-heating mode, the high-temperature-side heat medium heated by the water-refrigerant heat exchanger 13 flows into the heater core 32 as in the single air-cooling mode.

As in the multi-stage hot-gas air-heating mode, the interior air conditioning unit 50 in the multi-stage outside air endothermic hot-gas air-heating mode blows temperature-regulated ventilation air into the vehicle interior to achieve heating of the vehicle interior.

Moreover, in the multi-stage outside air endothermic hot-gas air-heating mode, the heat of the outside air can be absorbed by the refrigerant in the exterior heat exchanger 16 and used as a heat source for heating the ventilation air in the heater core 32. Therefore, in the multi-stage outside air endothermic hot-gas air-heating mode, the heating capacity of the ventilation air can be improved compared to the multi-stage hot-gas air-heating mode.

As described above, the vehicular air conditioner 1 of the present embodiment can perform comfortable air conditioning in the vehicle interior and appropriate temperature regulation of the battery 70, which is an in-vehicle device, by switching the operation mode.

More specifically, the heat pump cycle 10 of the present embodiment includes the exterior-device high-stage-side expansion valve 14a, the air-heating gas-liquid separator 15a, the exterior-device low-stage-side expansion valve 14b, and the exterior heat exchanger 16. Therefore, in the vehicular air conditioner 1 of the present embodiment, the refrigerant circuit switching portion switches the refrigerant circuit of the heat pump cycle 10, so that the outside air endothermic air-heating mode can be executed.

In the outside air endothermic air-heating mode, heat absorbed from the outside air can be used as an air-heating heat source in the exterior heat exchanger 16. Therefore, the coefficient of performance (COP) of the cycle can be improved to achieve efficient heating.

The heat pump cycle 10 of the present embodiment includes the intermediate-pressure-side on/off valve 22c. Therefore, the vehicular air conditioner 1 of the present embodiment can execute the single-stage hot-gas air-heating mode by closing the intermediate-pressure-side on/off valve 22c.

In the single-stage hot-gas air-heating mode, the flow of the refrigerant having relatively high enthalpy flowing out of the bypass-side flow rate regulation valve 14f and the flow of the refrigerant having relatively low enthalpy flowing out of the cooling expansion valve 14e are merged at the seventh three-way joint 12g. Accordingly, even when the refrigerant discharge capacity of the compressor 11 is increased, the low-pressure refrigerant to be drawn into the low-pressure suction port 11a can be reliably maintained as the saturated gas refrigerant, and the cycle can be operated suitably.

In other words, in the single-stage hot-gas air-heating mode, the ventilation air can be stably heated by the heating portion using the heat generated by the compression work of the compressor 11 without using the heat absorbed from the outside air.

Furthermore, in the single-stage hot-gas air-heating mode, since the drawn refrigerant pressure Ps is increased more than in the outside air endothermic air-heating mode, the density of the low-pressure refrigerant drawn into the low-pressure suction port 11a of the compressor 11 can be increased, and the discharge refrigerant flow rate (mass flow rate) of the compressor 11 can be increased. As a result, in the single-stage hot-gas air-heating mode, the amount of compression work of the compressor 11 can be increased to improve the heating capacity of the ventilation air in the heating portion compared to the outside air endothermic air-heating mode.

In the heat pump cycle 10 of the present embodiment, low-pressure-side components, such as the interior evaporator 18 and the chiller 20, are connected to the low-pressure suction port 11a of the compressor 11. For this reason, in the heat pump cycle 10, the drawn refrigerant pressure Ps cannot be increased above the upper-limit pressure that is determined based on the pressure resistance performance or the like of the low-pressure-side components.

That is, in the single-stage hot-gas air-heating mode, there is a limit to improvement in the heating capacity of the heating portion even when the drawn refrigerant pressure Ps is increased to improve the heating capacity of the heating portion. Therefore, to improve the heating capacity of the heating portion, it is conceivable to employ a low-pressure-side component device having high pressure resistance performance. However, employing a low-pressure-side component device having high pressure resistance performance leads to deterioration in productivity such as increased size and weight of the vehicular air conditioner 1.

On the other hand, in the vehicular air conditioner 1 of the present embodiment, the multi-stage hot-gas air-heating mode can be executed by opening the intermediate-pressure-side on/off valve 22c.

In the multi-stage hot-gas air-heating mode, the cycle can be operated suitably as in the single-stage hot-gas air-heating mode. Therefore, in the multi-stage hot-gas air-heating mode, as in the single-stage hot-gas air-heating mode, the ventilation air can be stably heated by the heating portion using the heat generated by the compression work of the compressor 11 without using the heat absorbed from the outside air.

Furthermore, in the multi-stage hot-gas air-heating mode, the gas refrigerant separated by the hot-gas gas-liquid separator 15b is drawn into the intermediate-pressure suction port 11b of the compressor 11, so that the amount of compression work of the compressor 11 can be increased compared to the single-stage hot-gas air-heating mode. Therefore, sufficiently high heating capacity can be exerted in the heating portion without increasing the pressure of the low-pressure refrigerant.

More specifically, an amount of compression work L1 of the compressor 11 in the single-stage hot-gas air-heating mode is defined by the following Formula F2.

L1=Gs×ΔHs (F2)

As illustrated in FIG. 7, Gs is a suction flow rate (mass flow rate) of the low-pressure refrigerant drawn into the compressor 11 from the low-pressure suction port 11a. ΔHs is an increase in the enthalpy of the low-pressure refrigerant due to the compression work of the compressor 11.

An amount of compression work L2 of the compressor 11 in the multi-stage hot-gas air-heating mode is defined by the following Formula F3.

L2=Gs×ΔHs+Ginj×ΔHm (F3)

As illustrated in FIG. 9, Ginj represents a suction flow rate (mass flow rate) of the intermediate-pressure refrigerant drawn into the compressor 11 from the intermediate-pressure suction port 11b. ΔHm is an increase in the enthalpy of the intermediate-pressure refrigerant due to the compression work of the compressor 11.

In the single-stage hot-gas air-heating mode and the multi-stage hot-gas air-heating mode, the drawn refrigerant pressure Ps is controlled to approach the target low pressure PSO. Therefore, the suction flow rate Gs of the low-pressure refrigerant in the single-stage hot-gas air-heating mode is equivalent to the suction flow rate Gs of the low-pressure refrigerant in the multi-stage hot-gas air-heating mode.

Moreover, in the single-stage hot-gas air-heating mode and the multi-stage hot-gas air-heating mode, the high/low pressure difference ΔP is controlled to approach the target high/low pressure difference ΔPO. For this reason, the enthalpy increase ΔHs of the low-pressure refrigerant in the multi-stage hot-gas air-heating mode illustrated in FIG. 9 is slightly lower than that in the single-stage hot-gas air-heating mode, but is roughly equivalent to the enthalpy increase ΔHs of the low-pressure refrigerant in the single-stage hot-gas air-heating mode illustrated in FIG. 7.

The reason why the enthalpy increase ΔHs in the multi-stage hot-gas air-heating mode is slightly lower than the enthalpy increase ΔHs in the single-stage hot-gas air-heating mode is that intermediate-pressure refrigerant having low enthalpy is mixed with the refrigerant in the compression process in the multi-stage hot-gas air-heating mode.

Therefore, in the amount of compression work in the multi-stage hot-gas air-heating mode, the amount of work corresponding to the multiplication value of the suction flow rate Ginj of the intermediate-pressure refrigerant and the enthalpy increase ΔHm of the intermediate-pressure refrigerant is larger than the amount of compression work in the single-stage hot-gas air-heating mode. As a result, in the multi-stage hot-gas air-heating mode, the heating capacity of the heating portion can be improved compared to the single-stage hot-gas air-heating mode.

In the vehicular air conditioner 1 of the present embodiment, the intermediate-pressure-side on/off valve 22c is opened while the single-stage hot-gas air-heating mode is being executed and the ventilation air temperature TAV is lower than the target blowout temperature TAO. That is, when the ventilation air temperature TAV is lower than the target blowout temperature TAO, the mode is switched from the single-stage hot-gas air-heating mode to the multi-stage hot-gas air-heating mode. Therefore, the heating capacity of the ventilation air can be prevented from becoming insufficient.

The vehicular air conditioner 1 of the present embodiment increases the throttle opening of the high-stage-side expansion valve 14c when the ventilation air temperature TAV is lower than the target blowout temperature TAO during the execution of the multi-stage hot-gas air-heating mode. This enables the pressure of the intermediate-pressure refrigerant to increase, thereby increasing the suction flow rate Ginj. Therefore, the heating capacity of the ventilation air can be prevented from becoming insufficient.

The heat pump cycle 10 of the present embodiment includes the exterior heat exchanger 16, the air-cooling expansion valve 14d, and the interior evaporator 18. Therefore, in the vehicular air conditioner 1 of the present embodiment, the refrigerant circuit switching portion switches the refrigerant circuit of the heat pump cycle 10, so that the air-cooling mode for cooling the ventilation air as an object to be cooled can be executed.

The heat pump cycle 10 of the present embodiment includes the exterior heat exchanger 16, the cooling expansion valve 14e, and the chiller 20. Therefore, in the vehicular air conditioner 1 of the present embodiment, the refrigerant circuit switching portion switches the refrigerant circuit of the heat pump cycle 10, so that the cooling and air-cooling mode for cooling the battery 70 as an object to be cooled can be executed.

The heat pump cycle 10 of the present embodiment includes the air-cooling expansion valve 14d and the interior evaporator 18. Therefore, in the vehicular air conditioner 1 of the present embodiment, the refrigerant circuit switching portion switches the refrigerant circuit of the heat pump cycle 10, so that the multi-stage inside air endothermic hot-gas air-heating mode can be executed.

The heat pump cycle 10 of the present embodiment includes the cooling expansion valve 14e and the chiller 20. Therefore, in the vehicular air conditioner 1 of the present embodiment, the refrigerant circuit switching portion switches the refrigerant circuit of the heat pump cycle 10, so that the multi-stage device endothermic hot-gas air-heating mode can be executed.

The heat pump cycle 10 of the present embodiment includes the exterior-device low-stage-side expansion valve 14b and the exterior heat exchanger 16. Therefore, in the vehicular air conditioner 1 of the present embodiment, the refrigerant circuit switching portion switches the refrigerant circuit of the heat pump cycle 10, so that the multi-stage outside air endothermic hot-gas air-heating mode can be executed.

### Second Embodiment

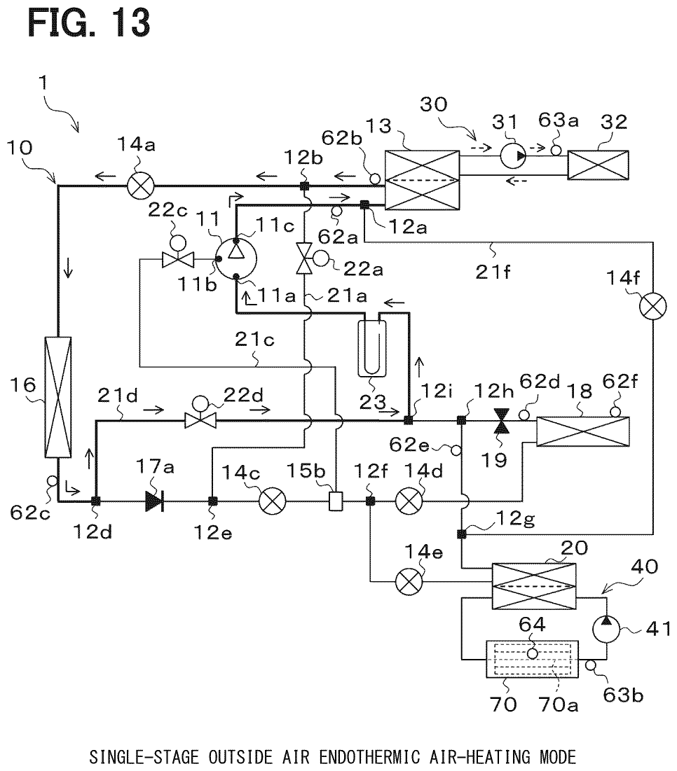

For the vehicular air conditioner 1 of the present embodiment, as illustrated in the overall configuration diagram of FIG. 13, an example in which the configuration of the heat pump cycle 10 is simplified compared to the first embodiment will be described. In FIG. 13, a flow of refrigerant in a single-stage outside air endothermic air-heating mode to be described later is indicated by thick solid lines and arrows.

Specifically, in the heat pump cycle 10 of the present embodiment, the air-heating gas-liquid separator 15a, the exterior-device low-stage-side expansion valve 14b, the air-heating intermediate-pressure passage 21b, the air-heating on/off valve 22b, the third three-way joint 12c, the hot-gas intermediate-pressure passage 21e, and the second check valve 17b are eliminated from the first embodiment. Therefore, the intermediate-pressure passage 21c of the present embodiment connects the gas refrigerant outlet of the hot-gas gas-liquid separator 15b and the intermediate-pressure suction port 11b. Other configurations of the vehicular air conditioner 1 are similar to those of the first embodiment.

Here, in the embodiment in which the exterior-device low-stage-side expansion valve 14b is eliminated as in the present embodiment, the exterior-device high-stage-side expansion valve 14a described in the first embodiment is referred to as an exterior-device-side expansion valve 14a for clarity of description. The exterior-device-side expansion valve 14a is an exterior-device-side decompression portion.

Next, the operation of the vehicular air conditioner 1 of the present embodiment having the above configuration will be described. In the control program of the present embodiment, as in the first embodiment, the control routine described above, such as reading detection and operation signals, determining the target blowout temperature TAO, selecting the operation mode, and controlling various devices according to the selected operation mode, is repeated every predetermined control cycle. Each operation mode will be described below.

### (a) Air-Cooling Mode

In the air-cooling mode of the present embodiment, the single air-cooling mode and the cooling and air-cooling mode can be switched as in the first embodiment.

(a-1) Single Air-Cooling Mode

In the heat pump cycle 10 in the single air-cooling mode, the control device 60 brings the exterior-device-side expansion valve 14a into the fully open state, brings the high-stage-side expansion valve 14c into the throttled state, brings the air-cooling expansion valve 14d into the throttled state, brings the cooling expansion valve 14e into the fully closed state, and brings the bypass-side flow rate regulation valve 14f into the fully closed state.

The control device 60 closes the high-pressure-side on/off valve 22a, opens the intermediate-pressure-side on/off valve 22c, and closes the low-pressure-side on/off valve 22d. Therefore, in the heat pump cycle 10 in the single air-cooling mode, the refrigerant circuit is switched to the refrigerant circuit through which the refrigerant flows in the same order as in the single air-cooling mode of the first embodiment.

Other operations are similar to those of the first embodiment. Therefore, in the single air-cooling mode, cooling of the vehicle interior is achieved as in the first embodiment.

(a-2) Cooling and Air-Cooling Mode

In the heat pump cycle 10 in the cooling and air-cooling mode, the control device 60 brings the cooling expansion valve 14e into the throttled state compared to the single air-cooling mode. Therefore, in the heat pump cycle 10 in the cooling and air-cooling mode, the refrigerant circuit is switched to the refrigerant circuit through which the refrigerant flows in the same order as in the cooling and air-cooling mode of the first embodiment.

Other operations are similar to those of the first embodiment. Therefore, in the cooling and air-cooling mode, cooling of the vehicle interior and cooling of the battery 70 are achieved as in the first embodiment.

### (b) Air-Heating Mode

In the air-cooling mode of the present embodiment, the single-stage outside air endothermic air-heating mode, the single-stage hot-gas air-heating mode, and the multi-stage hot-gas air-heating mode can be switched.

(b-4) Single-Stage Outside Air Endothermic Air-Heating Mode

The single-stage outside air endothermic air-heating mode is an operation mode corresponding to the outside air endothermic air-heating mode described in the first embodiment. The single-stage outside air endothermic air-heating mode is selected when heat absorbed from the outside air can be used as an air-heating heat source.

In the heat pump cycle 10 in the single-stage outside air endothermic air-heating mode, the control device 60 brings the exterior-device-side expansion valve 14a into the throttled state, brings the high-stage-side expansion valve 14c into the fully closed state, brings the air-cooling expansion valve 14d into the fully closed state, brings the cooling expansion valve 14e into the fully closed state, and brings the bypass-side flow rate regulation valve 14f into the fully closed state.

The control device 60 closes the high-pressure-side on/off valve 22a, closes the intermediate-pressure-side on/off valve 22c, and opens the low-pressure-side on/off valve 22d.

Therefore, in the heat pump cycle 10 in the single-stage outside air endothermic air-heating mode, as indicated by the thick solid lines and arrows in FIG. 13, the refrigerant discharged from the discharge port 11c of the compressor 11 is switched to the refrigerant circuit through which the refrigerant circulates in the order of the water-refrigerant heat exchanger 13, the exterior-device-side expansion valve 14a, the exterior heat exchanger 16, the low-pressure-side passage 21d, the accumulator 23, and the low-pressure suction port 11a of the compressor 11. Furthermore, the control device 60 controls the operations of other component devices as in the first embodiment.

Therefore, in the heat pump cycle 10 in the single-stage outside air endothermic air-heating mode, a single-stage vapor compression refrigeration cycle is configured in which the water-refrigerant heat exchanger 13 functions as a condenser and the exterior heat exchanger 16 functions as an evaporator.

In the water-refrigerant heat exchanger 13, the refrigerant radiates heat to the high-temperature-side heat medium, and the high-temperature-side heat medium is heated. In the exterior heat exchanger 16, the refrigerant absorbs heat from outside air.

In the high-temperature-side heat medium circuit 30 in the outside air endothermic air-heating mode, the high-temperature-side heat medium heated by the water-refrigerant heat exchanger 13 flows into the heater core 32 as in the first embodiment.

As in the first embodiment, the interior air conditioning unit 50 in the outside air endothermic air-heating mode blows the temperature-regulated ventilation air into the vehicle interior to achieve heating of the vehicle interior.

(b-2) Single-Stage Hot-Gas Air-Heating Mode

As in the first embodiment, the single-stage hot-gas air-heating mode is selected when heat absorbed from outside air cannot be used as an air-heating heat source or when the heating capacity of the ventilation air in the heater core 32 is determined as insufficient with respect to the target heating capacity during the execution of the single-stage outside air endothermic air-heating mode.

In the heat pump cycle 10 in the single-stage hot-gas air-heating mode, the control device 60 brings the exterior-device-side expansion valve 14a into the fully closed state, brings the high-stage-side expansion valve 14c into the throttled state, brings the air-cooling expansion valve 14d into the fully closed state, brings the cooling expansion valve 14e into the throttled state, and brings the bypass-side flow rate regulation valve 14f into the throttled state.

The control device 60 opens the high-pressure-side on/off valve 22a, closes the intermediate-pressure-side on/off valve 22c, and closes the low-pressure-side on/off valve 22d.

Thus, in the heat pump cycle 10 in the single-stage hot-gas air-heating mode, the refrigerant flows in the same order as in the single-stage hot-gas air-heating mode in the first embodiment.

Other operations are similar to those of the first embodiment. Therefore, in the single-stage hot-gas air-heating mode, heating of the vehicle interior is achieved as in the first embodiment.

(b-3) Multi-Stage Hot-Gas Air-Heating Mode

As in the first embodiment, the multi-stage hot-gas air-heating mode is selected when heat absorbed from outside air cannot be used as an air-heating heat source or when the heating capacity of the ventilation air in the heater core 32 is determined as insufficient with respect to the target heating capacity during the execution of the single-stage hot-gas air-heating mode.

In the heat pump cycle 10 in the multi-stage hot-gas air-heating mode, the control device 60 brings the exterior-device-side expansion valve 14a into the fully closed state, brings the high-stage-side expansion valve 14c into the throttled state, brings the air-cooling expansion valve 14d into the fully closed state, brings the cooling expansion valve 14e into the throttled state, and brings the bypass-side flow rate regulation valve 14f into the throttled state.

The control device 60 opens the high-pressure-side on/off valve 22a, opens the intermediate-pressure-side on/off valve 22c, and closes the low-pressure-side on/off valve 22d.

Thus, in the heat pump cycle 10 in the multi-stage hot-gas air-heating mode, the refrigerant flows in the same order as in the multi-stage hot-gas air-heating mode of the first embodiment.

Other operations are similar to those of the first embodiment. Therefore, in the multi-stage hot-gas air-heating mode, heating of the vehicle interior is achieved as in the first embodiment.

Moreover, the vehicular air conditioner 1 of the present embodiment can execute the multi-stage endothermic hot-gas air-heating mode as in the first embodiment.

(b-3-1) Multi-Stage Inside Air Endothermic Hot-Gas Air-Heating Mode

In the heat pump cycle 10 in the multi-stage inside air endothermic hot-gas air-heating mode, the control device 60 brings the exterior-device-side expansion valve 14a into the fully closed state, brings the high-stage-side expansion valve 14c into the throttled state, brings the air-cooling expansion valve 14d into the throttled state, brings the cooling expansion valve 14e into the fully closed state, and brings the bypass-side flow rate regulation valve 14f into the throttled state.

The control device 60 opens the high-pressure-side on/off valve 22a, opens the intermediate-pressure-side on/off valve 22c, and closes the low-pressure-side on/off valve 22d.

Thus, in the heat pump cycle 10 in the multi-stage inside air endothermic hot-gas air-heating mode, the refrigerant flows in the same order as in the multi-stage inside air endothermic hot-gas air-heating mode of the first embodiment.

Other operations are similar to those of the first embodiment. Accordingly, in the multi-stage inside air endothermic hot-gas air-heating mode, heating of the vehicle interior is achieved as in the multi-stage inside air endothermic hot-gas air-heating mode of the first embodiment.

(b-3-2) Multi-Stage Device Endothermic Hot-Gas Air-Heating Mode

In the heat pump cycle 10 in the multi-stage device endothermic hot-gas air-heating mode, the control device 60 brings the exterior-device-side expansion valve 14a into the fully closed state, brings the high-stage-side expansion valve 14c into the throttled state, brings the air-cooling expansion valve 14d into the fully closed state, brings the cooling expansion valve 14e into the throttled state, and brings the bypass-side flow rate regulation valve 14f into the throttled state.

The control device 60 opens the high-pressure-side on/off valve 22a, opens the intermediate-pressure-side on/off valve 22c, and closes the low-pressure-side on/off valve 22d.

Thus, in the heat pump cycle 10 in the multi-stage device endothermic hot-gas air-heating mode, the refrigerant flows in the same order as in the first embodiment.

Other operations are similar to those of the first embodiment. Therefore, in the multi-stage device endothermic hot-gas air-heating mode, heating of the vehicle interior is achieved as in the multi-stage device endothermic hot-gas air-heating mode of the first embodiment.

(b-3-3) Multi-Stage Outside Air Endothermic Hot-Gas Air-Heating Mode

In the heat pump cycle 10 in the multi-stage outside air endothermic hot-gas air-heating mode, the control device 60 brings the exterior-device-side expansion valve 14a into the throttled state, brings the high-stage-side expansion valve 14c into the throttled state, brings the air-cooling expansion valve 14d into the fully closed state, brings the cooling expansion valve 14e into the throttled state, and brings the bypass-side flow rate regulation valve 14f into the throttled state.

The control device 60 opens the high-pressure-side on/off valve 22a, opens the intermediate-pressure-side on/off valve 22c, and opens the low-pressure-side on/off valve 22d.

Thus, in the heat pump cycle 10 in the multi-stage outside air endothermic hot-gas air-heating mode, the refrigerant flows in the same order as in the first embodiment.

Other operations are similar to those of the first embodiment. Therefore, in the multi-stage outside air endothermic hot-gas air-heating mode, heating of the vehicle interior is achieved substantially similarly to the multi-stage outside air endothermic hot-gas air-heating mode of the first embodiment.

As described above, the vehicular air conditioner 1 of the present embodiment can perform comfortable air conditioning in the vehicle interior and appropriate temperature regulation of the battery 70, which is an in-vehicle device, by switching the operation mode. Furthermore, the same effects as those of the vehicular air conditioner 1 of the first embodiment can be obtained. Therefore, in the multi-stage hot-gas air-heating mode, sufficiently high heating capacity can be exerted in the heating portion without increasing the pressure of the low-pressure refrigerant.

### Third Embodiment

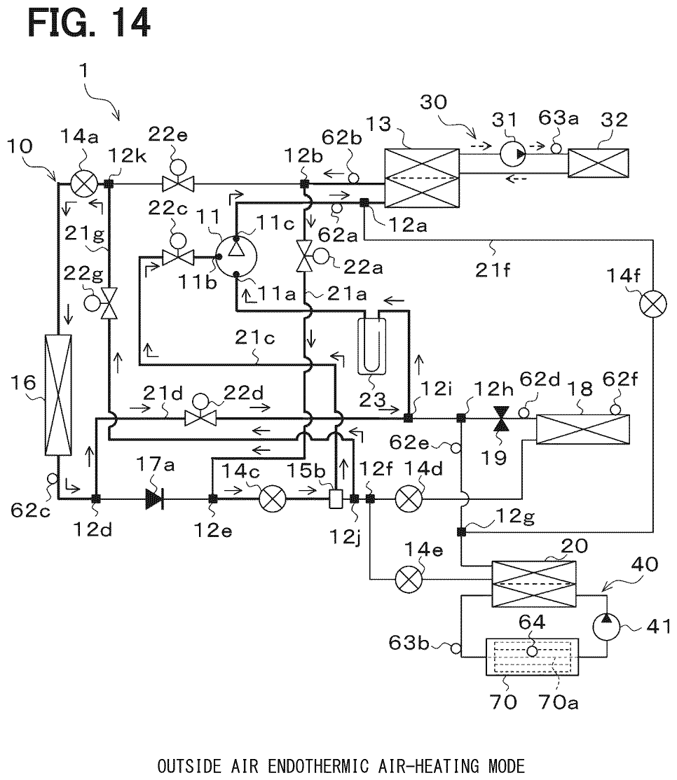

For the vehicular air conditioner 1 of the present embodiment, an example in which the configuration of the heat pump cycle 10 is changed from that of the second embodiment as illustrated in the overall configuration diagram of FIG. 14 and the like will be described.

Specifically, in the heat pump cycle 10 of the present embodiment, a tenth three-way joint 12j, an eleventh three-way joint 12k, an exterior-device passage 21g, an exterior-device on/off valve 22g, and a second high-pressure-side on/off valve 22e are added to the heat pump cycle of the second embodiment. Here, in the embodiment in which the second high-pressure-side on/off valve 22e is added as in the present embodiment, the high-pressure-side on/off valve 22a described in the first embodiment is referred to as a first high-pressure-side on/off valve 22a for clarity of description.

The tenth three-way joint 12j is disposed in the refrigerant passage from the liquid refrigerant outlet of the hot-gas gas-liquid separator 15b to the inflow port of the sixth three-way joint 12f. The inflow port of the tenth three-way joint 12j is connected to the liquid refrigerant outlet side of the hot-gas gas-liquid separator 15b. The inflow port side of the tenth three-way joint 12j is connected to one outflow port of the sixth three-way joint 12f.

The eleventh three-way joint 12k is disposed in the refrigerant passage from one outflow port of the second three-way joint 12b to the inlet of the exterior-device-side expansion valve 14a. One outflow port side of the eleventh three-way joint 12k is connected to one inflow port of the second three-way joint 12b. The inlet side of the exterior-device-side expansion valve 14a is connected to the outflow port of the eleventh three-way joint 12k.

The second high-pressure-side on/off valve 22e is disposed in the refrigerant passage from one outflow port of the second three-way joint 12b to one inflow port of the eleventh three-way joint 12k. The second high-pressure-side on/off valve 22e is a refrigerant circuit switching portion that opens and closes a refrigerant passage from one outflow port of the second three-way joint 12b to one inflow port of the eleventh three-way joint 12k.

The other inflow port side of the eleventh three-way joint 12k is connected to the other outflow port of the tenth three-way joint 12j. The refrigerant passage from the other outflow port of the tenth three-way joint 12j to the other inflow port of the eleventh three-way joint 12k is an exterior-device passage 21g that guides the liquid refrigerant separated by the hot-gas gas-liquid separator 15b to the inlet side of the exterior-device-side expansion valve 14a.

The exterior-device on/off valve 22g is disposed in the exterior-device passage 21g. The exterior-device on/off valve 22g is a refrigerant circuit switching portion that opens and closes exterior-device passage 21g. Other configurations of the vehicular air conditioner 1 are similar to those of the second embodiment.

Next, the operation of the vehicular air conditioner 1 of the present embodiment having the above configuration will be described. In the control program of the present embodiment, as in the first embodiment, the control routine described above, such as reading detection and operation signals, determining the target blowout temperature TAO, selecting the operation mode, and controlling various devices according to the selected operation mode, is repeated every predetermined control cycle. Each operation mode will be described below.

### (a) Air-Cooling Mode

In the air-cooling mode of the present embodiment, the single air-cooling mode and the cooling and air-cooling mode can be switched as in the first embodiment.

(a-1) Single Air-Cooling Mode

In the heat pump cycle 10 in the single air-cooling mode, the control device 60 brings the exterior-device-side expansion valve 14a into the fully open state, brings the high-stage-side expansion valve 14c into the throttled state, brings the air-cooling expansion valve 14d into the throttled state, brings the cooling expansion valve 14e into the fully closed state, and brings the bypass-side flow rate regulation valve 14f into the fully closed state.

The control device 60 closes the first high-pressure-side on/off valve 22a, opens the intermediate-pressure-side on/off valve 22c, closes the low-pressure-side on/off valve 22d, opens the second high-pressure-side on/off valve 22e, and closes the exterior-device on/off valve 22g. Therefore, in the heat pump cycle 10 in the single air-cooling mode, the refrigerant circuit is switched to the refrigerant circuit through which the refrigerant flows in the same order as in the single air-cooling mode of the first embodiment.

Other operations are similar to those of the first embodiment. Therefore, in the single air-cooling mode, cooling of the vehicle interior is achieved as in the first embodiment.

(a-2) Cooling and Air-Cooling Mode

In the heat pump cycle 10 in the cooling and air-cooling mode, the control device 60 brings the cooling expansion valve 14e into the throttled state compared to the single air-cooling mode. Therefore, in the heat pump cycle 10 in the cooling and air-cooling mode, the refrigerant circuit is switched to the refrigerant circuit through which the refrigerant flows in the same order as in the cooling and air-cooling mode of the first embodiment.

Other operations are similar to those of the first embodiment. Therefore, in the cooling and air-cooling mode, cooling of the vehicle interior and cooling of the battery 70 are achieved as in the first embodiment.

### (b) Air-Heating Mode

In the air-heating mode of the present embodiment, the outside air endothermic air-heating mode, the single-stage hot-gas air-heating mode, and the multi-stage hot-gas air-heating mode can be switched as in the first embodiment.

(b-1) Outside Air Endothermic Air-Heating Mode

In the heat pump cycle 10 in the outside air endothermic air-heating mode, the control device 60 brings the exterior-device-side expansion valve 14a into the throttled state, the high-stage-side expansion valve 14c into the throttled state, the air-cooling expansion valve 14d into the fully closed state, the cooling expansion valve 14e into the fully closed state, and the bypass-side flow rate regulation valve 14f into the fully closed state.

The control device 60 opens the first high-pressure-side on/off valve 22a, opens the intermediate-pressure-side on/off valve 22c, opens the low-pressure-side on/off valve 22d, closes the second high-pressure-side on/off valve 22e, and opens the exterior-device on/off valve 22g.

Therefore, in the heat pump cycle 10 in the outside air endothermic air-heating mode, as indicated by the thick solid lines in FIG. 14, the refrigerant discharged from the discharge port 11c of the compressor 11 flows through the water-refrigerant heat exchanger 13, the high-pressure-side passage 21a, the high-stage-side expansion valve 14c, and the hot-gas gas-liquid separator 15b in this order. The gas refrigerant separated by the hot-gas gas-liquid separator 15b flows through the intermediate-pressure passage 21c and the intermediate-pressure suction port 11b of the compressor 11 in this order. At the same time, the liquid refrigerant separated by the hot-gas gas-liquid separator 15b is switched to the refrigerant circuit in which the liquid refrigerant flows through the exterior-device passage 21g, the exterior-device-side expansion valve 14a, the exterior heat exchanger 16, the low-pressure-side passage 21d, the accumulator 23, and the low-pressure suction port 11a of the compressor 11 in this order.

Moreover, the control device 60 controls the throttle opening of the high-stage-side expansion valve 14c such that the degree of subcooling SC1 of the refrigerant flowing out of the water-refrigerant heat exchanger 13 approaches the reference degree of subcooling KSC1.

The control device 60 also controls the throttle opening of the exterior-device-side expansion valve 14a to be a predetermined reference opening for the outside air endothermic air-heating mode. As in the outside air endothermic air-heating mode of the first embodiment, the control device 60 controls the operations of other components.

Therefore, in the heat pump cycle 10 in the outside air endothermic air-heating mode, as in the first embodiment, a gas-liquid separation-type gas injection cycle is configured in which the water-refrigerant heat exchanger 13 functions as a condenser and the exterior heat exchanger 16 functions as an evaporator.

In the high-temperature-side heat medium circuit 30 in the outside air endothermic air-heating mode, the high-temperature-side heat medium heated by the water-refrigerant heat exchanger 13 flows into the heater core 32 as in the first embodiment.

As in the first embodiment, the interior air conditioning unit 50 in the outside air endothermic air-heating mode blows the temperature-regulated ventilation air into the vehicle interior to achieve heating of the vehicle interior.

(b-2) Single-Stage Hot-Gas Air-Heating Mode

In the heat pump cycle 10 in the single-stage hot-gas air-heating mode, the control device 60 brings the exterior-device-side expansion valve 14a into the fully closed state, brings the high-stage-side expansion valve 14c into the fully open state, brings the air-cooling expansion valve 14d into the fully closed state, brings the cooling expansion valve 14e into the throttled state, and brings the bypass-side flow rate regulation valve 14f into the throttled state.

The control device 60 opens the first high-pressure-side on/off valve 22a, closes the intermediate-pressure-side on/off valve 22c, closes the low-pressure-side on/off valve 22d, closes the second high-pressure-side on/off valve 22e, and closes the exterior-device on/off valve 22g.

Thus, in the heat pump cycle 10 in the single-stage hot-gas air-heating mode, the refrigerant flows in the same order as in the single-stage hot-gas air-heating mode in the first embodiment.

Other operations are similar to those of the first embodiment. Therefore, in the single-stage hot-gas air-heating mode, heating of the vehicle interior is achieved as in the first embodiment.

(b-3) Multi-Stage Hot-Gas Air-Heating Mode

In the heat pump cycle 10 in the multi-stage hot-gas air-heating mode, the control device 60 brings the exterior-device-side expansion valve 14a into the fully closed state, brings the high-stage-side expansion valve 14c into the throttled state, brings the air-cooling expansion valve 14d into the fully closed state, brings the cooling expansion valve 14e into the throttled state, and brings the bypass-side flow rate regulation valve 14f into the throttled state.

The control device 60 opens the first high-pressure-side on/off valve 22a, opens the intermediate-pressure-side on/off valve 22c, closes the low-pressure-side on/off valve 22d, closes the second high-pressure-side on/off valve 22e, and closes the exterior-device on/off valve 22g.

Thus, in the heat pump cycle 10 in the multi-stage hot-gas air-heating mode, the refrigerant flows in the same order as in the multi-stage hot-gas air-heating mode of the first embodiment.

Other operations are similar to those of the first embodiment. Therefore, in the multi-stage hot-gas air-heating mode, heating of the vehicle interior is achieved as in the first embodiment.

Moreover, the vehicular air conditioner 1 of the present embodiment can execute the multi-stage endothermic hot-gas air-heating mode as in the first embodiment.

(b-3-1) Multi-Stage Inside Air Endothermic Hot-Gas Air-Heating Mode

In the heat pump cycle 10 in the multi-stage inside air endothermic hot-gas air-heating mode, the control device 60 brings the exterior-device-side expansion valve 14a into the fully closed state, brings the high-stage-side expansion valve 14c into the throttled state, brings the air-cooling expansion valve 14d into the throttled state, brings the cooling expansion valve 14e into the fully closed state, and brings the bypass-side flow rate regulation valve 14f into the throttled state.

The control device 60 opens the first high-pressure-side on/off valve 22a, opens the intermediate-pressure-side on/off valve 22c, closes the low-pressure-side on/off valve 22d, closes the second high-pressure-side on/off valve 22e, and closes the exterior-device on/off valve 22g.

Thus, in the heat pump cycle 10 in the multi-stage inside air endothermic hot-gas air-heating mode, the refrigerant flows in the same order as in the multi-stage inside air endothermic hot-gas air-heating mode of the first embodiment.

Other operations are similar to those of the first embodiment. Accordingly, in the multi-stage inside air endothermic hot-gas air-heating mode, heating of the vehicle interior is achieved as in the multi-stage inside air endothermic hot-gas air-heating mode of the first embodiment.

(b-3-2) Multi-Stage Device Endothermic Hot-Gas Air-Heating Mode

In the heat pump cycle 10 in the multi-stage device endothermic hot-gas air-heating mode, the control device 60 brings the exterior-device-side expansion valve 14a into the fully closed state, brings the high-stage-side expansion valve 14c into the throttled state, brings the air-cooling expansion valve 14d into the fully closed state, brings the cooling expansion valve 14e into the throttled state, and brings the bypass-side flow rate regulation valve 14f into the throttled state.

The control device 60 opens the first high-pressure-side on/off valve 22a, opens the intermediate-pressure-side on/off valve 22c, closes the low-pressure-side on/off valve 22d, closes the second high-pressure-side on/off valve 22e, and closes the exterior-device on/off valve 22g.

Thus, in the heat pump cycle 10 in the multi-stage inside air endothermic hot-gas air-heating mode, the refrigerant flows in the same order as in the multi-stage device endothermic hot-gas air-heating mode of the first embodiment.

Other operations are similar to those of the first embodiment. Therefore, in the multi-stage device endothermic hot-gas air-heating mode, heating of the vehicle interior is achieved as in the multi-stage inside air endothermic hot-gas air-heating mode of the first embodiment.

(b-3-3) Multi-Stage Outside Air Endothermic Hot-Gas Air-Heating Mode

In the heat pump cycle 10 in the multi-stage outside air endothermic hot-gas air-heating mode, the control device 60 brings the exterior-device-side expansion valve 14a into the throttled state, brings the high-stage-side expansion valve 14c into the throttled state, brings the air-cooling expansion valve 14d into the fully closed state, brings the cooling expansion valve 14e into the throttled state, and brings the bypass-side flow rate regulation valve 14f into the throttled state.

The control device 60 opens the first high-pressure-side on/off valve 22a, opens the intermediate-pressure-side on/off valve 22c, opens the low-pressure-side on/off valve 22d, closes the second high-pressure-side on/off valve 22e, and opens the exterior-device on/off valve 22g.

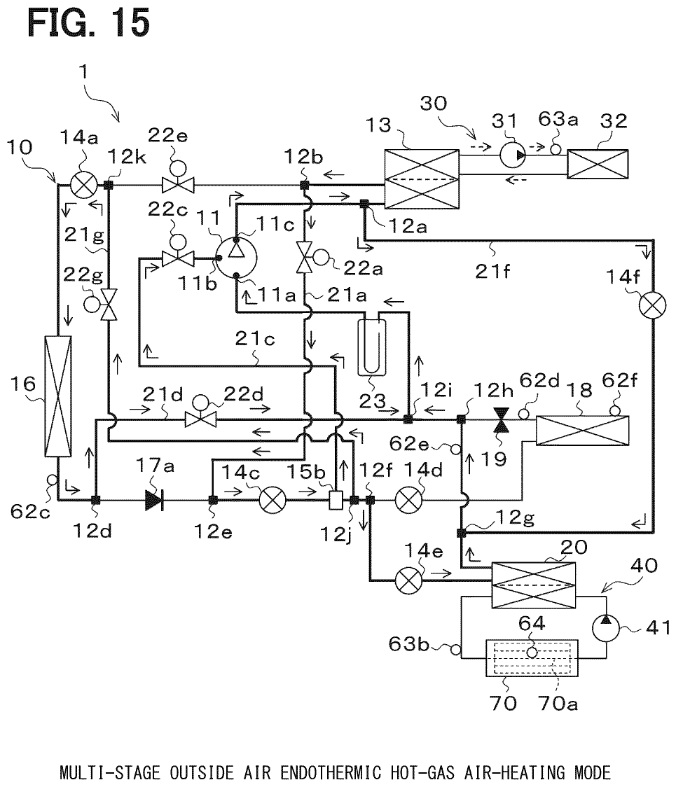

Therefore, in the heat pump cycle 10 in the multi-stage outside air endothermic hot-gas air-heating mode, as indicated by the thick solid lines and arrows in FIG. 15, the refrigerant discharged from the discharge port 11c of the compressor 11 flows as in the multi-stage hot-gas air-heating mode. At the same time, the liquid refrigerant separated by the hot-gas gas-liquid separator 15b is switched to the refrigerant circuit in which the liquid refrigerant flows through the exterior-device passage 21g, the exterior-device-side expansion valve 14a, the exterior heat exchanger 16, the low-pressure-side passage 21d, the accumulator 23, and the low-pressure suction port 11a of the compressor 11 in this order.

The control device 60 also controls the throttle opening of the exterior-device-side expansion valve 14a so that the exterior-device-side refrigerant temperature T2 is lower than the outside air temperature Tam. As in the multi-stage hot-gas air-heating mode, the control device 60 controls the operations of various components of the other heat pump cycle 10.

In the high-temperature-side heat medium circuit 30 in the multi-stage outside air endothermic hot-gas air-heating mode, as in the multi-stage hot-gas air-heating mode, the control device 60 controls the operations of various components of the high-temperature-side heat medium circuit 30.

In the low-temperature-side heat medium circuit 40 in the multi-stage outside air endothermic hot-gas air-heating mode, the control device 60 stops the low-temperature-side pump 41 as in the multi-stage hot-gas air-heating mode.

In the interior air conditioning unit 50 in the multi-stage outside air endothermic hot-gas air-heating mode, the control device 60 controls the operations of various components of the interior air conditioning unit 50 as in the multi-stage hot-gas air-heating mode. Furthermore, the control device 60 appropriately controls the operation of other devices to be controlled.

Accordingly, in the heat pump cycle 10 in the multi-stage outside air endothermic hot-gas air-heating mode, the refrigerant radiates heat to the high-temperature-side heat medium in the water-refrigerant heat exchanger 13 as in the multi-stage hot-gas air-heating mode. Thereby, the high-temperature-side heat medium is heated. As in the outside air endothermic air-heating mode, the refrigerant absorbs heat from the outside air at the interior evaporator 18.

In the high-temperature-side heat medium circuit 30 in the multi-stage outside air endothermic hot-gas air-heating mode, the high-temperature-side heat medium heated by the water-refrigerant heat exchanger 13 flows into the heater core 32 as in the single air-cooling mode.

As in the multi-stage hot-gas air-heating mode, the interior air conditioning unit 50 in the multi-stage outside air endothermic hot-gas air-heating mode blows temperature-regulated ventilation air into the vehicle interior to achieve heating of the vehicle interior.

Moreover, in the multi-stage outside air endothermic hot-gas air-heating mode, the heat of the outside air can be absorbed by the refrigerant in the exterior heat exchanger 16 and used as a heat source for heating the ventilation air in the heater core 32. Therefore, in the multi-stage outside air endothermic hot-gas air-heating mode, the heating capacity of the ventilation air can be improved compared to the multi-stage hot-gas air-heating mode.

As described above, the vehicular air conditioner 1 of the present embodiment can perform comfortable air conditioning in the vehicle interior and appropriate temperature regulation of the battery 70, which is an in-vehicle device, by switching the operation mode. Furthermore, the same effects as those of the vehicular air conditioner 1 of the first embodiment can be obtained. Therefore, in the multi-stage hot-gas air-heating mode, sufficiently high heating capacity can be exerted in the heating portion without increasing the pressure of the low-pressure refrigerant.

Moreover, the heat pump cycle 10 of the present embodiment further includes the exterior-device-side expansion valve 14a, the exterior heat exchanger 16, and the exterior-device passage 21g. Therefore, in the vehicular air conditioner 1 of the present embodiment, the refrigerant circuit switching portion switches the refrigerant circuit of the heat pump cycle 10, so that the outside air endothermic air-heating mode can be executed. In the outside air endothermic air-heating mode, as in the first embodiment, COP can be improved to achieve efficient heating.

### Fourth Embodiment

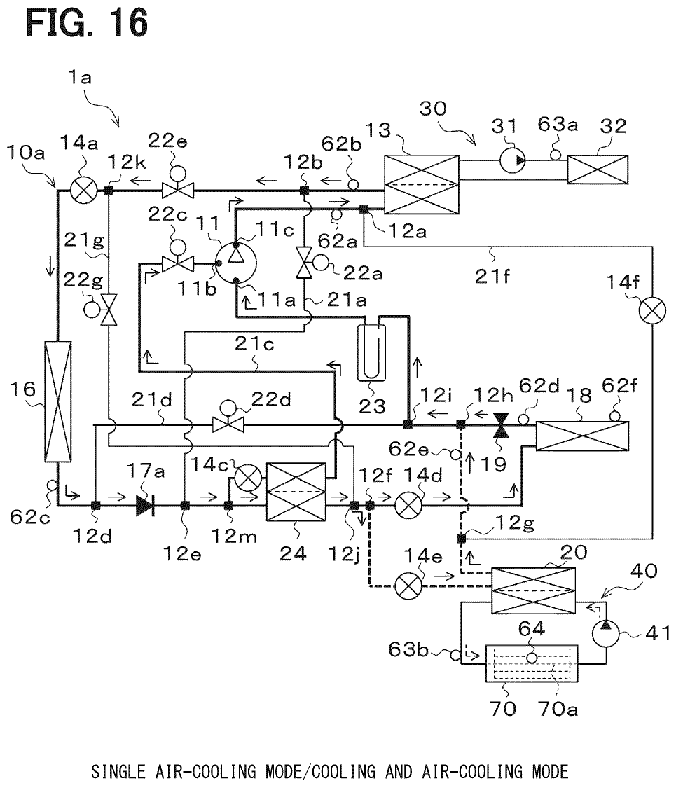

A vehicular air conditioner 1a of the present embodiment includes a heat pump cycle 10a illustrated in an overall configuration diagram of FIG. 16 and the like.

Specifically, in the heat pump cycle 10a of the present embodiment, the hot-gas gas-liquid separator 15b is eliminated compared to the third embodiment. In the heat pump cycle 10a of the present embodiment, a thirteenth three-way joint 12m and an internal heat exchanger 24 are added to the heat pump cycle of the third embodiment.

The thirteenth three-way joint 12m divides the flow of the refrigerant flowing out of the fifth three-way joint 12e. Accordingly, during the multi-stage hot-gas air-heating mode, the thirteenth three-way joint 12m serves as a downstream branch that divides the flow of the refrigerant flowing out of the water-refrigerant heat exchanger 13. The inlet side of the low-temperature-side passage of the internal heat exchanger 24 is connected to one outflow port of the thirteenth three-way joint 12m. The inlet side of the high-temperature-side passage of the internal heat exchanger 24 is connected to the other outflow port of the thirteenth three-way joint 12m.

The high-stage-side expansion valve 14c is disposed in the refrigerant passage connecting one outflow port of the thirteenth three-way joint 12m and the inlet of the low-temperature-side passage of the internal heat exchanger 24. Therefore, the high-stage-side expansion valve 14c of the present embodiment serves as a high-stage-side decompression portion that decompresses one of the refrigerant divided at the thirteenth three-way joint 12m.

The internal heat exchanger 24 includes a low-temperature-side passage and a high-temperature-side passage. The low-temperature-side passage is a refrigerant passage through which the refrigerant decompressed by the high-stage-side expansion valve 14c flows. The high-temperature-side passage is a refrigerant passage through which the other of the refrigerant divided at the thirteenth three-way joint 12m flows. Therefore, the internal heat exchanger 24 is an internal heat exchanger that exchanges heat between the refrigerant decompressed by the high-stage-side expansion valve 14c and the other of the refrigerant divided at the thirteenth three-way joint 12m.

The intermediate-pressure passage 21c of the present embodiment connects the outlet of the low-temperature-side passage of the internal heat exchanger 24 and the intermediate-pressure suction port 11b. The inflow port side of the tenth three-way joint 12j is connected to the outlet of the high-temperature-side passage of the internal heat exchanger 24. Therefore, the air-cooling expansion valve 14d and the cooling expansion valve 14e of the present embodiment serve as low-stage-side decompression portions that decompress the other of the refrigerant divided at the thirteenth three-way joint 12m and flowing out of the internal heat exchanger 24. Other configurations of the vehicular air conditioner 1a are similar to those of the vehicular air conditioner 1 described in the first embodiment.

Next, the operation of the vehicular air conditioner 1a of the present embodiment in the above configuration will be described. In the control program of the present embodiment, as in the first embodiment, the control routine described above, such as reading detection and operation signals, determining the target blowout temperature TAO, selecting the operation mode, and controlling various devices to be controlled, is repeated every predetermined control cycle. Each operation mode will be described below.

### (a) Air-Cooling Mode

In the air-cooling mode of the present embodiment, the single air-cooling mode and the cooling and air-cooling mode can be switched as in the first embodiment.

(a-1) Single Air-Cooling Mode

In the heat pump cycle 10a in the single air-cooling mode, the control device 60 brings the exterior-device-side expansion valve 14a into the fully open state, brings the high-stage-side expansion valve 14c into the throttled state, brings the air-cooling expansion valve 14d into the throttled state, brings the cooling expansion valve 14e into the fully closed state, and brings the bypass-side flow rate regulation valve 14f into the fully closed state.

The control device 60 closes the first high-pressure-side on/off valve 22a, opens the intermediate-pressure-side on/off valve 22c, closes the low-pressure-side on/off valve 22d, opens the second high-pressure-side on/off valve 22e, and closes the exterior-device on/off valve 22g.

Therefore, in the heat pump cycle 10a in the single air-cooling mode, as indicated by the thick solid lines and arrows in FIG. 16, the refrigerant discharged from the discharge port 11c of the compressor 11 flows through the water-refrigerant heat exchanger 13, the exterior-device-side expansion valve 14a in the fully open state, the exterior heat exchanger 16, and the thirteenth three-way joint 12m in this order. One of the refrigerant divided at the thirteenth three-way joint 12m flows through the high-stage-side expansion valve 14c, the low-temperature-side passage of the internal heat exchanger 24, the intermediate-pressure passage 21c, and the intermediate-pressure suction port 11b of the compressor 11 in this order. At the same time, the other of the refrigerant divided at the thirteenth three-way joint 12m is switched to the refrigerant circuit in which the other of the refrigerant flows through the high-temperature-side passage of the internal heat exchanger 24, the air-cooling expansion valve 14d, the interior evaporator 18, the evaporating pressure regulation valve 19, the accumulator 23, and the low-pressure suction port 11a of the compressor 11 in this order.

Moreover, the control device 60 controls the throttle opening of the air-cooling expansion valve 14d such that the degree of subcooling SC2 of the refrigerant flowing out of the exterior heat exchanger 16 approaches a predetermined reference degree of subcooling KSC2. The control device 60 controls the throttle opening of the high-stage-side expansion valve 14c to be a predetermined reference opening for the air-cooling mode. The reference opening for the air-cooling mode is determined such that the refrigerant flowing into the intermediate-pressure suction port 11b becomes a gas refrigerant. As in the single air-cooling mode of the first embodiment, the control device 60 controls the operations of other components.

Therefore, in the heat pump cycle 10a in the single air-cooling mode, a two-stage boost type vapor compression refrigeration cycle is configured in which the water-refrigerant heat exchanger 13 and the exterior heat exchanger 16 function as condensers and the interior evaporator 18 functions as an evaporator. More specifically, in the heat pump cycle 10a in the single air-cooling mode of the present embodiment, a so-called internal heat-exchange-type gas injection cycle is configured.

As in the first embodiment, the high-temperature-side heat medium is heated in water-refrigerant heat exchanger 13. In the exterior heat exchanger 16, the refrigerant radiates heat to the outside air. The ventilation air is cooled in the interior evaporator 18.

In the high-temperature-side heat medium circuit 30 in the single air-cooling mode, as in the first embodiment, the high-temperature-side heat medium heated by the water-refrigerant heat exchanger 13 flows into the heater core 32.

As in the first embodiment, the interior air conditioning unit 50 in the single air-cooling mode blows the temperature-regulated ventilation air into the vehicle interior to achieve cooling of the vehicle interior.

(a-2) Cooling and Air-Cooling Mode

In the heat pump cycle 10a in the cooling and air-cooling mode, the control device 60 brings the cooling expansion valve 14e into the throttled state compared to the single air-cooling mode.

Therefore, in the heat pump cycle 10a in the cooling and air-cooling mode, as indicated by the thick solid lines and arrows in FIG. 16, the refrigerant discharged from the discharge port 11c of the compressor 11 flows as in the single air-cooling mode. At the same time, as indicated by the thick broken lines and arrows in FIG. 16, the other of the refrigerant divided at the thirteenth three-way joint 12m is switched to the refrigerant circuit in which the other of the refrigerant flows through the high-temperature-side passage of the internal heat exchanger 24, the cooling expansion valve 14e, the chiller 20, the accumulator 23, and the low-pressure suction port 11a of the compressor 11 in this order.

That is, in the heat pump cycle 10a in the cooling and air-cooling mode, the interior evaporator 18 and the chiller 20 are switched to the refrigerant circuit connected in parallel to the flow of the refrigerant flowing out of the high-temperature-side passage of the internal heat exchanger 24.

Moreover, the control device 60 controls the throttle opening of the cooling expansion valve 14e to be a predetermined throttle opening for the cooling and air-cooling mode. As in the cooling and air-cooling mode of the first embodiment, the control device 60 controls the operations of other components.

Therefore, in the heat pump cycle 10a in the cooling and air-cooling mode, an internal heat-exchange-type gas injection cycle is configured in which the water-refrigerant heat exchanger 13 and the exterior heat exchanger 16 function as condensers, and the interior evaporator 18 and the chiller 20 function as evaporators.

As in the first embodiment, the high-temperature-side heat medium is heated in water-refrigerant heat exchanger 13. In the exterior heat exchanger 16, the refrigerant radiates heat to the outside air. The ventilation air is cooled in the interior evaporator 18. In the chiller 20, the low-temperature-side heat medium is cooled.

In the high-temperature-side heat medium circuit 30 in the single air-cooling mode, as in the first embodiment, the high-temperature-side heat medium heated by the water-refrigerant heat exchanger 13 flows into the heater core 32.

In the low-temperature-side heat medium circuit 40 in the cooling and air-cooling mode, as in the first embodiment, the low-temperature-side heat medium cooled by the chiller 20 flows through the cooling water passage 70a of the battery 70. As a result, the battery 70 is cooled.

As in the first embodiment, the interior air conditioning unit 50 in the single air-cooling mode blows the temperature-regulated ventilation air into the vehicle interior to achieve cooling of the vehicle interior.

### (b) Air-Heating Mode

In the air-heating mode of the present embodiment, the outside air endothermic air-heating mode, the single-stage hot-gas air-heating mode, and the multi-stage hot-gas air-heating mode can be switched as in the first embodiment.

(b-1) Outside Air Endothermic Air-Heating Mode

In the heat pump cycle 10a in the single air-cooling mode, the control device 60 brings the exterior-device-side expansion valve 14a into the throttled state, the high-stage-side expansion valve 14c into the throttled state, the air-cooling expansion valve 14d into the fully closed state, the cooling expansion valve 14e into the fully closed state, and the bypass-side flow rate regulation valve 14f into the fully closed state.

The control device 60 opens the first high-pressure-side on/off valve 22a, opens the intermediate-pressure-side on/off valve 22c, opens the low-pressure-side on/off valve 22d, closes the second high-pressure-side on/off valve 22e, and opens the exterior-device on/off valve 22g.

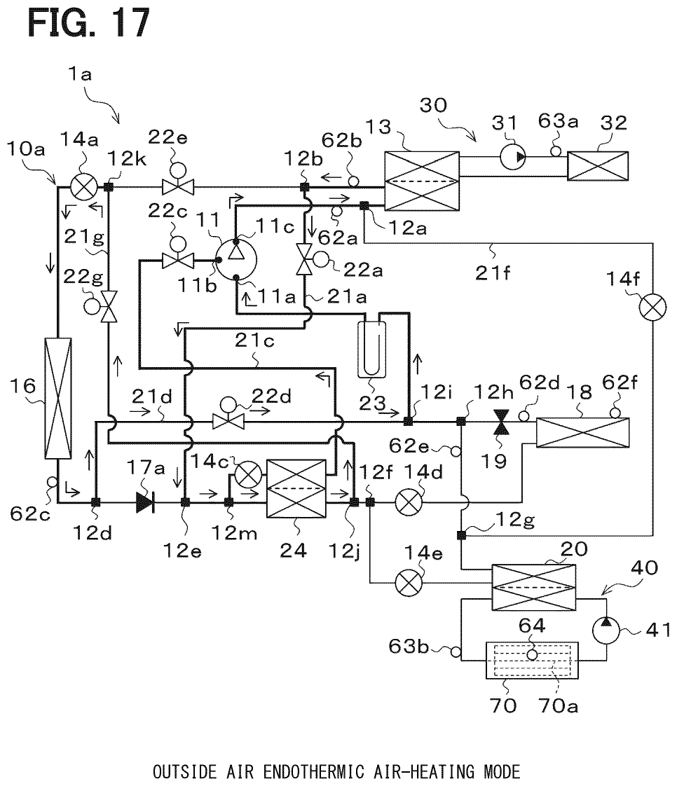

Accordingly, in the heat pump cycle 10a in the outside air endothermic air-heating mode, as indicated by the thick solid lines and arrows in FIG. 17, the refrigerant discharged from the discharge port 11c of the compressor 11 flows through the water-refrigerant heat exchanger 13, the high-pressure-side passage 21a, and the thirteenth three-way joint 12m in this order. One of the refrigerant divided at the thirteenth three-way joint 12m flows through the high-stage-side expansion valve 14c, the low-temperature-side passage of the internal heat exchanger 24, the intermediate-pressure passage 21c, and the intermediate-pressure suction port 11b of the compressor 11 in this order. At the same time, the other of the refrigerant divided at the thirteenth three-way joint 12m is switched to the refrigerant circuit in which the other of the refrigerant flows through the high-temperature-side passage of the internal heat exchanger 24, the exterior-device passage 21g, the exterior-device-side expansion valve 14a, the exterior heat exchanger 16, the low-pressure-side passage 21d, the accumulator 23, and the low-pressure suction port 11a of the compressor 11 in this order.

Moreover, the control device 60 controls the throttle opening of the exterior-device-side expansion valve 14a such that the degree of subcooling SC1 of the refrigerant flowing out of the water-refrigerant heat exchanger 13 approaches the reference degree of subcooling KSC1. The control device 60 also controls the throttle opening of the high-stage-side expansion valve 14c to be a predetermined reference opening for the air-heating mode. The reference opening for the air-heating mode is determined such that the refrigerant flowing into the intermediate-pressure suction port 11b is a gas refrigerant. As in the outside air endothermic air-heating mode of the first embodiment, the control device 60 controls the operations of other components.

Therefore, in the heat pump cycle 10a in the outside air endothermic air-heating mode, an internal heat-exchange-type gas injection cycle is configured in which the water-refrigerant heat exchanger 13 functions as a condenser and the exterior heat exchanger 16 functions as an evaporator.

As in the first embodiment, the high-temperature-side heat medium is heated in water-refrigerant heat exchanger 13. In the exterior heat exchanger 16, the refrigerant absorbs heat from outside air.

In the high-temperature-side heat medium circuit 30 in the outside air endothermic air-heating mode, the high-temperature-side heat medium heated by the water-refrigerant heat exchanger 13 flows into the heater core 32 as in the first embodiment.

As in the first embodiment, the interior air conditioning unit 50 in the outside air endothermic air-heating mode blows the temperature-regulated ventilation air into the vehicle interior to achieve heating of the vehicle interior.

(b-2) Single-Stage Hot-Gas Air-Heating Mode

In the heat pump cycle 10a in the single-stage hot-gas air-heating mode, the control device 60 brings the exterior-device-side expansion valve 14a into the fully closed state, brings the high-stage-side expansion valve 14c into the fully closed state, brings the air-cooling expansion valve 14d into the fully closed state, brings the cooling expansion valve 14e into the throttled state, and brings the bypass-side flow rate regulation valve 14f into the throttled state.

The control device 60 opens the first high-pressure-side on/off valve 22a, closes the intermediate-pressure-side on/off valve 22c, closes the low-pressure-side on/off valve 22d, closes the second high-pressure-side on/off valve 22e, and closes the exterior-device on/off valve 22g.

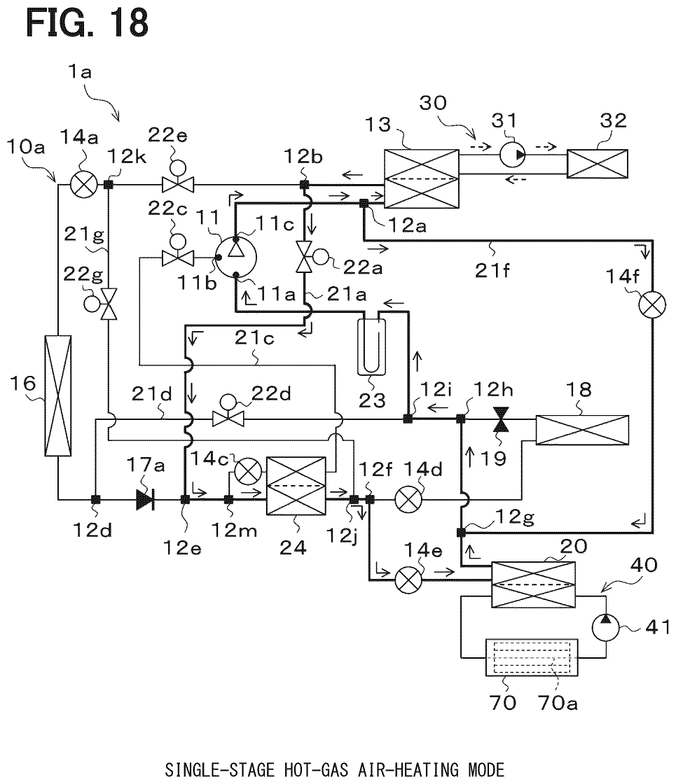

Therefore, in the heat pump cycle 10a in the single-stage hot-gas air-heating mode, as indicated by the thick solid lines and arrows in FIG. 18, the refrigerant discharged from the discharge port 11c of the compressor 11 circulates through the water-refrigerant heat exchanger 13, the high-pressure-side passage 21a, the high-temperature-side passage of the internal heat exchanger 24, the cooling expansion valve 14e, the chiller 20, the seventh three-way joint 12g, the accumulator 23, and the low-pressure suction port 11a of the compressor 11 in this order. At the same time, the refrigerant discharged from the compressor 11 is switched to the refrigerant circuit through which the refrigerant circulates in the order of the bypass-side flow rate regulation valve 14f, the seventh three-way joint 12g, and the low-pressure suction port 11a of the compressor 11 arranged in the bypass passage 21f.

In the single-stage hot-gas air-heating mode, the high-stage-side expansion valve 14c is fully closed and the exterior-device on/off valve 22g is closed, so that the refrigerant does not flow through the low-temperature-side passage of the internal heat exchanger 24. For this reason, in the single-stage hot-gas air-heating mode, the refrigerant does not exchange heat with the refrigerant flowing through the low-temperature-side passage in the high-temperature-side passage of the internal heat exchanger 24, and the high-temperature-side passage of the internal heat exchanger 24 becomes a simple refrigerant passage.

Thus, in the heat pump cycle 10a in the single-stage hot-gas air-heating mode, the refrigerant flows in substantially the same order as in the first embodiment.

Other operations are similar to those of the first embodiment. Therefore, in the single-stage hot-gas air-heating mode, heating of the vehicle interior is achieved as in the first embodiment.

(b-3) Multi-Stage Hot-Gas Air-Heating Mode

In the heat pump cycle 10a in the multi-stage hot-gas air-heating mode, the control device 60 brings the exterior-device-side expansion valve 14a into the fully closed state, brings the high-stage-side expansion valve 14c into the throttled state, brings the air-cooling expansion valve 14d into the fully closed state, brings the cooling expansion valve 14e into the throttled state, and brings the bypass-side flow rate regulation valve 14f into the throttled state.

The control device 60 opens the first high-pressure-side on/off valve 22a, opens the intermediate-pressure-side on/off valve 22c, closes the low-pressure-side on/off valve 22d, closes the second high-pressure-side on/off valve 22e, and closes the exterior-device on/off valve 22g.

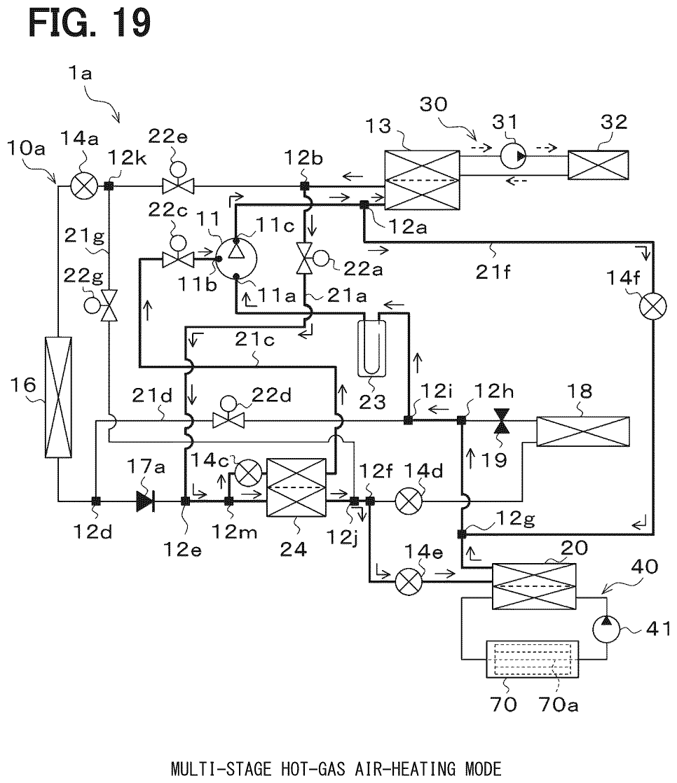

Therefore, in the heat pump cycle 10a in the single-stage hot-gas air-heating mode, as indicated by the thick solid lines and arrows in FIG. 19, the refrigerant discharged from the discharge port 11c of the compressor 11 flows through the water-refrigerant heat exchanger 13, the high-pressure-side passage 21a, and the thirteenth three-way joint 12m in this order. One of the refrigerant divided at the thirteenth three-way joint 12m flows through the high-stage-side expansion valve 14c, the low-temperature-side passage of the internal heat exchanger 24, the intermediate-pressure passage 21c, and the intermediate-pressure suction port 11b of the compressor 11 in this order. The other of the refrigerant divided at the thirteenth three-way joint 12m flows in the order of the high-temperature-side passage of the internal heat exchanger 24, the cooling expansion valve 14e, the chiller 20, the seventh three-way joint 12g, the accumulator 23, and the low-pressure suction port 11a of the compressor 11. At the same time, the refrigerant discharged from the compressor 11 is switched to the refrigerant circuit through which the refrigerant circulates in the order of the bypass-side flow rate regulation valve 14f, the seventh three-way joint 12g, and the low-pressure suction port 11a of the compressor 11 arranged in the bypass passage 21f.

Furthermore, when the ventilation air temperature TAV can be set to the target blowout temperature TAO by adjusting the opening of the air mix door 54, the control device 60 controls the throttle opening of the high-stage-side expansion valve 14c to be the reference opening for the air-heating mode, as in the outside air endothermic air-heating mode.

On the other hand, even if the air mix door 54 is displaced to a position where the air passage on the heater core 32 side is fully opened and the cold air bypass passage 55 is fully closed, when the ventilation air temperature TAV is lower than the target blowout temperature TAO, the throttle opening of the high-stage-side expansion valve 14c is increased from the current value to the extent that the refrigerant flowing into the intermediate-pressure suction port 11b becomes the gas refrigerant. As in the multi-stage hot-gas air-heating mode of the first embodiment, the control device 60 controls the operations of other components.

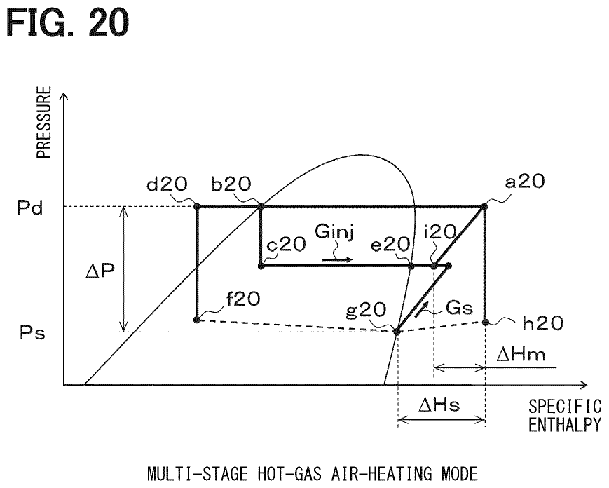

Therefore, in the heat pump cycle 10 in the multi-stage hot-gas air-heating mode, the state of the refrigerant changes as illustrated in a Mollier diagram of FIG. 20.

That is, the flow of the high-pressure refrigerant (point a20 in FIG. 20) discharged from the discharge port 11c of the compressor 11 is divided at the first three-way joint 12a. One of the refrigerant divided at first three-way joint 12a flows into the water-refrigerant heat exchanger 13 and radiates heat to the high-temperature-side heat medium (from point a20 to point b20 in FIG. 20). Thereby, the high-temperature-side heat medium is heated.

The refrigerant flowing out of the water-refrigerant heat exchanger 13 flows into the high-pressure-side passage 21a. The flow of the refrigerant flowing into the high-pressure-side passage 21a is divided at the thirteenth three-way joint 12m. One of the refrigerant divided at the thirteenth three-way joint 12m flows into the high-stage-side expansion valve 14c and is decompressed (from point b20 to point c20 in FIG. 20)

The refrigerant flowing out of the high-stage-side expansion valve 14c flows into the low-temperature-side passage of the internal heat exchanger 24. When the refrigerant, flowing into the low-temperature-side passage, flows through the low-temperature-side passage, the refrigerant exchanges heat with the refrigerant flowing through the high-temperature-side passage and is heated (from point c20 to point e20 in FIG. 20).

The refrigerant allowed to flow and heated in the low-temperature-side passage of the internal heat exchanger 24 is drawn into the compressor 11 from the intermediate-pressure suction port 11b via the intermediate-pressure passage 21c. The intermediate-pressure refrigerant drawn from the intermediate-pressure suction port 11b merges with the refrigerant in the process of compression from low pressure to high pressure in the compressor 11 (point i7 in FIG. 9).

The other of the refrigerant divided at the thirteenth three-way joint 12m flows into the high-temperature-side passage of the internal heat exchanger 24. When the refrigerant, flowing into the high-temperature-side passage, flows through the high-temperature-side passage, the refrigerant exchanges heat with the refrigerant flowing through the low-temperature-side passage and is cooled (from point b20 to point d20 in FIG. 20).

The refrigerant cooled by flowing through the high-temperature-side passage of the internal heat exchanger 24 flows into the cooling expansion valve 14e and is decompressed (from point d20 to point f20 in FIG. 20). The low-pressure refrigerant having a relatively low enthalpy and flowing out of the cooling expansion valve 14e flows into the other inflow port of the seventh three-way joint 12g via the chiller 20.

In the multi-stage hot-gas air-heating mode, since the low-temperature-side pump 41 is stopped, the refrigerant flowing into the chiller 20 does not exchange heat with the low-temperature-side heat medium.

As in the single-stage hot-gas air-heating mode, the other of the refrigerant divided at the first three-way joint 12a flows into the bypass passage 21f, and the other of the refrigerant is regulated in flow rate and decompressed by the bypass-side flow rate regulation valve 14f (from point a20 to point h20 in FIG. 20). The low-pressure refrigerant decompressed by the bypass-side flow rate regulation valve 14f and having a relatively high enthalpy flows into one inflow port of the seventh three-way joint 12g.

The refrigerant merged at the seventh three-way joint 12g flows into the accumulator 23 and is separated into gas and liquid. The gas refrigerant (point g20 in FIG. 20) separated by the accumulator 23 is drawn into the compressor 11 from the low-pressure suction port 11a and compressed.

In the high-temperature-side heat medium circuit 30 in the multi-stage hot-gas air-heating mode, the high-temperature-side heat medium heated by the water-refrigerant heat exchanger 13 flows into the heater core 32 as in the single air-cooling mode.

As in the outside air endothermic air-heating mode, the interior air conditioning unit 50 in the multi-stage hot-gas air-heating mode blows the temperature-regulated ventilation air into the vehicle interior to achieve heating of the vehicle interior.

Moreover, the vehicular air conditioner 1 of the present embodiment can execute the multi-stage endothermic hot-gas air-heating mode as in the first embodiment.

(b-3-1) Multi-Stage Inside Air Endothermic Hot-Gas Air-Heating Mode

In the heat pump cycle 10 in the multi-stage inside air endothermic hot-gas air-heating mode, the control device 60 brings the exterior-device-side expansion valve 14a into the fully closed state, brings the high-stage-side expansion valve 14c into the throttled state, brings the air-cooling expansion valve 14d into the throttled state, brings the cooling expansion valve 14e into the fully closed state, and brings the bypass-side flow rate regulation valve 14f into the throttled state.

The control device 60 opens the first high-pressure-side on/off valve 22a, opens the intermediate-pressure-side on/off valve 22c, closes the low-pressure-side on/off valve 22d, closes the second high-pressure-side on/off valve 22e, and closes the exterior-device on/off valve 22g.

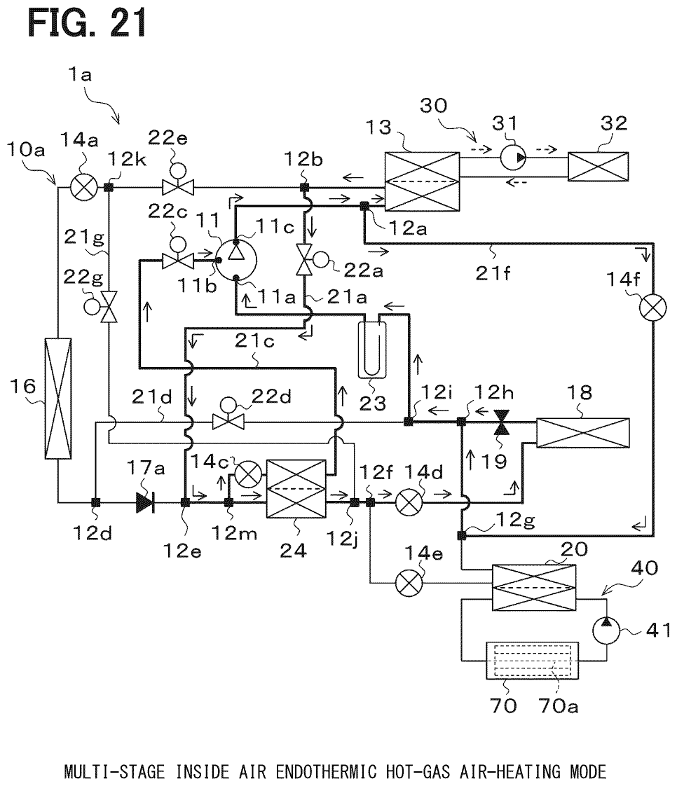

Therefore, in the heat pump cycle 10a in the multi-stage inside air endothermic hot-gas air-heating mode, as indicated by the thick solid lines and arrows in FIG. 21, the refrigerant discharged from the discharge port 11c of the compressor 11 flows through the water-refrigerant heat exchanger 13, the high-pressure-side passage 21a, and the thirteenth three-way joint 12m in this order. One of the refrigerant divided at the thirteenth three-way joint 12m flows through the high-stage-side expansion valve 14c, the low-temperature-side passage of the internal heat exchanger 24, the intermediate-pressure passage 21c, and the intermediate-pressure suction port 11b of the compressor 11 in this order. The other of the refrigerant divided at the thirteenth three-way joint 12m flows through the high-temperature-side passage of the internal heat exchanger 24, the air-cooling expansion valve 14d, the interior evaporator 18, the evaporating pressure regulation valve 19, the accumulator 23, and the low-pressure suction port 11a of the compressor 11 in this order. At the same time, the refrigerant discharged from the compressor 11 is switched to the refrigerant circuit through which the refrigerant circulates in the order of the bypass-side flow rate regulation valve 14f, the seventh three-way joint 12g, and the low-pressure suction port 11a of the compressor 11 arranged in the bypass passage 21f.

As in the multi-stage hot-gas air-heating mode, the control device 60 controls the operations of various components of the heat pump cycle 10a.

In the high-temperature-side heat medium circuit 30 in the multi-stage inside air endothermic hot-gas air-heating mode, as in the multi-stage hot-gas air-heating mode, the control device 60 controls the operations of various components of the high-temperature-side heat medium circuit 30.

In the low-temperature-side heat medium circuit 40 in the multi-stage inside air endothermic hot-gas air-heating mode, as in the multi-stage hot-gas air-heating mode, the control device 60 stops the low-temperature-side pump 41.

In the interior air conditioning unit 50 in the multi-stage inside air endothermic hot-gas air-heating mode, the control device 60 controls the operation of the inside/outside air switching device 53 so that inside air is introduced as ventilation air. As in the multi-stage hot-gas air-heating mode, the control device 60 controls the operations of various other components of the interior air conditioning unit 50. Furthermore, the control device 60 appropriately controls the operation of other devices to be controlled.

Therefore, the vehicular air conditioner 1a in the multi-stage inside air endothermic hot-gas air-heating mode achieves heating of the vehicle interior as in the multi-stage inside air endothermic hot-gas air-heating mode of the first embodiment.

(b-3-2) Multi-Stage Device Endothermic Hot-Gas Air-Heating Mode

In the heat pump cycle 10 in the multi-stage device endothermic hot-gas air-heating mode, the control device 60 brings the exterior-device-side expansion valve 14a into the fully closed state, brings the high-stage-side expansion valve 14c into the throttled state, brings the air-cooling expansion valve 14d into the fully closed state, brings the cooling expansion valve 14e into the throttled state, and brings the bypass-side flow rate regulation valve 14f into the throttled state.

The control device 60 opens the first high-pressure-side on/off valve 22a, opens the intermediate-pressure-side on/off valve 22c, closes the low-pressure-side on/off valve 22d, closes the second high-pressure-side on/off valve 22e, and closes the exterior-device on/off valve 22g.

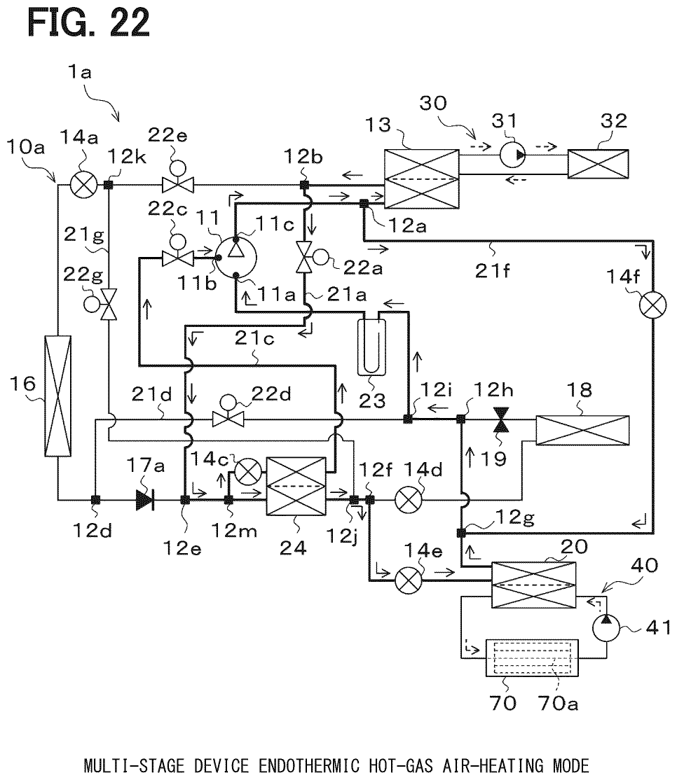

Therefore, in the heat pump cycle 10a in the multi-stage device endothermic hot-gas air-heating mode, as indicated by the thick solid lines and arrows in FIG. 22, the refrigerant circuit is switched to the refrigerant circuit through which the refrigerant flows in the same order as in the multi-stage hot-gas air-heating mode.

As in the multi-stage hot-gas air-heating mode, the control device 60 controls the operations of various components of the heat pump cycle 10.

In the high-temperature-side heat medium circuit 30 in the multi-stage device endothermic hot-gas air-heating mode, as in the multi-stage hot-gas air-heating mode, the control device 60 controls the operations of various components of the high-temperature-side heat medium circuit 30.

In the low-temperature-side heat medium circuit 40 in the multi-stage device endothermic hot-gas air-heating mode, as in the cooling and air-cooling mode, the control device 60 operates the low-temperature-side pump 41.

In the interior air conditioning unit 50 in the multi-stage device endothermic hot-gas air-heating mode, the control device 60 controls the operations of various components of the interior air conditioning unit 50 as in the multi-stage hot-gas air-heating mode. Furthermore, the control device 60 appropriately controls the operation of other devices to be controlled.

Therefore, the vehicular air conditioner 1a in the multi-stage device endothermic hot-gas air-heating mode achieves heating of the vehicle interior as in the multi-stage device endothermic hot-gas air-heating mode of the first embodiment.

(b-3-3) Multi-Stage Outside Air Endothermic Hot-Gas Air-Heating Mode

In the heat pump cycle 10a in the multi-stage outside air endothermic hot-gas air-heating mode, the control device 60 brings the exterior-device-side expansion valve 14a into the fully closed state, brings the high-stage-side expansion valve 14c into the throttled state, brings the air-cooling expansion valve 14d into the fully closed state, brings the cooling expansion valve 14e into the throttled state, and brings the bypass-side flow rate regulation valve 14f into the throttled state.

The control device 60 opens the first high-pressure-side on/off valve 22a, opens the intermediate-pressure-side on/off valve 22c, opens the low-pressure-side on/off valve 22d, closes the second high-pressure-side on/off valve 22e, and opens the exterior-device on/off valve 22g.

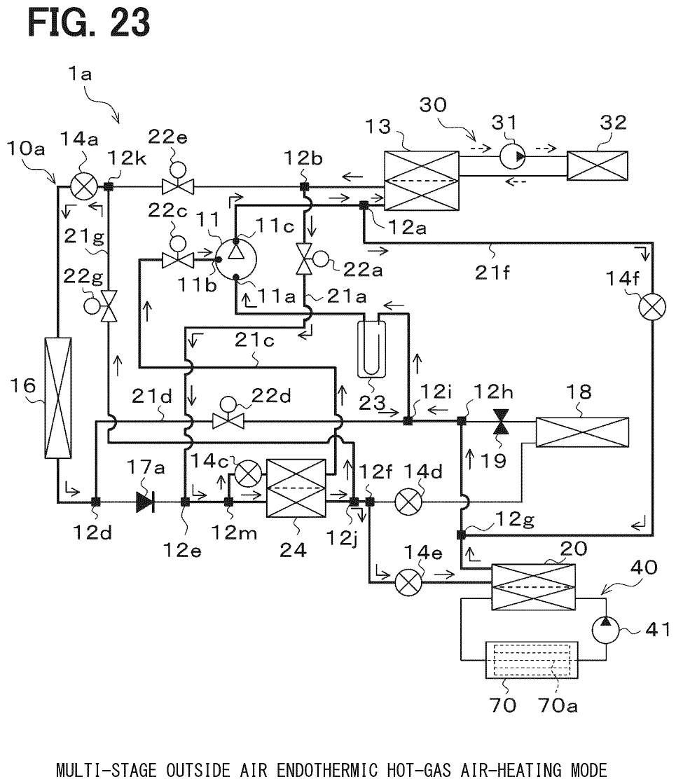

Therefore, in the heat pump cycle 10a in the multi-stage outside air endothermic hot-gas air-heating mode, as indicated by the thick solid lines and arrows in FIG. 23, the refrigerant discharged from the discharge port 11c of the compressor 11 flows as in the multi-stage hot-gas air-heating mode. At the same time, the other of the refrigerant divided at the tenth three-way joint 12j is switched to the refrigerant circuit in which the other of the refrigerant flows through the exterior-device passage 21g, the exterior-device-side expansion valve 14a, the exterior heat exchanger 16, the low-pressure-side passage 21d, the accumulator 23, and the low-pressure suction port 11a of the compressor 11 in this order.

The control device 60 also controls the throttle opening of the exterior-device-side expansion valve 14a so that the exterior-device-side refrigerant temperature T2 is lower than the outside air temperature Tam. As in the multi-stage hot-gas air-heating mode, the control device 60 controls the operations of various components of the other heat pump cycle 10a.

In the high-temperature-side heat medium circuit 30 in the multi-stage outside air endothermic hot-gas air-heating mode, as in the multi-stage hot-gas air-heating mode, the control device 60 controls the operations of various components of the high-temperature-side heat medium circuit 30.

In the low-temperature-side heat medium circuit 40 in the multi-stage outside air endothermic hot-gas air-heating mode, the control device 60 stops the low-temperature-side pump 41 as in the multi-stage hot-gas air-heating mode.

In the interior air conditioning unit 50 in the multi-stage outside air endothermic hot-gas air-heating mode, the control device 60 controls the operations of various components of the interior air conditioning unit 50 as in the multi-stage hot-gas air-heating mode. Furthermore, the control device 60 appropriately controls the operation of other devices to be controlled.

Accordingly, the vehicular air conditioner 1a in the multi-stage outside air endothermic hot-gas air-heating mode achieves heating of the vehicle interior as in the multi-stage outside air endothermic hot-gas air-heating mode of the first embodiment.

As described above, the vehicular air conditioner 1a of the present embodiment can perform comfortable air conditioning in the vehicle interior and appropriate temperature regulation of the battery 70, which is an in-vehicle device, by switching the operation mode. Furthermore, the same effects as those of the vehicular air conditioner 1 described in the first embodiment can be obtained.

More specifically, in the multi-stage hot-gas air-heating mode, the cycle can be operated suitably as in the first embodiment. In the multi-stage hot-gas air-heating mode, as in the single-stage hot-gas air-heating mode, the ventilation air can be stably heated by the heating portion using the heat generated by the compression work of the compressor 11 without using the heat absorbed from the outside air.

Moreover, in the multi-stage hot-gas heating mode, as in the first embodiment, the refrigerant heated by the internal heat exchanger 24 is drawn into the intermediate-pressure suction port 11b, so that the amount of compression work of the compressor 11 can be increased compared to the single-stage hot-gas air-heating mode. Therefore, sufficiently high heating capacity can be exerted in the heating portion without increasing the pressure of the low-pressure refrigerant.

The heat pump cycle 10a of the present embodiment includes the exterior-device-side expansion valve 14a, the exterior heat exchanger 16, and the exterior-device passage 21g. Therefore, in the vehicular air conditioner 1a of the present embodiment, the refrigerant circuit switching portion switches the refrigerant circuit of the heat pump cycle 10, so that the outside air endothermic air-heating mode can be executed. In the outside air endothermic air-heating mode, as in the first embodiment, COP can be improved to achieve efficient heating.

The heat pump cycle 10a of the present embodiment includes the exterior heat exchanger 16, the air-cooling expansion valve 14d, and the interior evaporator 18. Therefore, in the vehicular air conditioner 1a of the present embodiment, the refrigerant circuit switching portion switches the refrigerant circuit of the heat pump cycle 10, so that the air-cooling mode for cooling the ventilation air can be executed as in the first embodiment.

The heat pump cycle 10a of the present embodiment includes the exterior heat exchanger 16, the cooling expansion valve 14e, and the chiller 20. Therefore, in the vehicular air conditioner 1a of the present embodiment, the refrigerant circuit switching portion switches the refrigerant circuit of the heat pump cycle 10, so that the cooling and air-cooling mode for cooling the battery 70 can be executed as in the first embodiment.

The heat pump cycle 10 of the present embodiment includes the air-cooling expansion valve 14d and the interior evaporator 18. Therefore, in the vehicular air conditioner 1 of the present embodiment, the refrigerant circuit switching portion switches the refrigerant circuit of the heat pump cycle 10, so that the multi-stage inside air endothermic hot-gas air-heating mode can be executed.

The heat pump cycle 10 of the present embodiment includes the cooling expansion valve 14e and the chiller 20. Therefore, in the vehicular air conditioner 1 of the present embodiment, the refrigerant circuit switching portion switches the refrigerant circuit of the heat pump cycle 10, so that the multi-stage device endothermic hot-gas air-heating mode can be executed.

The heat pump cycle 10 of the present embodiment includes the exterior-device-side expansion valve 14a and the exterior heat exchanger 16. Therefore, in the vehicular air conditioner 1 of the present embodiment, the refrigerant circuit switching portion switches the refrigerant circuit of the heat pump cycle 10, so that the multi-stage outside air endothermic hot-gas air-heating mode can be executed.

### Fifth Embodiment

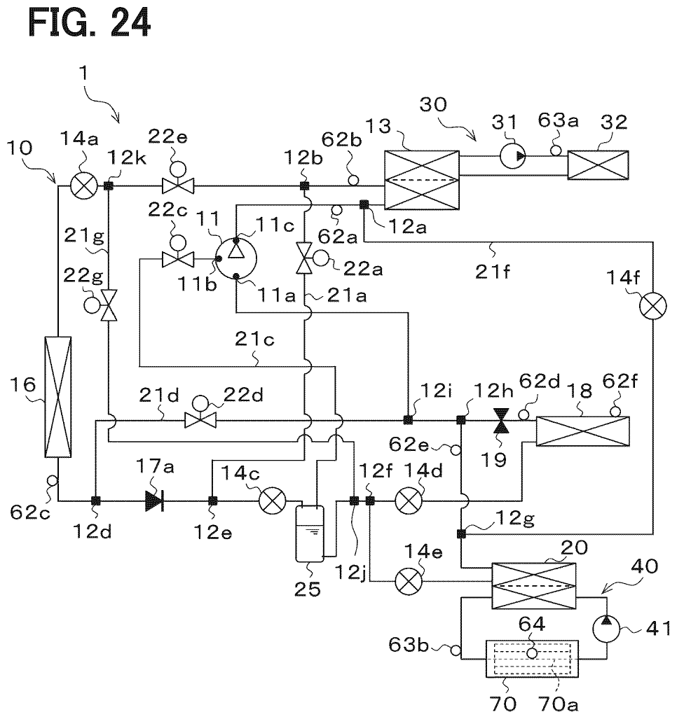

For the vehicular air conditioner 1 of the present embodiment, as illustrated in the overall configuration diagram of FIG. 24, an example in which the configuration of the heat pump cycle 10 is changed from that of the third embodiment will be described.

Specifically, in the heat pump cycle 10 of the present embodiment, the hot-gas gas-liquid separator 15b and the accumulator 23 are eliminated compared to the third embodiment. In addition, in the heat pump cycle 10 of the present embodiment, a receiver 25 is added to the heat pump cycle of the third embodiment.

The receiver 25 is a high-pressure-side liquid storage that separates the refrigerant flowing into the receiver into gas and liquid, and stores the separated liquid refrigerant as a surplus refrigerant of the cycle. The receiver 25 is disposed in the same manner as the hot-gas gas-liquid separator 15b.

Therefore, the outlet side of the high-stage-side expansion valve 14c is connected to the inlet of the receiver 25. The inlet side of the intermediate-pressure passage 21c is connected to the gas refrigerant outlet of the receiver 25. Furthermore, the inflow port side of the tenth three-way joint 12j is connected to the liquid refrigerant outlet of the receiver 25. Other configurations of the vehicular air conditioner 1 are similar to those of the first embodiment.

Next, the operation of the vehicular air conditioner 1 of the present embodiment having the above configuration will be described. The basic operation of the vehicular air conditioner 1 of the present embodiment is similar to that of the third embodiment.

(a-1) Single Air-Cooling Mode

In the single air-cooling mode, the control device 60 controls the throttle opening of the air-cooling expansion valve 14d such that a degree of superheating SHE of the outlet-side refrigerant of the interior evaporator 18 approaches a predetermined reference degree of superheating KSHE, compared to the single air-cooling mode of the third embodiment. The degree of superheating SHE can be determined from the evaporator-side refrigerant temperature Te and the evaporator-side refrigerant pressure Pe detected by the evaporator-side refrigerant temperature/pressure sensor 62d.

Other operations are similar to those of the third embodiment. Therefore, in the single air-cooling mode, cooling of the vehicle interior is achieved as in the third embodiment.

Moreover, in the single air-cooling mode of the present embodiment, the outlet-side refrigerant of the interior evaporator 18 is a gas refrigerant having a degree of superheating. With this configuration, the enthalpy difference obtained by subtracting the enthalpy of the inlet-side refrigerant from the enthalpy of the outlet-side refrigerant of the interior evaporator 18 is increased compared to the third embodiment, thereby improving the cooling capacity of the ventilation air exerted by the interior evaporator 18. In addition, the liquid compression of the compressor 11 can be suppressed.

(a-2) Cooling and Air-Cooling Mode

In the cooling and air-cooling mode, the control device 60 controls the throttle opening of the air-cooling expansion valve 14d such that the degree of superheating SHE of the outlet-side refrigerant of the interior evaporator 18 approaches the reference degree of superheating KSHE, compared to the cooling and air-cooling mode of the third embodiment.

Other operations are similar to those of the third embodiment. Therefore, in the cooling and air-cooling mode, cooling of the vehicle interior and cooling of the battery 70 are achieved as in the third embodiment.

Moreover, in the cooling and air-cooling mode of the present embodiment, as in the single air-cooling mode, the cooling capacity of the ventilation air exerted by the interior evaporator 18 can be improved compared to the third embodiment. In addition, the liquid compression of the compressor 11 can be suppressed.

(b-1) Outside Air Endothermic Air-Heating Mode

In the outside air endothermic air-heating mode, compared to the outside air endothermic air-heating mode according to the third embodiment, the control device 60 controls the throttle opening of the air-cooling expansion valve 14d such that a degree of superheating SH2 of the outlet-side refrigerant of the exterior heat exchanger 16 approaches a reference degree of superheating KSH2.

Other operations are similar to those of the third embodiment. Therefore, in the outside air endothermic air-heating mode, heating of the vehicle interior is achieved as in the third embodiment.

Moreover, in the outside air endothermic air-heating mode of the present embodiment, the outlet-side refrigerant of the exterior heat exchanger 16 is a gas refrigerant having a degree of superheating. With this configuration, the endothermic amount of the refrigerant in the exterior heat exchanger 16 can be increased compared to the first embodiment, and the heating capacity of the ventilation air can be improved. In addition, the liquid compression of the compressor 11 can be suppressed.

(b-2) Single-Stage Hot-Gas Air-Heating Mode

In the single-stage hot-gas air-heating mode, the control device 60 controls the throttle opening of the cooling expansion valve 14e such that a degree of superheating SHC of the refrigerant flowing out of the seventh three-way joint 12g approaches a reference degree of superheating KSHC, compared to the single-stage hot-gas air-heating mode of the third embodiment. The degree of superheating SHC can be determined from the chiller-side refrigerant temperature Tc and the chiller-side refrigerant pressure Pc detected by the chiller-side refrigerant temperature/pressure sensor 62e.

Other operations are similar to those of the third embodiment. Therefore, in the single-stage hot-gas air-heating mode, heating of the vehicle interior is achieved as in the third embodiment.

Moreover, in the single-stage hot-gas air-heating mode of the present embodiment, the refrigerant flowing out of the seventh three-way joint 12g is a gas refrigerant having a degree of superheating. Therefore, the liquid compression of the compressor 11 can be suppressed, and the cycle can be operated suitably.

(b-3) Multi-Stage Hot-Gas Air-Heating Mode

In the multi-stage hot-gas air-heating mode, the control device 60 controls the throttle opening of the cooling expansion valve 14e such that the degree of superheating SHC of the refrigerant flowing out of the seventh three-way joint 12g approaches the reference degree of superheating KSHC, compared to the multi-stage hot-gas air-heating mode of the third embodiment.

Other operations are similar to those of the third embodiment. Therefore, in the multi-stage hot-gas air-heating mode, heating of the vehicle interior is achieved as in the third embodiment.

Moreover, in the multi-stage hot-gas air-heating mode of the present embodiment, the refrigerant flowing out of the seventh three-way joint 12g is a gas refrigerant having a degree of superheating. Therefore, the liquid compression of the compressor 11 can be suppressed, and the cycle can be operated suitably.

(b-3-1) Multi-Stage Inside Air Endothermic Hot-Gas Air-Heating Mode

In the multi-stage inside air endothermic hot-gas air-heating mode, the control device 60 controls the throttle opening of the air-cooling expansion valve 14d such that the degree of superheating SHC of the refrigerant flowing out of the eighth three-way joint 12h approaches the reference degree of superheating KSHC, compared to the multi-stage inside air endothermic hot-gas air-heating mode of the third embodiment.

Other operations are similar to those of the third embodiment. Therefore, in the multi-stage inside air endothermic hot-gas air-heating mode, heating of the vehicle interior is achieved as in the third embodiment.

Moreover, in the multi-stage inside air endothermic hot-gas air-heating mode of the present embodiment, the refrigerant flowing out of the eighth three-way joint 12h is a gas refrigerant having a degree of superheating. Therefore, the liquid compression of the compressor 11 can be suppressed, and the cycle can be operated suitably.

(b-3-2) Multi-Stage Device Endothermic Hot-Gas Air-Heating Mode

In the multi-stage device endothermic hot-gas air-heating mode, the control device 60 controls the throttle opening of the cooling expansion valve 14e such that the degree of superheating SHC of the refrigerant flowing out of the seventh three-way joint 12g approaches the reference degree of superheating KSHC, compared to the multi-stage device endothermic hot-gas air-heating mode of the third embodiment.

Other operations are similar to those of the third embodiment. Therefore, in the multi-stage device endothermic hot-gas air-heating mode, heating of the vehicle interior is achieved as in the third embodiment.

Moreover, in the multi-stage device endothermic hot-gas air-heating mode of the present embodiment, the refrigerant flowing out of the seventh three-way joint 12g is a gas refrigerant having a degree of superheating. Therefore, the liquid compression of the compressor 11 can be suppressed, and the cycle can be operated suitably.

(b-3-3) Multi-Stage Outside Air Endothermic Hot-Gas Air-Heating Mode

In the multi-stage outside air endothermic hot-gas air-heating mode, compared to the multi-stage outside air endothermic hot-gas air-heating mode of the third embodiment, the control device 60 controls the throttle opening of the cooling expansion valve 14e such that the degree of superheating SHC of the refrigerant flowing out of the seventh three-way joint 12g approaches the reference degree of superheating KSHC.

Other operations are similar to those of the third embodiment. Therefore, in the multi-stage outside air endothermic hot-gas air-heating mode, heating of the vehicle interior is achieved as in the third embodiment.

Moreover, in the multi-stage outside air endothermic hot-gas air-heating mode of the present embodiment, the refrigerant flowing out of the seventh three-way joint 12g is a gas refrigerant having a degree of superheating. Therefore, the liquid compression of the compressor 11 can be suppressed, and the cycle can be operated suitably.

As described above, the vehicular air conditioner 1 of the present embodiment can perform comfortable air conditioning in the vehicle interior and appropriate temperature regulation of the battery 70, which is an in-vehicle device, by switching the operation mode. Furthermore, the same effects as those of the vehicular air conditioner 1 of the first embodiment can be obtained. Therefore, in the multi-stage hot-gas air-heating mode, sufficiently high heating capacity can be exerted in the heating portion without increasing the pressure of the low-pressure refrigerant.

The present disclosure is not limited to the embodiments described above but can be variously modified as follows without departing from the gist of the present disclosure.

In the embodiments described above, an example in which the heat pump cycle device according to the present disclosure is applied to the vehicular air conditioner has been described, but the application target of the heat pump cycle device is not limited to the vehicular air conditioner. For example, the present invention may be applied to an air conditioner that performs only air conditioning of a space to be air conditioned without regulating the temperature of a heat-generating device. For example, the present invention may be applied to a water heater that heats domestic water or the like as an object to be heated.

Furthermore, in the embodiments described above, an example of regulating the temperature of the battery 70 has been described as the in-vehicle device to be the temperature regulation target, but the in-vehicle device is not limited to the battery 70. For example, the temperature of an inverter, a power control unit (PCU), a transaxle, a control device for advanced driver-assistance systems (ADAS), or the like may be regulated. Furthermore, the temperatures of a plurality of in-vehicle devices may be regulated.

The inverter supplies power to a motor generator and the like. The PCU is a power control unit that performs transformation and power distribution. The transaxle is a power transmission mechanism in which a transmission, a differential gear, and the like are integrated. The control device for ADAS is a control device for advanced driver-assistance systems.

The configuration of the heat pump cycle device according to the present disclosure is not limited to the configuration disclosed in the embodiments described above.

In the embodiments described above, an example has been described in which the heating portion is formed by each of the components, the water-refrigerant heat exchanger 13 and the high-temperature-side heat medium circuit 30, but the present invention is not limited thereto.

For example, an interior condenser may be employed as the heating portion. The interior condenser is a heating heat exchange portion that exchanges heat between one of discharge refrigerant divided at the first three-way joint 12a and the ventilation air passing through the interior evaporator 18 to heat the ventilation air. The interior condenser may be disposed in the air passage of the interior air conditioning unit 50 in the same manner as the heater core 32.

In the embodiments described above, an example in which the sixth three-way joint 12f as a mixing portion is disposed on the refrigerant-flow downstream side of the chiller 20 has been described, but the present invention is not limited thereto.

For example, the sixth three-way joint 12f may be disposed on the downstream side of the cooling expansion valve 14e and on the refrigerant-flow upstream side of the chiller 20. With this configuration, the refrigerant flowing out of the cooling expansion valve 14e and the refrigerant flowing out of the bypass-side flow rate regulation valve 14f can be homogeneously mixed when flowing through the refrigerant passage of the chiller 20. In the first to fourth embodiments, the seventh three-way joint 12g may be eliminated, and the end of the bypass passage 21f may be directly connected to the accumulator 23.

In the embodiments described above, an example in which the centrifugation-type gas-liquid separation portion is employed as the air-heating gas-liquid separator 15a and the hot-gas gas-liquid separator 15b has been described, but the invention is not limited thereto. For example, an impingement-type gas-liquid separation portion may be employed. The impingement-type gas-liquid separation portion has an impingement portion that causes the refrigerant to impinge, and drops the liquid refrigerant having high density from the refrigerant that has impinged on the impingement portion and decreased in speed to perform gas-liquid separation.

In the embodiments described above, an example in which a variable throttle mechanism configured by a mechanical mechanism is employed as the evaporating pressure regulation valve 19 has been described. However, an electric variable throttle mechanism similar to the bypass-side flow rate regulation valve 14f and the like may be employed as the evaporating pressure regulation valve 19. When frosting does not occur on the interior evaporator 18, the evaporating pressure regulation valve 19 may be eliminated.

In the embodiments described above, the interior evaporator 18 and the chiller 20 are employed as the evaporator, but the present invention is not limited to this. As the evaporator, a ventilation heat recovery heat exchanger that exchanges heat between the inside air flowing out of the room and the refrigerant decompressed by the decompression portion to evaporate the refrigerant may be employed. Moreover, a decompression portion that decompresses the refrigerant flowing into the ventilation heat recovery heat exchanger may be provided. Accordingly, the refrigerant circuit switching portion allows the refrigerant to flow into the ventilation heat recovery heat exchanger, so that an operation equivalent to that in the multi-stage inside air endothermic hot-gas air-heating mode can be performed.

In addition, a plurality of cycle component devices may be integrated within a range in which the effects described above can be obtained. For example, a joint portion with a four-way joint structure in which the eighth three-way joint 12h and the ninth three-way joint 12i are integrated may be employed.

In the fourth embodiment described above, an example in which the intermediate-pressure-side on/off valve 22c is disposed as the intermediate-pressure-side opening/closing portion has been described, but the present invention is not limited thereto. The intermediate-pressure passage 21c may be closed by the full-close function of the high-stage-side expansion valve 14c. That is, the high-stage-side expansion valve 14c may also function as an intermediate-pressure-side opening/closing portion.

In the embodiments described above, an example in which R1234yf is employed as each of the refrigerant of the heat pump cycle 10 or 10a has been described, but the present invention is not limited thereto. For example, R134a, R600a, R410A, R404A, R32, R407C, or the like may be employed. Alternatively, a mixed refrigerant obtained by mixing a plurality of types of these refrigerants or the like may be employed. Furthermore, carbon dioxide may be employed as the refrigerant to form a supercritical refrigeration cycle in which the high-pressure-side refrigerant pressure is equal to or higher than the critical pressure of the refrigerant.

In the embodiments described above, an example in which PAG oil (i.e., polyalkylene glycol oil) is employed as the refrigerating machine oil has been described, but the present invention is not limited thereto. For example, POE (i.e., polyol ester) or the like may be employed.

In the embodiments described above, an example in which an ethylene glycol aqueous solution is employed as the heat medium, the low-temperature-side heat medium, and the high-temperature-side heat medium has been described, but the present invention is not limited thereto. For example, dimethylpolysiloxane, a solution containing a nanofluid or the like, an antifreeze liquid, an aqueous liquid refrigerant containing alcohol or the like, or a liquid medium containing oil or the like may be employed.

Furthermore, the control sensor group connected to the input side of the control device 60 is not limited to the detection portion disclosed in the embodiments described above. Various detection parts may be added as necessary.

The control mode of the heat pump cycle device according to the present disclosure is not limited to the control mode disclosed in the embodiments described above.

In the embodiments described above, the vehicular air conditioners 1, 1a capable of executing various operation modes have been described. However, the heat pump cycle device according to the present disclosure does not need to be capable of executing all the operation modes described above. If at least the multi-stage hot-gas air-heating mode can be executed, sufficiently high heating capacity can be exerted in the heating portion without increasing the pressure of the low-pressure refrigerant.

Moreover, the vehicular air conditioners 1, 1a may be capable of executing other operation modes.

For example, a dehumidifying and air-heating mode for dehumidifying and heating the vehicle interior may be executable. For example, it may be possible to execute a device cooling mode for exclusively cooling the battery 70 without performing air conditioning in the vehicle interior. In the device cooling mode, as in the cooling and air-cooling mode described above, the refrigerant circuit of the heat pump cycle 10 or 10a is switched to bring the air-cooling expansion valve 14d into the fully closed state. Furthermore, the control device 60 may stop the interior blower 52.

For example, it may be possible to execute a dehumidifying and air-heating mode in which the ventilation air cooled and dehumidified by the interior evaporator 18 is reheated by the heater core 32 and blown into the vehicle interior. In the dehumidifying and air-heating mode, the high-temperature-side heat medium flowing into the heater core 32 may use heat absorbed by the refrigerant from the outside air in the exterior heat exchanger 16.

The dehumidifying and air-heating mode may be a series dehumidifying and air-heating mode in which the flow of the refrigerant flowing out of the water-refrigerant heat exchanger 13 serving as the heating portion is switched to a refrigerant circuit that connects the exterior heat exchanger 16 and the interior evaporator 18 in series. The dehumidifying and air-heating mode may be a parallel dehumidifying and air-heating mode in which the flow of the refrigerant flowing out of the water-refrigerant heat exchanger 13 serving as the heating portion is switched to a refrigerant circuit that connects the exterior heat exchanger 16 and the interior evaporator 18 in parallel.

In addition, for example, as the multi-stage endothermic hot-gas air-heating mode, a composite multi-stage endothermic hot-gas air-heating mode for causing the refrigerant to absorb heat of the inside air and simultaneously absorb waste heat of the battery 70 may be executed. In the composite multi-stage endothermic hot-gas air-heating mode, both the air-cooling expansion valve 14d and the cooling expansion valve 14e may be brought into the throttled state.

The items and features of the heat pump cycle device described in the present disclosure are shown as follows.

### (Item 1)

A heat pump cycle device includes: a compressor (11) configured to compress low-pressure refrigerant drawn from a low-pressure suction port (11a), to discharge compression refrigerant from a discharge port (11c), and to merge intermediate-pressure refrigerant drawn from an intermediate-pressure suction port (11b) with the low-pressure refrigerant in a process of compression; an upstream branch (12a) configured to divide a flow of high-pressure refrigerant discharged from the discharge port of the compressor; a heating portion (13, 30) configured to heat an object to be heated using one of the high-pressure refrigerant divided at the upstream branch as a heat source; a high-stage-side decompression portion (14c) configured to decompress the refrigerant flowing out of the heating portion; a hot-gas gas-liquid separation portion (15b) configured to separate the refrigerant, flowing out of the high-stage-side decompression portion, into gas refrigerant and liquid refrigerant; a low-stage-side decompression portion (14d, 14e) configured to depressurize the liquid refrigerant separated by the hot-gas gas-liquid separation portion; a bypass passage (21f) that guides an another one of the high-pressure refrigerant divided at the upstream branch toward the low-pressure suction port; a bypass-side flow rate regulation portion (14f) configured to regulate a flow rate of the refrigerant flowing through the bypass passage; and a joint (12g, 12h) that merges a flow of the refrigerant flowing out of the bypass-side flow rate regulation portion and a flow of the refrigerant flowing out of the low-stage-side decompression portion. In addition, during a multi-stage hot-gas heating mode in which the heating object is heated by the heating portion, gas refrigerant separated by the hot-gas gas-liquid separation portion is led toward the intermediate-pressure suction port of the compressor, and the refrigerant flowing out of the joint is led toward the low-pressure suction port of the compressor.

### (Item 2)

A heat pump cycle device includes: a compressor (11) configured to compress low-pressure refrigerant drawn from a low-pressure suction port (11a), to discharge compression refrigerant from a discharge port (11c), and to merge intermediate-pressure refrigerant drawn from an intermediate-pressure suction port (11b) with the low-pressure refrigerant in a process of compression; an upstream branch (12a) configured to divide a flow of high-pressure refrigerant discharged from the discharge port; a heating portion (13, 30) configured to heat an object to be heated using one of the high-pressure refrigerant divided at the upstream branch as a heat source; a downstream branch (12m) configured to divide a flow of the refrigerant flowing out of the heating portion; a high-stage-side decompression portion (14c) configured to decompress one of the refrigerant divided at the downstream branch; an internal heat exchanger (24) that exchanges heat between the refrigerant flowing out of the high-stage-side decompression portion and an another one of the refrigerant divided at the downstream branch; a low-stage-side decompression portion (14d, 14e) configured to decompress the another one of the refrigerant divided at the downstream branch and flowing out of the internal heat exchanger; a bypass passage (21f) that guides an another one of the high-pressure refrigerant divided at the upstream branch toward the low-pressure suction port of the compressor; a bypass-side flow rate regulation portion (14f) configured to regulate a flow rate of the refrigerant flowing through the bypass passage; and a joint (12g, 12h) that merges a flow of the refrigerant flowing out of the bypass-side flow rate regulation portion and a flow of the refrigerant flowing out of the low-stage-side decompression portion. In addition, during a multi-stage hot-gas heating mode in which the object to be heated is heated by the heating portion, the refrigerant heated by the internal heat exchanger is guided toward the intermediate-pressure suction port of the compressor, and the refrigerant flowing out of the joint is guided to the low-pressure suction port of the compressor.

### (Item 3)

The heat pump cycle device according to Item 1 or 2, further includes a refrigerant circuit switching portion (22a, . . . 22e, 22g) configured to switch between refrigerant circuits in which the refrigerant circulates. In this case, the refrigerant circuit switching portion includes an intermediate-pressure-side opening/closing portion (22c) that opens and closes an intermediate-pressure passage (21c) through which the refrigerant flows toward the intermediate-pressure suction port of the compressor, and the intermediate-pressure-side opening/closing portion closes the intermediate-pressure passage during a single-stage hot-gas heating mode in which the object to be heated is heated using the heating portion.

### (Item 4)

The heat pump cycle device according to Item 3, further includes: a target temperature determination portion (60e) configured to determine a target temperature (TAO) of the object to be heated; and a heating-object temperature detection portion (65) configured to detect an object temperature (TAV) of the object to be heated. In this case, the intermediate-pressure-side opening/closing portion opens the intermediate-pressure passage when the object temperature (TAV) is lower than the target temperature (TAO).

### (Item 5)

The heat pump cycle device according to Item 1, further includes: an exterior-device high-stage-side decompression portion (14a) configured to decompress the refrigerant; a heating gas-liquid separation portion (15a) that separates the refrigerant, decompressed by the exterior-device high-stage-side decompression portion, into gas refrigerant and liquid refrigerant; an exterior-device low-stage-side decompression portion (14b) configured to decompress the liquid refrigerant separated by the heating gas-liquid separation portion; an exterior heat exchanger (16) that exchanges heat between the refrigerant and outside air; and a refrigerant circuit switching portion (22a, . . . 22d) configured to switch between refrigerant circuits in which the refrigerant circulates. In this case, during an outside air endothermic heating mode in which the object is heated using the heating portion, the refrigerant circuit switching portion switches a refrigerant circuit in which the refrigerant flowing out of the heating portion is guided to the exterior-device high-stage-side decompression portion, the gas refrigerant separated by the heating gas-liquid separation portion is guided toward the intermediate-pressure suction port, the refrigerant decompressed by the exterior-device low-stage-side decompression portion is guided to a refrigerant inlet side of the exterior heat exchanger, and the refrigerant flowing out of the exterior heat exchanger is guided toward the low-pressure suction port of the compressor.

### (Item 6)

The heat pump cycle device according to Item 1, further includes: an exterior-device-side decompression portion (14a) configured to decompress the refrigerant; an exterior heat exchanger (16) that exchanges heat between the refrigerant and outside air; an exterior-device passage (21g) that guides the liquid refrigerant separated by the hot-gas gas-liquid separation portion to an inlet side of the exterior-device-side decompression portion; and a refrigerant circuit switching portion (22a, . . . 22g) configured to switch between refrigerant circuits in which the refrigerant circulates. In this case, during an outside air endothermic heating mode in which the object is heated using the heating portion, the refrigerant circuit switching portion switches a refrigerant circuit in which the gas refrigerant separated by the hot-gas gas-liquid separation portion is guided toward the intermediate-pressure suction port, the liquid refrigerant separated by the hot-gas gas-liquid separation portion is guided to an inlet side of the exterior-device-side decompression portion via the exterior-device passage, the refrigerant decompressed by the exterior-device-side decompression portion is guided to a refrigerant inlet side of the exterior heat exchanger, and the refrigerant flowing out of the exterior heat exchanger is guided toward the low-pressure suction port of the compressor.

### (Item 7)

The heat pump cycle device according to Item 2, further includes: an exterior-device-side decompression portion (14a) configured to decompress the refrigerant; an exterior heat exchanger (16) that exchanges heat between the refrigerant and outside air; an exterior-device passage (21g) that guides the refrigerant cooled by the internal heat exchanger to an inlet side of the exterior-device-side decompression portion; and a refrigerant circuit switching portion (22a, . . . 22g) configured to switch between refrigerant circuits through which the refrigerant circulates. In this case, during an outside air endothermic heating mode in which the object is heated using the heating portion, the refrigerant circuit switching portion switches a refrigerant circuit in which the refrigerant heated by the internal heat exchanger is guided toward the intermediate-pressure suction port of the compressor, the refrigerant cooled by the internal heat exchanger is guided to an inlet side of the exterior-device-side decompression portion via the exterior-device passage, and the refrigerant flowing out of the exterior heat exchanger is guided toward the low-pressure suction port of the compressor.

### (Item 8)

The heat pump cycle device according to Item 1 or 5, further includes: an exterior heat exchanger (16) that exchanges heat between the refrigerant and outside air; an evaporator (18, 20) that evaporates the refrigerant decompressed by the low-stage-side decompression portion; and a refrigerant circuit switching portion (22a, . . . 22g) that switches between refrigerant circuits through which the refrigerant circulates. In this case, during a cooling mode for cooling an object to be cooled, the refrigerant circuit switching portion switches a refrigerant circuit in which the refrigerant flowing out of the heating portion is guided to a refrigerant inlet side of the exterior heat exchanger, the refrigerant flowing out of the exterior heat exchanger is guided to an inlet side of the high-stage-side decompression portion, the gas refrigerant separated by the hot-gas gas-liquid separation portion is guided toward the intermediate-pressure suction port, the refrigerant decompressed by the low-stage-side decompression portion is guided to the refrigerant inlet side of the evaporator, and the refrigerant flowing out of the evaporator is guided toward the low-pressure suction port of the compressor.

### (Item 9)

The heat pump cycle device according to any one of Items 1, 5, 8, further includes: an evaporator (18, 20) that evaporates the refrigerant decompressed by the low-stage-side decompression portion; and a refrigerant circuit switching portion (22a, . . . 22g) that switches between refrigerant circuits through which the refrigerant circulates. In this case, during a multi-stage endothermic hot-gas heating mode for heating the object to be heated using the heating portion, the refrigerant circuit switching portion switches a refrigerant circuit in which the gas refrigerant separated by the hot-gas gas-liquid separation portion is guided toward the intermediate-pressure suction port, the liquid refrigerant separated by the hot-gas gas-liquid separation portion is decompressed by the low-stage-side decompression portion, and the refrigerant flowing out of the joint is guided toward the low-pressure suction port of the compressor.

### (Item 10)

The heat pump cycle device according to Item 2, further includes: an exterior heat exchanger (16) that exchanges heat between the refrigerant and outside air; an evaporator (18, 20) that evaporates the refrigerant decompressed by the low-stage-side decompression portion; and a refrigerant circuit switching portion that switches between refrigerant circuits through which the refrigerant circulates. In this case, during a cooling mode for cooling an object to be cooled, the refrigerant circuit switching portion switches a refrigerant circuit in which the refrigerant flowing out of the heating portion is guided to a refrigerant inlet side of the exterior heat exchanger, the refrigerant flowing out of the exterior heat exchanger is guided to an inflow port of the downstream branch, the refrigerant heated by the internal heat exchanger is guided toward the intermediate-pressure suction port, the refrigerant decompressed by the low-stage-side decompression portion is guided to a refrigerant inlet side of the evaporator, and the refrigerant flowing out of the evaporator is guided toward the low-pressure suction port of the compressor.

### (Item 11)

The heat pump cycle device according to Item 2 or 10, further includes: an evaporator (18, 20) that evaporates the refrigerant decompressed by the low-stage-side decompression portion; and a refrigerant circuit switching portion (22a, . . . 22g) that switches between refrigerant circuits through which the refrigerant circulates. In this case, during a multi-stage endothermic hot-gas heating mode for heating the object to be heated using the heating portion, the refrigerant circuit switching portion switches a refrigerant circuit in which the refrigerant heated by the internal heat exchanger is guided toward the intermediate-pressure suction port, the refrigerant cooled by the internal heat exchanger is decompressed by the low-stage-side decompression portion, and the refrigerant flowing out of the joint is guided toward the low-pressure suction port.

### (Item 12)

The heat pump cycle device according to any one of Items 1, 5, 6, 8, 9, further includes: a high-stage-side decompression control portion (60d) configured to control an operation of the high-stage-side decompression portion; a target temperature determination portion (60e) configured to determine a target temperature (TAO) of the object to be heated; and an heating-object temperature detector (65) configured to detect an object temperature (TAV) of the object to be heated. In this case, the high-stage-side decompression control portion increases a throttle opening of the high-stage-side decompression portion during the multi-stage hot-gas heating mode and when the object temperature (TAV) is lower than the target temperature (TAO).

### (Item 13)

The heat pump cycle device according to any one of Items 1, 5, 6, 8, 9, further includes: an exterior heat exchanger (16) that exchanges heat between the refrigerant and outside air; an exterior-device decompression portion (14a, 14b) configured to decompress the refrigerant flowing out of the heating portion and to flow toward an inlet side of the exterior heat exchanger (16); and a refrigerant circuit switching portion (22a, . . . 22d) configured to switch between refrigerant circuits in which the refrigerant circulates. In this case, during a multi-stage outside air endothermic hot-gas heating mode in which the object is heated using the heating portion, the gas refrigerant separated by the hot-gas gas-liquid separation portion is guided toward the intermediate-pressure suction port, and the refrigerant flowing out of the joint and the refrigerant flowing out of the exterior heat exchanger are guided toward the low-pressure suction port of the compressor.

### (Item 14)

The heat pump cycle device according to any one of Items 2, 10, 11 further includes: an exterior heat exchanger (16) that exchanges heat between the refrigerant and outside air; an exterior-device decompression portion (14a) configured to decompress the refrigerant flowing out of the heating portion and to flow toward an inlet side of the exterior heat exchanger (16); and a refrigerant circuit switching portion (22a, . . . 22d) configured to switch between refrigerant circuits in which the refrigerant circulates. In this case, during a multi-stage outside air endothermic hot-gas heating mode in which the object is heated using the heating portion, the refrigerant heated by the internal heat exchanger is guided toward the intermediate-pressure suction port, and the refrigerant flowing out of the joint and the refrigerant flowing out of the exterior heat exchanger are guided toward the low-pressure suction port of the compressor.

Although the present disclosure has been described in accordance with the embodiments, it is understood that the present disclosure is not limited to the embodiments and structures. The present disclosure encompasses various modifications and modified examples within an equivalent scope. In addition, various combinations and forms, as well as other combinations and forms including only one element, more than that, or smaller than that, are also within the scope and idea of the present disclosure.

What is claimed is:

1. A heat pump cycle device comprising:
a compressor configured to compress low-pressure refrigerant drawn from a low-pressure suction port, to discharge compression refrigerant from a discharge port, and to merge intermediate-pressure refrigerant drawn from an intermediate-pressure suction port with the low-pressure refrigerant in a process of compression;
an upstream branch configured to divide a flow of high-pressure refrigerant discharged from the discharge port of the compressor;
a heater configured to heat an object to be heated using one of the high-pressure refrigerant divided at the upstream branch as a heat source;
a first decompression valve configured to decompress the refrigerant flowing out of the heater;
a hot-gas gas-liquid separator configured to separate the refrigerant, flowing out of the first decompression valve, into gas refrigerant and liquid refrigerant;
a second decompression valve configured to depressurize the liquid refrigerant separated by the hot-gas gas-liquid separator;
a bypass passage that guides an another one of the high-pressure refrigerant divided at the upstream branch toward the low-pressure suction port of the compressor;
a bypass-side flow rate valve configured to regulate a flow rate of the refrigerant flowing through the bypass passage;
a joint that merges a flow of the refrigerant flowing out of the bypass-side flow rate valve and a flow of the refrigerant flowing out of the second decompression valve;
a third decompression valve configured to decompress the refrigerant flowing out of the heater;
a heating gas-liquid separator that separates the refrigerant, decompressed by the third decompression valve, into gas refrigerant and liquid refrigerant;
a fourth decompression valve configured to decompress the liquid refrigerant separated by the heating gas-liquid separator;
an exterior heat exchanger that exchanges heat between the refrigerant and outside air; and
a refrigerant circuit switching portion configured to switch between refrigerant circuits in which the refrigerant circulates, wherein
during an outside air endothermic heating mode in which the object is heated using the heater, the refrigerant circuit switching portion switches a refrigerant circuit in which the refrigerant flowing out of the heater is guided to the third decompression valve, the gas refrigerant separated by the heating gas-liquid separator is guided toward the intermediate-pressure suction port, the refrigerant decompressed by the fourth decompression valve is guided to a refrigerant inlet side of the exterior heat exchanger, and the refrigerant flowing out of the exterior heat exchanger is guided toward the low-pressure suction port of the compressor.

2. The heat pump cycle device according to claim 1, further comprising:
an evaporator that evaporates the refrigerant decompressed by the second decompression valve, wherein
during a cooling mode for cooling an object to be cooled, the refrigerant circuit switching portion switches a refrigerant circuit in which the refrigerant flowing out of the heater is guided to a refrigerant inlet side of the exterior heat exchanger, the refrigerant flowing out of the exterior heat exchanger is guided to an inlet side of the first decompression valve, the gas refrigerant separated by the hot-gas gas-liquid separator is guided toward the intermediate-pressure suction port, the refrigerant decompressed by the second decompression valve is guided to the refrigerant inlet side of the evaporator, and the refrigerant flowing out of the evaporator is guided toward the low-pressure suction port of the compressor.

3. A heat pump cycle device comprising:
a compressor configured to compress low-pressure refrigerant drawn from a low-pressure suction port, to discharge compression refrigerant from a discharge port, and to merge intermediate-pressure refrigerant drawn from an intermediate-pressure suction port with the low-pressure refrigerant in a process of compression;
an upstream branch configured to divide a flow of high-pressure refrigerant discharged from the discharge port of the compressor;
a heater configured to heat an object to be heated using one of the high-pressure refrigerant divided at the upstream branch as a heat source;
a first decompression valve configured to decompress the refrigerant flowing out of the heater;
a hot-gas gas-liquid separator configured to separate the refrigerant, flowing out of the first decompression valve, into gas refrigerant and liquid refrigerant;
a second decompression valve configured to depressurize the liquid refrigerant separated by the hot-gas gas-liquid separator;
a bypass passage that guides an another one of the high-pressure refrigerant divided at the upstream branch toward the low-pressure suction port;
a bypass-side flow rate valve configured to regulate a flow rate of the refrigerant flowing through the bypass passage;
a joint that merges a flow of the refrigerant flowing out of the bypass-side flow rate valve and a flow of the refrigerant flowing out of the second decompression valve;
an exterior heat exchanger that exchanges heat between the refrigerant and outside air;
an evaporator that evaporates the refrigerant decompressed by the second decompression valve; and
a refrigerant circuit switching portion that switches between refrigerant circuits through which the refrigerant circulates, wherein
during a cooling mode for cooling an object to be cooled, the refrigerant circuit switching portion switches a refrigerant circuit in which the refrigerant flowing out of the heater is guided to a refrigerant inlet side of the exterior heat exchanger, the refrigerant flowing out of the exterior heat exchanger is guided to an inlet side of the first decompression valve, the gas refrigerant separated by the hot-gas gas-liquid separator is guided toward the intermediate-pressure suction port, the refrigerant decompressed by the second decompression valve is guided to the refrigerant inlet side of the evaporator, and the refrigerant flowing out of the evaporator is guided toward the low-pressure suction port of the compressor.

4. A heat pump cycle device comprising:
a compressor configured to compress low-pressure refrigerant drawn from a low-pressure suction port, to discharge compression refrigerant from a discharge port, and to merge intermediate-pressure refrigerant drawn from an intermediate-pressure suction port with the low-pressure refrigerant in a process of compression;
an upstream branch configured to divide a flow of high-pressure refrigerant discharged from the discharge port of the compressor;
a heater configured to heat an object to be heated using one of the high-pressure refrigerant divided at the upstream branch as a heat source;
a first decompression valve configured to decompress the refrigerant flowing out of the heater;
a hot-gas gas-liquid separator configured to separate the refrigerant, flowing out of the first decompression valve, into gas refrigerant and liquid refrigerant;
a second decompression valve configured to depressurize the liquid refrigerant separated by the hot-gas gas-liquid separator;
a bypass passage that guides an another one of the high-pressure refrigerant divided at the upstream branch toward the low-pressure suction port;
a bypass-side flow rate valve configured to regulate a flow rate of the refrigerant flowing through the bypass passage;
a joint that merges a flow of the refrigerant flowing out of the bypass-side flow rate valve and a flow of the refrigerant flowing out of the second decompression valve;
an evaporator that evaporates the refrigerant decompressed by the second decompression valve to cool the object to be cooled; and
a refrigerant circuit switching portion that switches between refrigerant circuits through which the refrigerant circulates, wherein
during a multi-stage endothermic hot-gas heating mode for heating the object to be heated using the heater, the refrigerant circuit switching portion switches a refrigerant circuit in which the gas refrigerant separated by the hot-gas gas-liquid separator is guided toward the intermediate-pressure suction port, the liquid refrigerant separated by the hot-gas gas-liquid separator is decompressed by the second decompression valve, and the refrigerant flowing out of the joint is guided toward the low-pressure suction port of the compressor.

5. The heat pump cycle device according to claim 4, further comprising:
a third decompression valve configured to decompress the refrigerant;
a heating gas-liquid separator that separates the refrigerant, decompressed by the third decompression valve, into gas refrigerant and liquid refrigerant;
a fourth decompression valve configured to decompress the liquid refrigerant separated by the heating gas-liquid separator; and
an exterior heat exchanger that exchanges heat between the refrigerant and outside air, wherein
during an outside air endothermic heating mode in which the object is heated using the heater, the refrigerant circuit switching portion switches a refrigerant circuit in which the refrigerant flowing out of the heater is guided to the third decompression valve, the gas refrigerant separated by the heating gas-liquid separator is guided toward the intermediate-pressure suction port, the refrigerant decompressed by the fourth decompression valve is guided to a refrigerant inlet side of the exterior heat exchanger, and the refrigerant flowing out of the exterior heat exchanger is guided toward the low-pressure suction port of the compressor.

6. The heat pump cycle device according to claim 4, further comprising:
an exterior heat exchanger that exchanges heat between the refrigerant and outside air, wherein
during a cooling mode for cooling an object to be cooled, the refrigerant circuit switching portion switches a refrigerant circuit in which the refrigerant flowing out of the heater is guided to a refrigerant inlet side of the exterior heat exchanger, the refrigerant flowing out of the exterior heat exchanger is guided to an inlet side of the first decompression valve, the gas refrigerant separated by the hot-gas gas-liquid separator is guided toward the intermediate-pressure suction port, the refrigerant decompressed by the second decompression valve is guided to the refrigerant inlet side of the evaporator, and the refrigerant flowing out of the evaporator is guided toward the low-pressure suction port of the compressor.

7. A heat pump cycle device comprising:
a compressor configured to compress low-pressure refrigerant drawn from a low-pressure suction port, to discharge compression refrigerant from a discharge port, and to merge intermediate-pressure refrigerant drawn from an intermediate-pressure suction port with the low-pressure refrigerant in a process of compression;
an upstream branch configured to divide a flow of high-pressure refrigerant discharged from the discharge port;
a heater configured to heat an object to be heated using one of the high-pressure refrigerant divided at the upstream branch as a heat source;
a downstream branch configured to divide a flow of the refrigerant flowing out of the heater;
a first decompression valve configured to decompress one of the refrigerant divided at the downstream branch;
an internal heat exchanger that exchanges heat between the refrigerant flowing out of the first decompression valve and an another one of the refrigerant divided at the downstream branch;
a second decompression valve configured to decompress the another one of the refrigerant divided at the downstream branch and flowing out of the internal heat exchanger;
a bypass passage that guides an another one of the high-pressure refrigerant divided at the upstream branch toward the low-pressure suction port of the compressor;
a bypass-side flow rate valve configured to regulate a flow rate of the refrigerant flowing through the bypass passage;
a joint that merges a flow of the refrigerant flowing out of the bypass-side flow rate valve and a flow of the refrigerant flowing out of the second decompression valve;
an evaporator that evaporates the refrigerant decompressed by the second decompression valve to cool an object to be cooled; and
a refrigerant circuit switching portion that switches between refrigerant circuits through which the refrigerant circulates, wherein
during a multi-stage endothermic hot-gas heating mode for heating the object to be heated using the heater, the refrigerant circuit switching portion switches a refrigerant circuit in which the refrigerant heated by the internal heat exchanger is guided toward the intermediate-pressure suction port, the refrigerant cooled by the internal heat exchanger is decompressed by the second decompression valve, and the refrigerant flowing out of the joint is guided toward the low-pressure suction port of the compressor.

8. The heat pump cycle device according to claim 7, further comprising:
a third decompression valve configured to decompress the refrigerant;
an exterior heat exchanger that exchanges heat between the refrigerant and outside air; and
an exterior-device passage that guides the refrigerant cooled by the internal heat exchanger to an inlet side of the third decompression valve, wherein
during an outside air endothermic heating mode in which the object is heated using the heater, the refrigerant circuit switching portion switches a refrigerant circuit in which the refrigerant heated by the internal heat exchanger is guided toward the intermediate-pressure suction port of the compressor, the refrigerant cooled by the internal heat exchanger is guided to an inlet side of the third decompression valve via the exterior-device passage, and the refrigerant flowing out of the exterior heat exchanger is guided toward the low-pressure suction port of the compressor.

9. The heat pump cycle device according to claim 7, further comprising:
an exterior heat exchanger that exchanges heat between the refrigerant and outside air, wherein
during a cooling mode for cooling an object to be cooled, the refrigerant circuit switching portion switches a refrigerant circuit in which the refrigerant flowing out of the heater is guided to a refrigerant inlet side of the exterior heat exchanger, the refrigerant flowing out of the exterior heat exchanger is guided to an inflow port of the downstream branch, the refrigerant heated by the internal heat exchanger is guided toward the intermediate-pressure suction port, the refrigerant decompressed by the second decompression valve is guided to a refrigerant inlet side of the evaporator, and the refrigerant flowing out of the evaporator is guided toward the low-pressure suction port of the compressor.

10. The heat pump cycle device according to claim 1, wherein
the refrigerant circuit switching portion includes an intermediate-pressure-side opening/closing valve that opens and closes an intermediate-pressure passage through which the refrigerant flows toward the intermediate-pressure suction port of the compressor, and
the intermediate-pressure-side opening/closing valve closes the intermediate-pressure passage during a single-stage hot-gas heating mode in which the object to be heated is heated using the heater.

11. The heat pump cycle device according to claim 10, further comprising:
a controller including at least one of a circuit and a processor having a memory storing computer program code, the controller being configured to determine a target temperature of the object to be heated; and
a heating-object temperature detection portion configured to detect an object temperature of the object to be heated,
wherein the controller controls the intermediate-pressure-side opening/closing valve to open the intermediate-pressure passage when the object temperature is lower than the target temperature.

12. The heat pump cycle device according to claim 1, further comprising:
a controller including at least one of a circuit and a processor having a memory storing computer program code, the controller being configured to control an operation of the first decompression valve and to determine a target temperature of the object to be heated; and
a heating-object temperature detector configured to detect an object temperature of the object to be heated,
wherein the controller increases a throttle opening of the first decompression valve during the multi-stage hot-gas heating mode and when the object temperature is lower than the target temperature.
